(19) United States
(12) Patent Application Publication
(10) Pub. No.: US 2012/0126124 A1
(43) Pub. Date: May 24, 2012

(54) RADIOGRAPHIC IMAGE CAPTURING APPARATUS

(75) Inventors: Haruyasu NAKATSUGAWA, Kanagawa-ken (JP); Naoyuki NISHINO, Kanagawa-ken (JP); Naoto IWAKIRI, Kanagawa-ken (JP); Fumito NARIYUKI, Kanagawa-ken (JP); Yasunori OHTA, Kanagawa-ken (JP); Kazuhiro NODA, Kanagawa-ken (JP)

(73) Assignee: FUJIFILM CORPORATION, Tokyo (JP)

(21) Appl. No.: 13/298,473

(22) Filed: Nov. 17, 2011

(30) Foreign Application Priority Data
Nov. 18, 2010 (JP) 2010-258175

(51) Int. Cl. G01T 1/20

(52) U.S. Cl. 250/363.01

(57) ABSTRACT

A radiographic image capturing apparatus includes a resetting light source, a switching filter, a photodetector substrate, and a scintillator, which are arranged successively in this order. If the switching filter is made permeable to resetting light from the resetting light source, the switching filter applies the resetting light to the photodetector substrate. If the switching filter is made impermeable to the resetting light, the switching filter reflects at least a fluorescence, which is converted from radiation by the scintillator, toward the photodetector substrate.

### CROSS-REFERENCE TO RELATED APPLICATION

This application is based upon and claims the benefit of priority from Japanese Patent Application No. 2010-258175 filed on Nov. 18, 2010, of which the contents are incorporated herein by reference.

### BACKGROUND OF THE INVENTION

1. Field of the Invention

The present invention relates to a radiographic image capturing apparatus having a scintillator for converting radiation into fluorescence, and a photodetector substrate for converting the fluorescence into electric signals.

2. Description of the Related Art

In the medical field, it has widely been customary to apply radiation from a radiation source to a subject and detect radiation that has passed through the subject with a radiation detector that makes up part of a radiographic image capturing apparatus, thereby capturing a radiographic image of the subject. The radiographic image capturing apparatus includes a scintillator for converting radiation that has passed through the subject into fluorescence, and a photodetector substrate for converting the fluorescence into electric signals. The photodetector substrate includes photodetector devices, which include photodiodes for detecting the fluorescence.

If the photodiodes of the photodetector devices are made of amorphous silicon (a-Si) or the like, then some of the electric charges (i.e., electrons) that are converted from the fluorescence become temporarily trapped by the impurity level (defect) of the amorphous silicon. If such trapped electrons are subsequently released due to a rise in temperature of the photodiodes, which may be caused at the time a moving image is captured over a long period of time, unwanted current such as dark current tends to be generated, possibly producing noise in a resultant radiographic image of the subject. To solve this problem, as disclosed in Japanese Laid-Open Patent Publication No. 2008-309517 and Japanese Laid-Open Patent Publication No. 2007-225598, there has been proposed a light resetting process for reducing noise by applying resetting light to the photodiodes at a time that radiation is not being applied to the subject, i.e., if a radiographic image of the subject is not being captured, to thereby embed electric charges in the impurity level, so that electric charges converted from fluorescence in a case where radiation is applied to the subject, i.e., in a case where a radiographic image of the subject is captured, will not become trapped by the impurity level.

According to Japanese Laid-Open Patent Publication No. 2008-309517, a scintillator, a photodetector substrate, and a resetting light source are arranged in this order, and resetting light emitted from the resetting light source is applied to a photodetector device of the photodetector substrate. According to Japanese Laid-Open Patent Publication No. 2007-225598, a reflecting layer, a resetting light source, a scintillator, a photodetector device, and a light absorbing layer are arranged in this order, and resetting light emitted from the resetting light source is applied to a photodetector device of the photodetector substrate via the scintillator.

### SUMMARY OF THE INVENTION

According to Japanese Laid-Open Patent Publication No. 2008-309517, fluorescence converted from radiation by the scintillator is directly applied to the photodetector substrate. Part of the fluorescence passes through the photodetector substrate and is absorbed by a black pigment of the resetting light source. The radiographic image is thereby prevented from becoming blurred by reflection of fluorescence by the resetting light source.

According to Japanese Laid-Open Patent Publication No. 2007-225598, fluorescence converted from radiation by the scintillator is directly applied to the photodetector substrate, or is reflected by the reflecting layer via the resetting light source, and thereafter is applied to the photodetector substrate via the resetting light source and the scintillator. Part of the fluorescence passes through the photodetector substrate to the light absorbing layer, which absorbs the applied fluorescence. The radiographic image is thereby prevented from becoming blurred by reflection and scattering of fluorescence toward the photodetector substrate.

In a case where a radiographic image, e.g., a moving radiographic image, of the subject is captured, it is desirable to increase insofar as possible the sensitivity of the photodetector substrate with respect to fluorescence, in order to reduce the dose of the radiation applied to the subject.

According to Japanese Laid-Open Patent Publication No. 2008-309517, however, since part of the fluorescence that passes through the photodetector substrate to the resetting light source is absorbed by the black pigment thereof, the amount of fluorescence that is converted into electric signals by the photodetector substrate is reduced. Inasmuch as part of the fluorescence is absorbed by the black pigment to prevent the image from becoming blurred, the sensitivity of the photodetector substrate with respect to fluorescence cannot be increased.

According to Japanese Laid-Open Patent Publication No. 2007-225598, since part of the fluorescence that passes through the photodetector substrate to the light absorbing layer also is absorbed in order to prevent the image from becoming blurred, the amount of fluorescence that is converted into electric signals by the photodetector substrate is reduced, and the sensitivity of the photodetector substrate with respect to fluorescence cannot be increased.

It is an object of the present invention to provide a radiographic image capturing apparatus, which is capable of sufficiently applying resetting light to a photodetector substrate and of increasing the sensitivity of the photodetector substrate with respect to fluorescence, while also preventing a captured radiographic image from becoming blurred.

To achieve the above object, there is provided in accordance with the present invention a radiographic image capturing apparatus comprising:

a scintillator for converting radiation into fluorescence;

a photodetector substrate for converting the fluorescence into electric signals;

a resetting light source for applying resetting light to the photodetector substrate; and

a switching filter, which is selectively permeable and impermeable to the resetting light,

wherein the resetting light source, the switching filter, the photodetector substrate, and the scintillator are arranged in this order, and

if the switching filter is made permeable to the resetting light, the switching filter applies the resetting light to the photodetector substrate, and if the switching filter is made impermeable to the resetting light, the switching filter reflects at least the fluorescence toward the photodetector substrate.

With the above arrangement, if the switching filter is switched to a permeable state for the resetting light, the resetting light source can apply the resetting light to the photodetector substrate for sufficiently performing a light resetting process on the photodetector substrate.

If the switching filter is switched to an impermeable state for the resetting light, the fluorescence converted from the radiation by the scintillator reaches the photodetector substrate. Among such fluorescence, part of the fluorescence that travels toward the resetting light source is reflected toward the photodetector substrate by the switching filter. The reflected light is applied to the photodetector substrate without reaching the resetting light source. Consequently, the photodetector substrate can acquire high-quality radiographic images that are not blurred, and the amount of fluorescence that is applied to the photodetector substrate can be increased, thereby increasing the sensitivity of the photodetector substrate with respect to fluorescence.

According to the present embodiment, therefore, since the resetting light source, the switching filter, the photodetector substrate, and the scintillator are successively arranged in this order, and the switching filter is made selectively permeable and impermeable to the resetting light, the light resetting process can sufficiently be performed on the photodetector substrate, and the sensitivity of the photodetector substrate with respect to visible light can be increased while also preventing the radiographic image from becoming blurred.

The scintillator converts radiation, which has passed through a subject, into fluorescence. The photodetector substrate converts the fluorescence into electric signals, which represent a radiographic image of the subject. The switching filter is selectively switchable to a transparent state (permeable state), which is permeable to the resetting light, and a mirror state (impermeable state), which reflects the fluorescence toward the photodetector substrate and also reflects the resetting light toward the resetting light source, based on an image capturing order concerning capturing of the radiographic image of the subject.

The switching filter can be kept in the transparent state or the mirror state, or can be switched to the transparent state or the mirror state, depending on an image capturing method (a still image capturing mode or a moving image capturing mode) for the subject, for thereby reliably and efficiently performing the light resetting process on the photodetector substrate, and for acquiring, with high sensitivity, high-quality radiographic images that are prevented from becoming blurred. If the switching filter in the mirror state reflects the fluorescence toward the photodetector substrate, the amount of fluorescence that is applied to the photodetector substrate is increased. Consequently, the amount of radiation that is applied to the subject can be reduced in order to reduce the dose of radiation applied to the subject.

More specifically, it is desirable for the radiographic image capturing apparatus to keep the switching filter in the transparent state or in the mirror state, or switch the switching filter to the transparent state or to the mirror state according to an image capturing order, as described below in cases [1] through [5].

[1] If the image capturing order includes a still image capturing mode for capturing at least one still image, or a moving image capturing mode at a frame rate lower than a frame rate threshold value, the switching filter is kept in the mirror state.

The above image capturing modes, in particular, require high-quality radiographic images to be acquired with high sensitivity. Since the image capturing interval in the aforementioned image capturing modes is relatively long, the temperature of the photodiodes does not rise significantly, and noise caused by electric charges, which are trapped by the impurity level, being discharged again is not expected to greatly affect the captured radiographic images.

If the above image capturing order is received, the switching filter is kept in the mirror state to hold the light resetting process off and also to reflect the fluorescence converted from radiation by the scintillator toward the photodetector substrate, thereby increasing the amount of fluorescence applied to the photodetector substrate. As a result, in case [1], it is possible to easily acquire low-noise, high-quality radiographic images with high sensitivity, which are prevented from becoming blurred.

[2] If the image capturing order includes a moving image capturing mode, the switching filter is kept in the mirror state in each frame while the subject is irradiated with radiation, and is kept in the transparent state if the subject is not irradiated with radiation, whereby the switching filter is switched successively between the mirror state and the transparent state.

Since the switching filter is switched successively between the mirror state and the transparent state in one frame, if the subject is irradiated with radiation, the switching filter is kept in the mirror state to reflect visible light reliably toward the photodetector substrate, thereby increasing the amount of fluorescence applied to the photodetector substrate. If the subject is not irradiated with radiation, the switching filter is kept in the transparent state to sufficiently perform the light resetting process on the photodetector substrate.

In the moving image capturing mode, therefore, the switching filter is switched alternately between the mirror state and the transparent state in one frame, to thereby acquire high-quality radiographic images with high sensitivity, and also to reduce noise in the acquired radiographic images. If the switching filter has a switching time that can sufficiently catch up with the frame rate of the moving image capturing mode, i.e., if the switching filter has a switching time shorter than a time interval between image capturing cycles, then the switching filter can be switched alternately between the mirror state and the transparent state.

[3] If the image capturing order includes a moving image capturing mode and a still image capturing mode for capturing at least one still image, the switching filter is kept in the mirror state in the still image capturing mode and is kept in the mirror state in the moving image capturing mode, or is kept in the mirror state if the subject is irradiated with radiation and is kept in the transparent state if the subject is not irradiated with radiation in each frame in the moving image capturing mode, whereby the switching filter is switched successively between the mirror state and the transparent state,

the switching filter switches from successively switching between the mirror state and the transparent state to the mirror state, or is further kept in the mirror state at a timing at which the moving image capturing mode is switched to the still image capturing mode, and

the switching filter switches from the mirror state to successively switching between the mirror state and the transparent state, or is further kept in the mirror state at a timing at which the still image capturing mode is switched to the moving image capturing mode.

By keeping the switching filter in one of the mirror state and the transparent states, or switching the switching filter between the mirror state and the transparent state at a timing at which switching takes place between the image capturing methods, i.e., the still image capturing mode and the moving image capturing mode, it is possible to reliably acquire optimum radiographic images depending on the image capturing methods.

[4] If the image capturing order includes a first moving image capturing mode at a frame rate lower than a frame rate threshold value and a second moving image capturing mode at a frame rate higher than the frame rate threshold value,

the switching filter is kept in the mirror state in the first moving image capturing mode, or is kept in the mirror state if the subject is irradiated with radiation and is kept in the transparent state if the subject is not irradiated with radiation in each frame in the second moving image capturing mode, whereby the switching filter is switched successively between the mirror state and the transparent state, and

the switching filter switches from the mirror state to successively switching between the mirror state and the transparent state at a timing at which the first moving image capturing mode is switched to the second moving image capturing mode, or switches from successively switching between the mirror state and the transparent state to the mirror state at a timing at which the second moving image capturing mode is switched to the first moving image capturing mode.

Therefore, even if the image capturing order has a frame rate thereof changed during the radiographic image capturing process, optimum radiographic images depending on the frame rate can reliably be acquired by switching the switching filter at a timing at which the frame rate is changed.

The frame rate threshold value refers to a threshold value for determining whether the light resetting process is required or not. If the frame rate of a moving image capturing mode included in the image capturing order is higher than the frame rate threshold value, then it is determined that the light resetting process is required. On the other hand, if the frame rate of a moving image capturing mode included in the image capturing order is lower than the frame rate threshold value, then it is determined that the light resetting process is not required.

Consequently, if a moving image capturing mode has a frame rate higher than the frame rate threshold value, thus requiring the light resetting process, and if the switching filter is capable of switching between the mirror state and the transparent state in a manner to catch up with the frame rate, then the switching filter is switched successively between the mirror state and the transparent state in one frame, thereby making it possible to perform the light resetting process reliably between image capturing cycles while the subject is not irradiated with radiation.

[5] If the image capturing order further includes a still image capturing mode for capturing at least one still image, the switching filter is kept in the mirror state in the still image capturing mode, and switches from a state in which the switching filter depends on one of the moving image capturing modes to the mirror state, at a timing at which one of the moving image capturing modes is switched to the still image capturing mode, or switches from the mirror state to the state in which the switching filter depends on one of the moving image capturing modes, at a timing at which the still image capturing mode is switched to the one of the moving image capturing modes.

Accordingly, even if the image capturing order includes a still image capturing mode, optimum radiographic images can easily be acquired in each of the image capturing modes by switching the switching filter as described above.

In the aforementioned radiographic image capturing apparatus, the photodetector substrate includes a plurality of photodetector devices for converting fluorescence into electric signals, and the switching filter has a window defined in a portion thereof for passing resetting light therethrough at all times. If the resetting light source applies the resetting light through the window to one of the photodetector devices, which faces toward the window, the photodetector device, which is irradiated with resetting light, detects a dark current signal generated by the resetting light, and the switching filter switches to the mirror state or the transparent state based on a temperature of the photodetector device depending on the dark current signal and the image capturing order.

The level of noise trapped by an impurity level varies with the temperature of the photodetector devices, which are in the form of photodiodes made of a-Si or the like. Noise can thus be efficiently reduced depending on changes in the temperature of the photodetector devices by switching the switching filter to the mirror state or the transparent state based on the temperature, which depends on the dark current signal and the image capturing order, as described above.

Preferably, the switching filter includes a light-regulating mirror film layer, which is electrically controlled to be permeable or impermeable to the resetting light. The switching filter includes a transparent base permeable to the resetting light, and the light-regulating mirror film layer is disposed on the transparent base. The photodetector substrate is disposed on a side of the light-regulating mirror film layer, and the resetting light source is disposed on a side of the transparent base. Therefore, the switching filter can easily and efficiently be switched to the permeable state or the impermeable state (mirror state).

The resetting light source may comprise an array of light-emitting elements, a backlight, or an electroluminescence light source, disposed in facing relation to the photodetector substrate with the switching filter interposed therebetween.

The backlight comprises a light guide plate disposed on a side of the switching filter remote from the photodetector substrate, a light source disposed on a side of the light guide plate, a reflection sheet disposed in surrounding relation to the light guide plate and the light source, and a diffusion sheet disposed on a surface of the light guide plate, which faces toward the switching filter. The light source applies light to the light guide plate, and the light applied to the light guide plate is repeatedly reflected in the light guide plate between surfaces of the reflection sheet and the diffusion sheet, and thereafter, the light is emitted as resetting light from the diffusion sheet to the switching filter.

The backlight makes it possible to place the light source in an area that is not irradiated with radiation. Therefore, the light source is prevented from becoming degraded by radiation. The light source may comprise a light-emitting diode or a cold-cathode ray tube.

If the resetting light source is in the form of an organic electroluminescence light source, then the resetting light source may be made low in profile.

In the above radiographic image capturing apparatus, the scintillator and the photodetector substrate may be bonded to each other by a bonding layer, the scintillator and the photodetector substrate may be adhered to each other by an adhesive layer, the scintillator may be directly deposited on the photodetector substrate, or the photodetector substrate may be directly formed on the scintillator.

After the scintillator has been deposited on the photodetector substrate, a distal end portion of the scintillator and the photodetector substrate may be bonded to each other by the bonding layer or adhered to each other by the adhesive layer.

The photodetector substrate may include a photodetector device for converting fluorescence into electric signals, and a switching element for reading the electric signals from the photodetector device. After the photodetector device and the switching element have been deposited on a base with a peel-off layer interposed therebetween, the photodetector substrate may be transferred to the scintillator with the bonding layer or the adhesive layer interposed therebetween, the base and the peel-off layer may be peeled off from the transferred photodetector substrate, and thereafter, the switching filter may be disposed on a surface of the photodetector substrate from which the base and the peel-off layer have been peeled off.

The radiographic image capturing apparatus may be fabricated in other ways than described above. More specifically, the photodetector substrate may include a photodetector device for converting fluorescence into electric signals, and a switching element for reading the electric signals from the photodetector device. If the scintillator is directly deposited on the photodetector substrate, or the photodetector substrate is directly formed on the scintillator, the photodetector device may be made of an organic photoconductor or an amorphous oxide semiconductor, and the switching element may be made of an organic semiconductor, an amorphous oxide semiconductor, or carbon nanotubes. Thus, the photodetector device and the switching device can be deposited as films at low temperatures.

More specifically, if the scintillator is directly deposited on the photodetector substrate, the photodetector device and the switching element may be formed on the base, and thereafter, the scintillator may be deposited on the photodetector device and the switching element. If the photodetector substrate is directly formed on the scintillator, the scintillator may be deposited on an evaporated substrate, and thereafter, the photodetector device and the switching element may be formed on a distal end portion of the scintillator.

The radiographic image capturing apparatus may further comprise an oblique light blocking layer for blocking fluorescence that travels obliquely to a direction in which radiation is applied, the oblique light blocking layer being interposed between the photodetector substrate and the scintillator. It is thus possible to increase the sensitivity of the photodetector substrate with respect to fluorescence and to prevent the radiographic images from becoming blurred.

The resetting light source, the switching filter, the photodetector substrate, and the scintillator are successively arranged in this order, or alternatively, the scintillator, the photodetector substrate, the switching filter, and the resetting light source are successively arranged in this order, along a direction in which radiation is applied.

If the resetting light source, the switching filter, the photodetector substrate, and the scintillator are successively arranged in this order along the direction in which radiation is applied, the switching filter may be kept in the mirror state, for thereby reflecting the resetting light toward the resetting light source while reflecting the fluorescence toward the photodetector substrate, at least when radiation is applied.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a schematic view, partially in block form, of a radiographic image capturing system, which incorporates therein an electronic cassette (radiographic image capturing apparatus) according to a first embodiment of the present invention;

FIG. 2 is a perspective view of the electronic cassette shown in FIG. 1;

FIGS. 3A and 3B are cross-sectional views of the electronic cassette shown in FIG. 2, taken along line III-III of FIG. 2;

FIGS. 4A and 4B are enlarged fragmentary cross-sectional views of the electronic cassette (electronic cassettes according to a first example and a second example) shown in FIG. 3A in the vicinity of a radiation detector thereof;

FIGS. 5A and 5B are enlarged fragmentary cross-sectional views of the electronic cassette (electronic cassettes according to a third example and a fourth example) shown in FIG. 3B in the vicinity of a radiation detector thereof;

FIG. 6A is an enlarged fragmentary cross-sectional view of an electronic cassette in the vicinity of a radiation detector thereof;

FIG. 6B is an enlarged fragmentary cross-sectional view of an electronic cassette in the vicinity of a resetting light source, a switching filter, and a photodetector substrate;

FIGS. 7A and 7B are enlarged fragmentary cross-sectional views of electronic cassettes in the vicinity of a resetting light source, a switching filter, and a photodetector substrate;

FIGS. 8A and 8B are enlarged fragmentary cross-sectional views of electronic cassettes in the vicinity of a resetting light source, a switching filter, and a photodetector substrate;

FIG. 9A is a cross-sectional view showing the manner in which photodetector devices and switching devices are formed on a base;

FIG. 9B is a cross-sectional view showing the manner in which a planarization film is formed;

FIG. 10A is a cross-sectional view showing the manner in which the photodetector substrate is bonded or adhered to a scintillator;

FIG. 10B is a cross-sectional view showing the manner in which a base and a peel-off layer are pealed from the photodetector substrate;

FIG. 11 is a cross-sectional view showing a switching filter;

FIGS. 12A and 12B are cross-sectional views showing the manner in which the switching filter is brought into a transparent state;

FIGS. 13A and 13B are cross-sectional views showing the manner in which the switching filter is brought into a mirror state;

FIGS. 14A and 14B are cross-sectional views, each showing a switching filter and a resetting light source;

FIG. 15A is a plan view of a resetting light source;

FIG. 15B is a cross-sectional view showing a switching filter and a resetting light source;

FIG. 16 is a cross-sectional view showing a switching filter and a resetting light source;

FIG. 17 is a schematic view, partially in block form, of an electric arrangement of the electronic cassette shown in FIG. 1;

FIG. 18 is a flowchart of a basic operation sequence of the radiographic image capturing system shown in FIG. 1;

FIG. 19 is a flowchart of a basic operation sequence of the radiographic image capturing system shown in FIG. 1;

FIG. 20 is a flowchart of a switching sequence and a resetting sequence of the switching filter;

FIG. 21 is a flowchart of a switching sequence and a resetting sequence of the switching filter;

FIG. 22 is a graph showing how a frame rate threshold value changes depending on a temperature of photodiodes;

FIG. 23A is a timing chart showing switching from a still image capturing mode to a moving image capturing mode;

FIG. 23B is a timing chart showing switching from the moving image capturing mode to the still image capturing mode;

FIG. 23C is a timing chart showing switching between the still image capturing mode, a low-rate moving image capturing mode, and a high-rate moving image capturing mode;

FIG. 24 is a flowchart of an operation sequence for determining an image capturing order;

FIG. 25 is a flowchart of a switching sequence and a resetting sequence of the switching filter;

FIG. 26 is a flowchart of a switching sequence and a resetting sequence of the switching filter;

FIG. 27 is a flowchart of a switching sequence and a resetting sequence of the switching filter;

FIG. 28 is a flowchart of a switching sequence and a resetting sequence of the switching filter;

FIG. 29A is a plan view of a window provided on a switching filter;

FIG. 29B is a fragmentary view showing the manner in which the switching filter with the window thereon operates;

FIGS. 30A and 30B are fragmentary cross-sectional views showing an electronic cassette according to a second embodiment of the present invention in the vicinity of a radiation detector thereof;

FIGS. 31A and 31B are fragmentary cross-sectional views showing an electronic cassette according to a second example in the vicinity of a radiation detector thereof;

FIG. 32A is a cross-sectional view showing the manner in which a bonding layer or an adhesive layer is formed on a base with a peel-off layer interposed therebetween;

FIG. 32B is a cross-sectional view showing the manner in which a switching device and a photodetector device are deposited on a base with a peel-off layer and a bonding layer or an adhesive layer interposed therebetween;

FIG. 32C is a cross-sectional view showing the manner in which a planarization film is formed;

FIG. 33A is a cross-sectional view showing the manner in which a scintillator is deposited;

FIG. 33B is a cross-sectional view showing the manner in which a moisture-resistant protective film is formed;

FIG. 34A is a cross-sectional view showing the manner in which a base and a peel-off layer are peeled off from a photodetector substrate;

FIG. 34B is a cross-sectional view showing the manner in which a switching filter is bonded or adhered to a photodetector substrate;

FIGS. 35A and 35B are fragmentary cross-sectional views showing an electronic cassette according to a third example in the vicinity of a radiation detector thereof; and

FIGS. 36A and 36B are fragmentary cross-sectional views showing an electronic cassette according to a fourth example in the vicinity of a radiation detector thereof.

### DESCRIPTION OF THE PREFERRED EMBODIMENTS

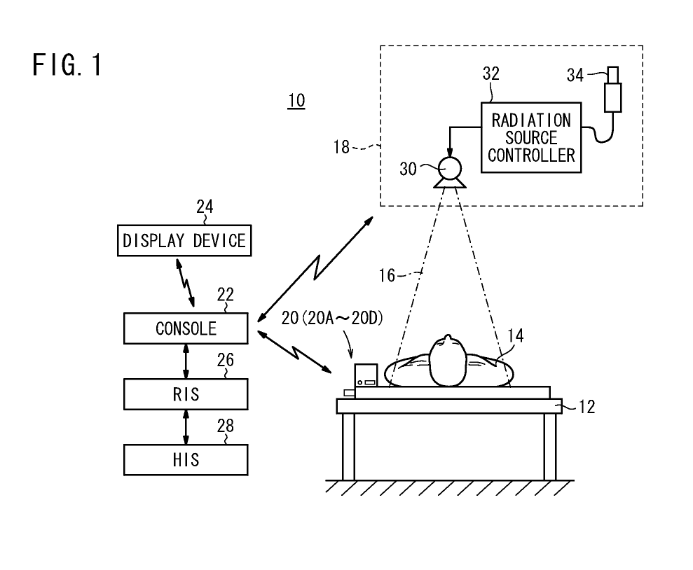

Radiographic image capturing apparatus according to preferred embodiments of the present invention will be described in detail below with reference to FIGS. 1 through 36B.

### Arrangement of the First Embodiment

FIG. 1 is a schematic view, partially in block form, of a radiographic image capturing system 10 incorporating therein an electronic cassette (radiographic image capturing apparatus) 20 according to a first embodiment of the present invention.

As shown in FIG. 1, the radiographic image capturing system 10 includes a radiation output device 18 for applying radiation 16 to a subject 14 such as a patient lying on an image capturing base 12 such as a bed or the like, an electronic cassette 20 for detecting radiation 16 that has passed through the subject 14 and converting the detected radiation into a radiographic image, a console 22 for controlling the radiographic image capturing system 10 in its entirety and receiving input actions from a doctor or radiological technician (hereinafter referred to as a “doctor”), and a display device 24 for displaying captured radiographic images, etc.

The radiation output device 18, the electronic cassette 20, the console 22, and the display device 24 send and receive signals to and from each other by way of a wireless LAN according to standards such as UWB (Ultra-Wide Band), IEEE802.11.a/b/g/n., or the like, or wireless communications using milliwaves. The radiation output device 18, the electronic cassette 20, the console 22, and the display device 24 may also send and receive signals to and from each other by way of wired communications through cables.

The console 22 is connected to a radiology information system (RIS) 26, which generally manages radiographic image and other information handled by the radiological department of a hospital. The RIS 26 is connected to a hospital information system (HIS) 28, which generally manages medical information in the hospital.

The radiation output device 18 has a radiation source 30 for emitting radiation 16, a radiation source controller 32 for controlling the radiation source 30, and a radiation switch 34. Radiation 16, which is emitted from the radiation source 30, may be X-rays, α-rays, β-rays, γ-rays, an electron beam, or the like. The radiation switch 34 can be pushed in two strokes, i.e., the radiation switch 34 can be pushed in a half stroke and a full stroke. If the radiation switch 34 is pushed in a half stroke by the doctor, the radiation switch 34 sends signals to the radiation source controller 32 to prepare the radiation source 30 to emit radiation 16. If the radiation switch 34 is pushed in a full stroke, the radiation switch 34 sends signals to the radiation source controller 32 to enable the radiation source 30 to start emitting radiation 16.

Since the radiation output device 18, the electronic cassette 20, the console 22, and the display device 24 can send and receive signals to and from each other, the radiation output device 18 can send a signal indicating that the radiation source 30 is being made ready to emit radiation 16 to the console 22 if the radiation switch 34 is pushed in a half stroke by the doctor, and may send a signal indicating that the radiation source 30 is capable of emitting radiation 16 to the console 22 if the radiation switch 34 is pushed in a full stroke by the doctor.

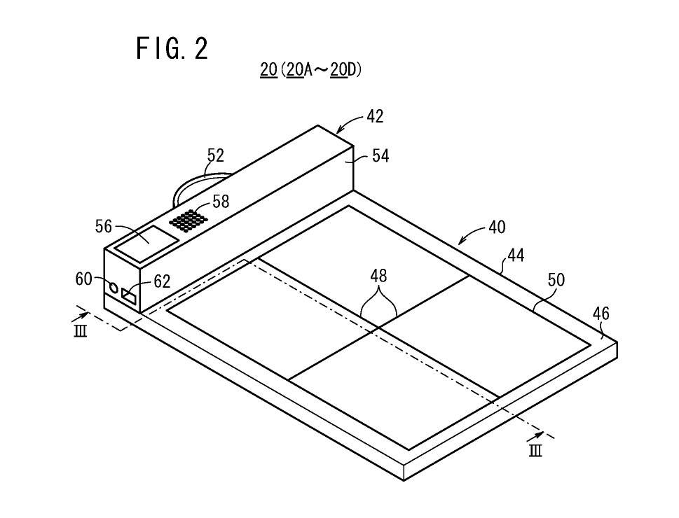

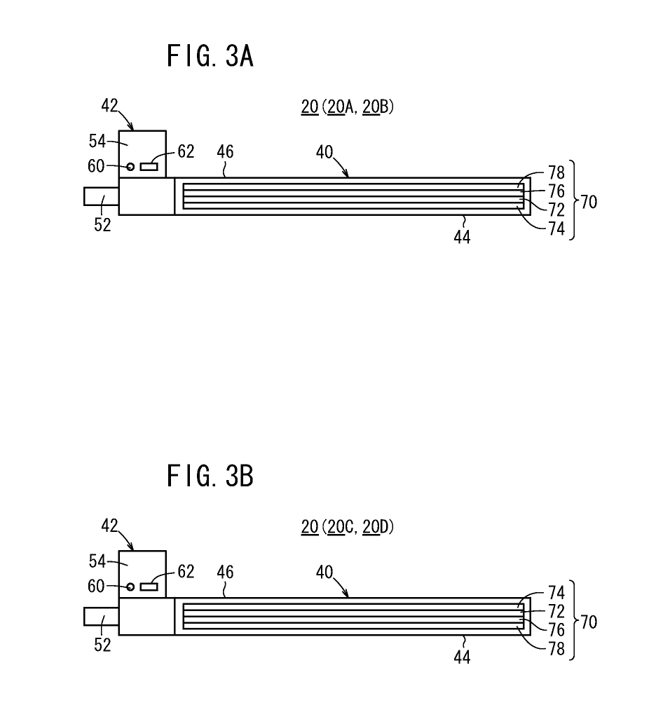

FIG. 2 is a perspective view of the electronic cassette 20 shown in FIG. 1, and FIGS. 3A and 3B are cross-sectional views of the electronic cassette 20 shown in FIG. 2, taken along line III-III of FIG. 2.

The electronic cassette 20 has a panel 40 and a controller 42 disposed on the panel 40. The panel 40 is thinner than the controller 42.

The panel 40 includes a substantially rectangular casing 44 made of a material that is permeable to radiation 16 (see FIG. 1). The panel 40 has an upper irradiation surface 46, which is irradiated with radiation 16. The irradiation surface 46 has guide lines 48 disposed substantially centrally thereon, which serve as a reference for an image capturing area and an image capturing position for the subject 14. The guide lines 48 include an outer frame representing an image capturing area 50, which indicates an irradiation field to be irradiated with radiation 16 on the irradiation surface 46. The guide lines 48 have a central position, in a central position of the image capturing area 50, where the guide lines 48 cross each other in a crisscross pattern.

The electronic cassette 20 also has a grip 52 on a side thereof close to the controller 42 for the doctor to hold. The doctor can hold the grip 52 and carry the electronic cassette 20 to a desired location, e.g., the image capturing base 12. Thus, the electronic cassette 20 serves as a portable radiographic image capturing apparatus.

The controller 42 includes a substantially rectangular casing 54 made of a material that is impermeable to radiation 16. The casing 54 extends along an end of the irradiation surface 46, and the controller 42 is disposed on the irradiation surface 46 outside of the image capturing area 50. The casing 54 has on an upper surface thereof a display control panel 56 in the form of a touch panel for the doctor to enter various items of information, and a speaker 58 for outputting sounds representing various notices for the doctor. The casing 54 also has on a side surface thereof an AC adapter input terminal 60 supplied with charging electric power from an external power source, and an USB terminal 62 serving as an interface for sending and receiving information to and from an external device such as the console 22, for example.

As shown in FIGS. 3A and 3B, the casing 44 houses therein a radiation detector 70 for converting radiation 16 into a radiographic image.

The radiation detector 70 comprises an indirect-conversion-type radiation detector including a photodetector substrate 72, a scintillator 74, a switching filter 76, and a resetting light source 78. Basically, the resetting light source 78, the switching filter 76, the photodetector substrate 72, and the scintillator 74 are arranged successively in this order from the irradiation surface 46, as shown in FIG. 3A.

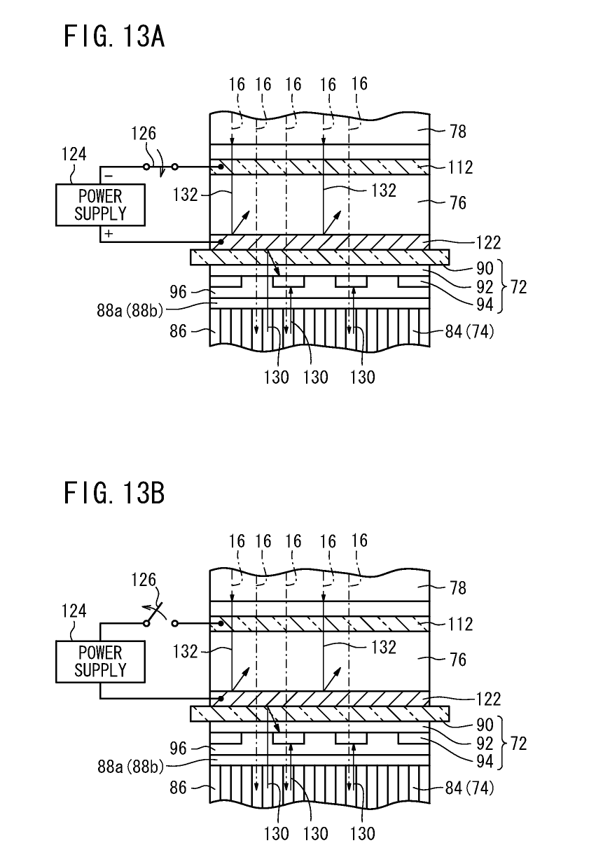

The scintillator 74 converts radiation 16 that has passed through the subject 14 into fluorescence, e.g., fluorescence in the visible range or the ultraviolet range. In FIGS. 13A and 13B to be described later, the scintillator 74 converts radiation 16 into visible light 130. In the description below, it is assumed that the scintillator 74 converts radiation 16 into visible light 130, unless otherwise noted.

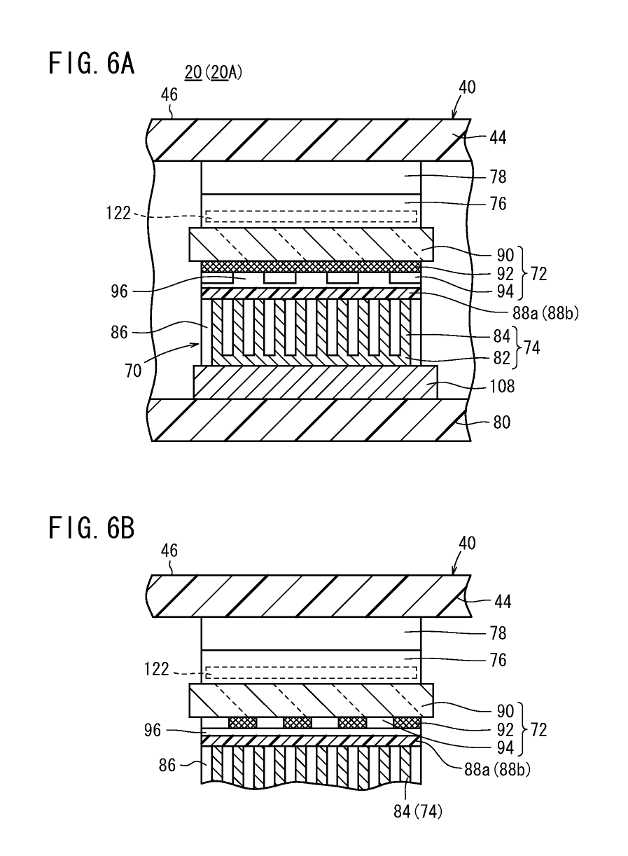

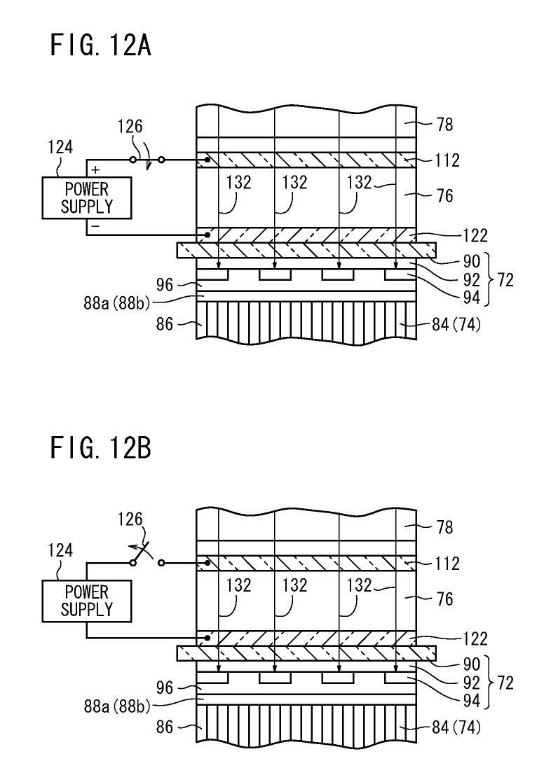

The photodetector substrate 72 converts visible light 130, as fluorescence, into an electric signal. The resetting light source 78 applies resetting light 132 (see FIGS. 12A through 14B, 15B, and 16) to the photodetector substrate 72 in order to reset the photodetector devices 94 (see FIGS. 6A through 8B) of the photodetector substrate 72. The switching filter 76 is able to selectively switch between a transmitting state in which the switching filter 76 passes resetting light 132 therethrough, and a blocking state in which the switching filter 76 blocks resetting light 132 against transmission.

The electronic cassette 20 according to the present embodiment is available as different electronic cassettes according to four examples, i.e., as electronic cassettes 20A through 20D according to first through fourth examples, depending on the order in which the resetting light source 78, the switching filter 76, the photodetector substrate 72, and the scintillator 74 are arranged along the direction in which radiation 16 is applied.

FIG. 3A shows the electronic cassettes 20A, 20B according to the first and second examples. Each of the electronic cassettes 20A, 20B is an indirect-conversion-type radiographic image capturing apparatus, in which the radiation detector 70 is an ISS (Irradiation Side Sampling) type, i.e., a face-side readout type, which includes the resetting light source 78, the switching filter 76, the photodetector substrate 72, and the scintillator 74, which are arranged successively in this order along the direction in which radiation 16 (see FIGS. 1, 4A through 5B) is applied.

FIG. 3B shows the electronic cassettes 20C, 20D according to third and fourth examples. Each of the electronic cassettes 20C, 20D is an indirect-conversion-type radiographic image capturing apparatus, in which the radiation detector 70 is a PSS (Penetration Side Sampling) type, i.e., a reverse-readout type, which includes the scintillator 74, the photodetector substrate 72, the switching filter 76, and the resetting light source 78, which are arranged successively in this order along the direction in which radiation 16 is applied.

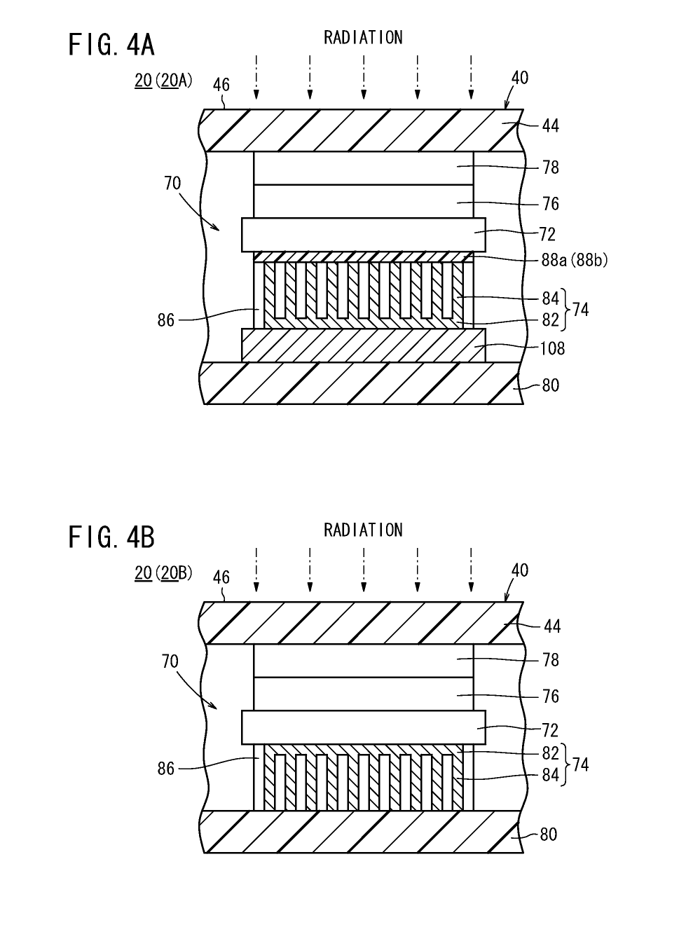

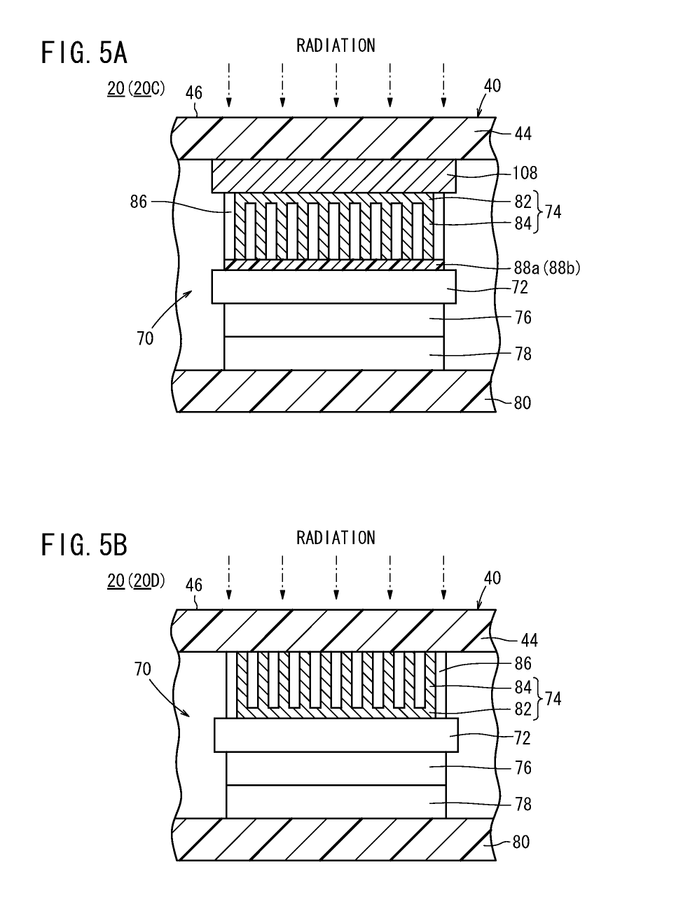

Basic structural details of the electronic cassettes 20A through 20D according to the first through fourth examples will be described below, respectively, with reference to FIGS. 4A through 5B. FIGS. 4A through 5B are fragmentary cross-sectional views of the electronic cassettes 20A through 20D in the vicinity of the radiation detector 70 in the casing 44.

In each of the electronic cassettes 20A through 20D according to the first through fourth examples, the radiation detector 70 is disposed between the irradiation surface 46, as a top plate and a bottom plate 80, on a bottom side remote from the irradiation surface 46. The electronic cassettes 20A through 20D are different from each other in the following ways.

In the electronic cassette 20A according to the first example, as shown in FIG. 4A, the scintillator 74 is deposited on an evaporated substrate 108 disposed on the bottom plate 80. More specifically, the scintillator 74 is formed as strips of a columnar crystalline structure 84 by depositing CsI:Tl (cesium iodide with added thallium), for example, by way of vacuum evaporation on the upper surface of the evaporated substrate 108, which is impermeable to visible light 130 as well as resetting light 132 (see FIGS. 12A through 14B, 15B, and 16). The scintillator 74 includes a proximal end portion located near the evaporated substrate 108 as a non-columnar crystalline portion 82.

The columnar crystalline structure 84 includes columns, which extend in a direction substantially perpendicular to the evaporated substrate 108 and the photodetector substrate 72, i.e., in a vertical direction in FIG. 4A along which radiation 16 is applied, with certain gaps being present between adjacent ones of the columns. Since the columnar crystalline structure 84, particularly the non-columnar crystalline portion 82, is vulnerable to moisture, the scintillator 74 of CsI (CsI:Tl) is sealed by a light-permeable moisture-resistant protective layer 86 made of polyparaxylylene resin (Parylene: registered trademark). With the scintillator 74 being sealed by the light-permeable moisture-resistant protective layer 86, the distal end portion of the columnar crystalline structure 84 of the scintillator 74 and the photodetector substrate 72 are held in close contact with each other by a bonding layer 88a or an adhesive layer 88b, which is permeable to visible light 130 as well as resetting light 132. A specific process of manufacturing the electronic cassette 20A according to the first example will be described later.

In FIG. 4A and certain subsequent figures, the gaps between the columns of the columnar crystalline structure 84 are shown as exaggerated for enabling easier understanding of the present invention.

Visible light 130 (see FIGS. 13A and 13B) emitted by the scintillator 74 should preferably be in a wavelength range from 360 nm to 830 nm, and more preferably, should include a wavelength range of the color green in order to make it possible for the radiation detector 70 to capture monochromatic radiographic images. In particular, CsI:Tl has an emission spectrum in a wavelength range from 420 nm to 700 nm upon being irradiated with radiation 16, with an emission peak wavelength of 565 nm in the visible range.

In order to keep the distal end portion of the scintillator 74 and the photodetector substrate 72 in increased close contact with each other, for thereby preventing the scintillator 74 and the photodetector substrate 72 from becoming spaced from each other while the electronic cassette 20A is in use, the distal end portion of the columnar crystalline structure 84 and the photodetector substrate 72 should firmly be bonded to each other by the bonding layer 88a. If at least one of the scintillator 74 and the photodetector substrate 72 are configured to be replaceable in view of possible failures thereof, then the distal end portion of the columnar crystalline structure 84 and the photodetector substrate 72 may be adhered to each other separately by the adhesive layer 88b, which does not require as strong a bonding strength as the bonding layer 88a.

As shown in FIG. 4B, the electronic cassette 20B according to the second example differs from the electronic cassette 20A (see FIG. 4A) according to the first example, in that the scintillator 74 is deposited on a side of the photodetector substrate 72 that faces the bottom plate 80.

As shown in FIG. 5A, the electronic cassette 20C according to the third example differs from the electronic cassette 20A (see FIG. 4A) according to the first example, in that the radiation detector 70 is vertically reversed or turned upside down. As shown in FIG. 5B, the electronic cassette 20D according to the fourth example differs from the electronic cassette 20B (see FIG. 4B) according to the second example, in that the radiation detector 70 is vertically reversed or turned upside down.

In each of the electronic cassettes 20A through 20D according to the first through fourth examples, the resetting light source 78, the switching filter 76, and the photodetector substrate 72 may be secured in position within the casing 44 by any of various known securing means, such as bonding with a bonding agent, adhesion with an adhesive agent, or fixing with a fixing means.

In FIGS. 4A through 5B, the scintillator 74 is made of CsI:Tl. However, the scintillator 74 may be made of GOS (gadolinium oxide sulfur) by coating the photodetector substrate 72 or the switching filter 76 with GOS.

Further, other than the scintillator 74 made of CsI:Tl or GOS, for example, the scintillator 74 may be made of BaFCl:Eu, BaFBr:Eu, YTaO₄, BaSO₄:Eu, or HfP₂O₇, which emits fluorescence (e.g., ultraviolet radiation) having an emission peak wavelength in a wavelength range from the violet (light) range to the ultraviolet range. In this case, the photodetector substrate 72 may convert fluorescence having such an emission peak wavelength emitted from the scintillator 74 into electric signals.

Specific structural details of the photodetector substrate 72, the switching filter 76, and the resetting light source 78 will be described below with reference to FIGS. 6A through 16.

As a representative example, specific structural details of the photodetector substrate 72, the switching filter 76, and the resetting light source 78 of the electronic cassette 20A according to the first example will be described below with reference to FIGS. 6A through 16. In FIGS. 6A through 16, certain components thereof are illustrated in a simplified or exaggerated form to facilitate easier understanding of the present invention. Specific structural details shown in FIGS. 6A through 16 may be modified and/or applied to the electronic cassettes 20B through 20D according to the second through fourth examples.

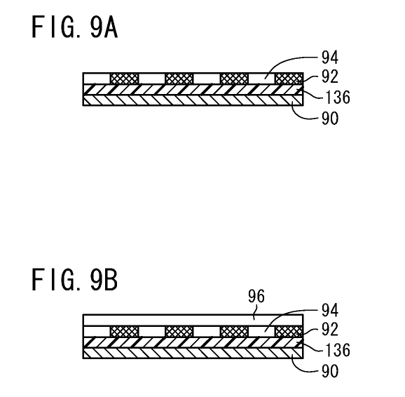

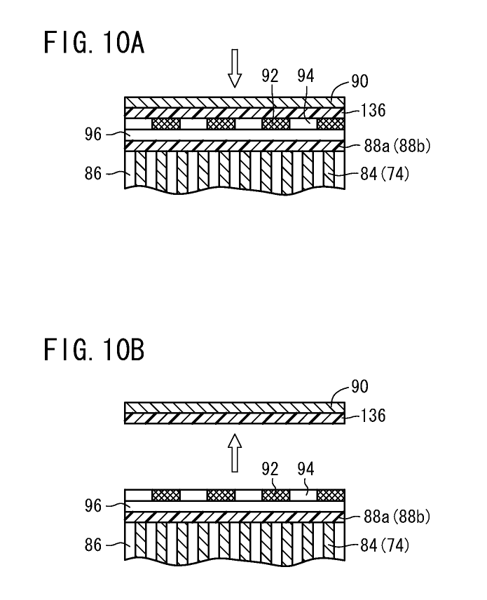

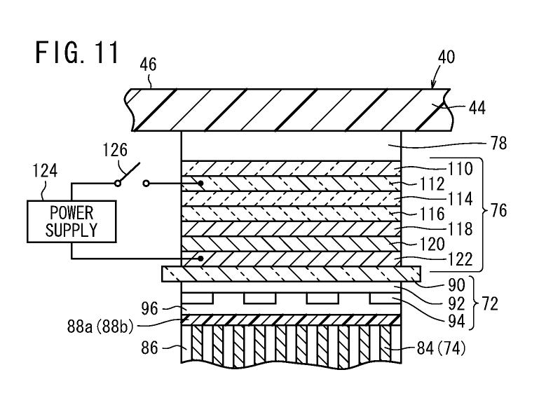

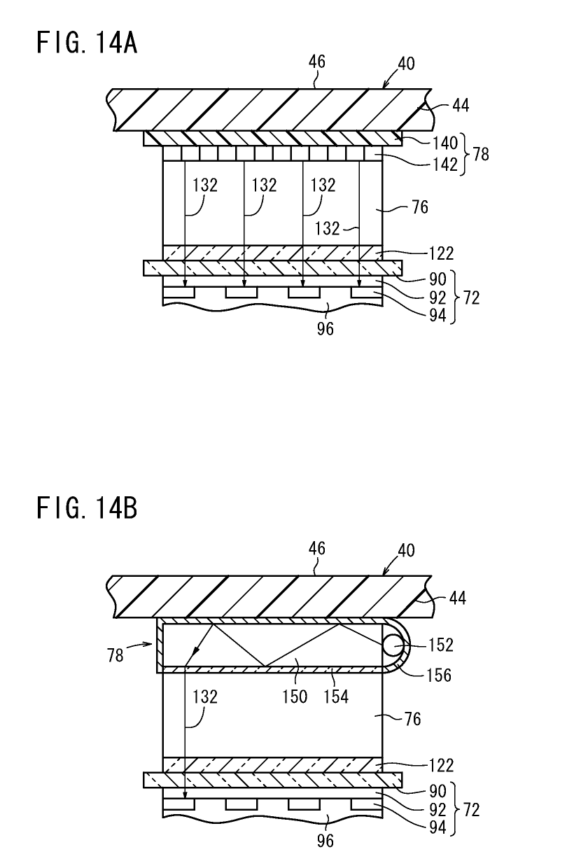

FIGS. 6A through 8B show different structures of the photodetector substrate 72. FIGS. 9A through 10B show a process of manufacturing the radiation detector 70. FIGS. 11 through 13B show in detail different structural details of the switching filter 76. FIGS. 14A through 16 show different structures of the resetting light source 78.

In the structure shown in FIG. 6A, the photodetector substrate 72 includes a base 90, which is permeable at least to the resetting light 132 (see FIGS. 12A through 14B, 15B, and 16), an array of TFTs (Thin Film Transistors) 92 disposed as switching elements on a surface of the base 90 that faces toward the bottom plate 80, and a plurality of photodetector devices 94 such as photodiodes made of a-Si or the like disposed on the array of TFTs 92. The photodetector devices 94, which contain a-Si, have a wide absorption spectrum and hence are capable of efficiently absorbing visible light 130 from the scintillator 74.

Since the photodetector devices 94, which are provided on the array of TFTs 92 disposed on the surface of the base 90 that faces the bottom plate 80, make surface irregularities on the photodetector substrate 72, it is desirable to perform a planarization process by covering the photodetector devices 94 with a planarization film 96 of polytetrafluoroethylene. The scintillator 74 of CsI:Tl is held in close contact with the planarization film 96, with the bonding layer 88a or the adhesive layer 88b interposed therebetween. Therefore, the base 90, the TFTs 92, the photodetector devices 94, the planarization film 96, and the bonding layer 88a or the adhesive layer 88b are arranged successively along the direction in which radiation 16 is applied, i.e., in the downward direction shown in FIG. 6A.

The base 90 may be a thin base plate, which is resistant to heat that is applied upon forming the TFTs 92 and the photodetector devices 94. The base 90 is normally a glass substrate, but may be made of various other materials.

More specifically, so that the TFTs 92 and the photodetector devices 94 can be deposited as films at low temperatures, the photodetector devices 94 may be made of an organic photoconductor (OPC) for converting fluorescence in the visible range (visible light 130) emitted from the scintillator 74 into electric signals, or an amorphous oxide semiconductor, e.g., IGZO (InGaZnOx) or the like, for converting fluorescence having an emission peak wavelength in the wavelength range from the violet range to the ultraviolet range (e.g., ultraviolet radiation) emitted from the scintillator 74 into electric signals. The TFTs 92 may be made of an organic semiconductor (e.g., phthalocyanine compound, pentacene, or vanadyl phthalocyanine), an amorphous oxide semiconductor, e.g., a-IGZO (InGaZnO₄), or carbon nanotubes. With such materials, a plastic film, which is flexible and permeable at least to the resetting light 132, such as a polyimide film, a polyarylate film, a biaxially-oriented polystyrene film, an aramid film, or a film of bionanofibers, may be used as the base 90.

The plastic film, which may be used as the base 90, will be described in greater detail below. The plastic film, which may be used as the base 90, should preferably be a flexible substrate of a polyester such as polyethylene terephthalate, polybutylene phthalate, polyethylene naphthalate, or the like, or polystyrene, polycarbonate, polyethersulfone, polyarylate, polyimide, polycycloolefin, norbornene resin, poly(chlorotrifluoroethylene), or the like. A flexible substrate of plastic makes the electronic cassette 20 (20A) light in weight and hence easy to carry.

The base 90 may include an insulating layer for making the base 90 electrically insulative, a gas barrier layer for making the base 90 impermeable to water and oxygen, and an undercoat layer for making the base 90 flat or in better intimate contact with electrodes.

An aramid film for use as the base 90 is advantageous in that, since a high-temperature process at 200 degrees Celsius may be applied thereto, the aramid film allows a transparent electrode material to be set at a high temperature in order to exhibit lower resistance, and also allows driver ICs to be automatically mounted thereon by a process including a solder reflow process. Furthermore, inasmuch as an aramid film has a coefficient of thermal expansion close to that of ITO (Indium Tin Oxide) and glass, a base made of an aramid film is less likely to become warped or cracked after fabrication. In addition, a base made of an aramid film may be made thinner than a glass substrate or the like. The base 90 may also be in the form of a stacked assembly comprising an ultrathin glass substrate and an aramid film.

Bionanofibers are made by compounding a bundle of cellulose microfibrils (bacteria cellulose) produced by bacteria (acetic acid bacteria, Acetobacter Xylinum) and a transparent resin. The bundle of cellulose microfibrils has a width of 50 nm, which is 1/10 the wavelength of visible light 130, is highly strong and highly resilient, and is subject to low thermal expansion. Bionanofibers, which contain 60% to 70% of fibers and exhibit a light transmittance of about 90% at a wavelength of 500 nm, can be produced by impregnating bacteria cellulose with a transparent resin such as an acrylic resin, an epoxy resin, or the like, and setting the transparent resin. Bionanofibers are flexible and have a low coefficient of thermal expansion ranging from 3 ppm to 7 ppm, which is comparable to silicon crystals, a high strength of 460 MPa that matches the strength of steel, and a high resiliency of 30 GPa. Therefore, if the base 90 is made of bionanofibers, the base 90 can be thinner than glass substrates or the like.

The photodetector devices 94, which include an organic photoconductor, exhibit a sharp absorption spectrum in the range of visible light 130 and do not absorb electromagnetic waves other than visible light 130. Therefore, any noise that would be produced if radiation 16 were absorbed by the photodetector devices 94 is effectively minimized.

In order for the organic photoconductor to absorb visible light 130 most efficiently, the absorption peak wavelength thereof should preferably be as close as possible to the light emission peak wavelength of the scintillator 74. Although the absorption peak wavelength of the organic photoconductor and the light emission peak wavelength of the scintillator 74 should ideally be in agreement with each other, it is possible to sufficiently absorb visible light 130 if the difference in wavelength between the absorption peak wavelength and the light emission peak wavelength is small enough. More specifically, the difference between the absorption peak wavelength of the organic photoconductor and the light emission peak wavelength should preferably be 10 nm or smaller, and more preferably, 5 nm or smaller.

Organic photoconductors that meet the above requirements include quinacridone-based organic compounds and phthalocyanine-based organic compounds. Since quinacridone has an absorption peak wavelength of 560 nm in the visible range, if quinacridone is used as the organic photoconductor and CsI:Tl is used as the material of the scintillator 74, then the difference between the aforementioned peak wavelengths can be reduced to 5 nm or smaller, thereby making it possible to substantially maximize the amount of electric charge generated by the photodetector devices 94.

If the TFTs 92 are made of an organic semiconductor, an amorphous oxide semiconductor, or carbon nanotubes, then the TFTs 92 can effectively prevent noise from being produced, because the TFTs 92 do not absorb radiation 16 or absorb only a small dose of radiation 16. In particular, if the TFTs 92 are made of carbon nanotubes, then the TFTs 92 can have a high switching speed and exhibit a low absorption rate both for visible light 130 and resetting light 132. If the TFTs 92 are made of carbon nanotubes, then since the performance of the TFTs 92 could be degraded significantly by trace metal impurities mixed therein, it is necessary to separate and extract highly pure carbon nanotubes by a centrifugal separator or the like.

With the electronic cassette shown in FIG. 6A, radiation 16 that has passed through the subject 14 is transmitted to the scintillator 74 through the irradiation surface 46 (top plate) of the casing 44, the resetting light source 78, the switching filter 76, the photodetector substrate 72, and the bonding layer 88a or the adhesive layer 88b. Such radiation 16 is then converted by the columnar crystalline structure 84 of the scintillator 74 into fluorescence in the visible range (visible light 130), which travels through the columns of the columnar crystalline structure 84, and then is transmitted to the photodetector devices 94 via the bonding layer 88a or the adhesive layer 88b and the planarization film 96 (see FIGS. 13A and 13B).

Part of the visible light 130 that travels toward the evaporated substrate 108 is reflected toward the photodetector substrate 72 by the non-columnar crystalline portion 82 and the evaporated substrate 108. This portion of the visible light 130 (i.e., reflected light) reaches the photodetector devices 94 via the scintillator 74, the bonding layer 88a or the adhesive layer 88b, and the planarization film 96.

Therefore, the photodetector devices 94 convert visible light 130 into analog electric signals and store the electric signals as electric charges. The TFTs 92 read the electric charges stored in the photodetector devices 94 as an image signal.

The structure shown in FIG. 6B differs from the structure shown in FIG. 6A, in that the TFTs 92 and the photodetector devices 94 are alternately positioned. A TFT 92 and a photodetector device 94, which are disposed adjacent to each other, make up an area corresponding to one pixel. Since the TFTs 92 and the photodetector devices 94 of the photodetector substrate 72 have surface irregularities, it is preferable for the TFTs 92 and the photodetector devices 94 to be covered with a planarization film 96, in order to keep the scintillator 74 and the photodetector substrate 72 in close contact with each other together with the bonding layer 88a or the adhesive layer 88b interposed therebetween.

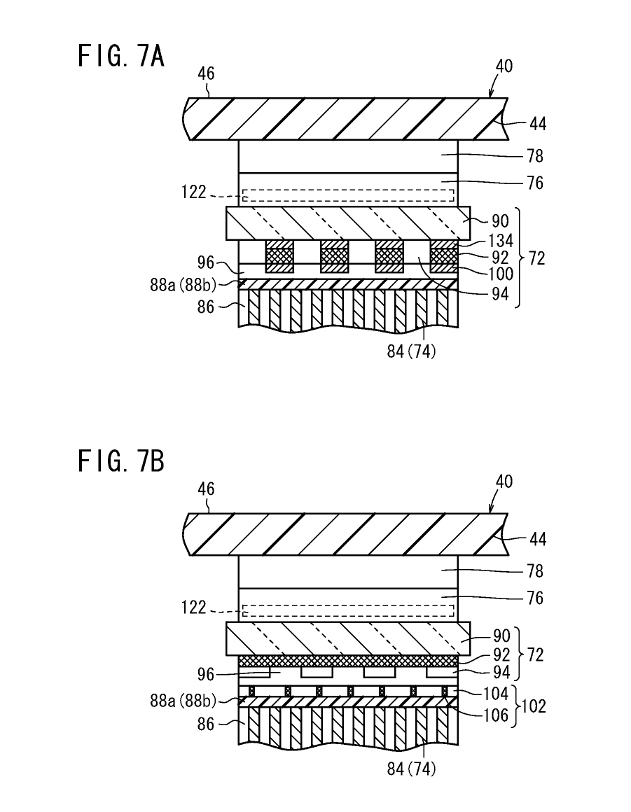

The structure shown in FIG. 7A differs from the structures shown in FIGS. 6A and 6B, in that the photodetector devices 94, each of which is in the form of a photodiode of a-Si, and stacked assemblies, each including a light shield layer 134, the TFT 92 of a-Si, and a light shield layer 100, are alternately disposed on the surface of the base 90 that faces toward the scintillator 74. The planarization film 96 is disposed on the surface of the photodetector substrate 72 near the light shield layers 100 and the photodetector devices 94.

If visible light 130 from the scintillator 74 and resetting light 132 from the resetting light source 78 are applied to the photodetector substrate 72, light traveling toward the photodetector devices 94 is applied to the photodetector devices 94, and light traveling toward the TFTs 92 is fully absorbed by the light shield layers 100, 134. With the structure shown in FIG. 7A, visible light 130 or resetting light 132 can efficiently be applied to the photodetector devices 94, and switching noise, which otherwise would be generated by the TFTs 92 if the TFTs 92 were exposed to visible light 130 or resetting light 132, is reliably prevented.

The structure shown in FIG. 7B differs from the structures shown in FIGS. 6A through 7A, in that an oblique light blocking layer 102, for blocking visible light 130 that travels obliquely to the direction in which radiation 16 is applied, is interposed between the planarization film 96 and the bonding layer 88a or the adhesive layer 88b. The oblique light blocking layer 102 includes light transmitters 104 made of a material permeable to visible light 130, e.g., silicone resin, olefin resin, urethane resin, acrylic resin, cellulose resin, polyester resin, or polycarbonate resin, and light blockers 106 made of a material having a high absorption rate for visible light 130, e.g., a dark metal oxide, a pigment, or a dye. The light transmitters 104 and the light blockers 106 are alternately arrayed along the surface of the planarization film 96, i.e., in a horizontal direction.

Visible light 130, which is applied within a predetermined angle with respect to the direction in which radiation 16 is applied, passes through the light transmitters 104 to the photodetector substrate 72. Visible light 130 that is applied obliquely at an angle beyond the predetermined angle is fully absorbed by the light blockers 106 and is prevented from being applied to the photodetector substrate 72. As a result, the photodetector substrate 72 is rendered more sensitive with respect to visible light 130, and the generated radiographic image is prevented from becoming blurred due to obliquely applied light.

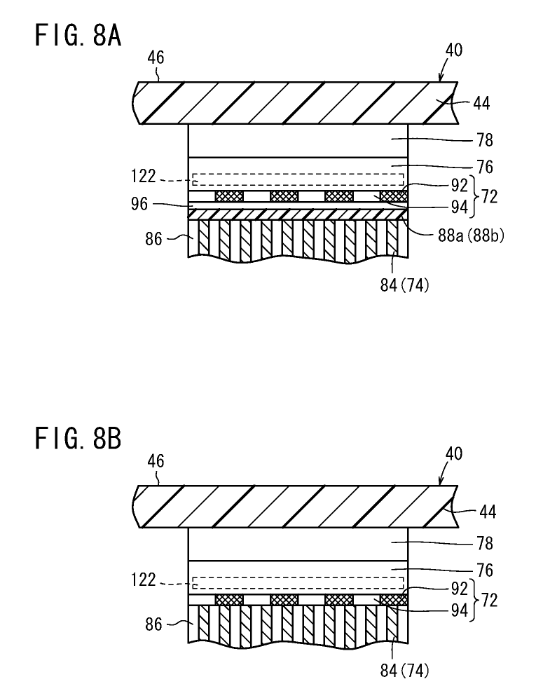

The structure shown in FIG. 8A differs from the structure shown in FIG. 6B, in that the base 90 is dispensed with. Since there is no base 90, radiation 16, which would otherwise be absorbed by the base 90, reaches the scintillator 74, and thus, the sensitivity of the photodetector devices 94 with respect to visible light 130 is increased. The photodetector substrate 72, which is free of the base 90, makes the radiation detector 70 thinner in profile.

The structure shown in FIG. 8B differs from the structure shown in FIG. 7A, in that, after the scintillator 74 is sealed by the moisture-resistant protective layer 86 to cover the columns of the columnar crystalline structure 84 with polyparaxylylene according to CVD (Chemical Vapor Deposition), the TFTs 92 and the photodetector devices 94 are formed directly on the distal end portion of the columnar crystalline structure 84. Since the distal end portion of the columnar crystalline structure 84 and the photodetector devices 94 are held in direct contact with each other with no bonding layer 88a or adhesive layer 88b interposed therebetween, the sensitivity of the photodetector devices 94 with respect to visible light 130 is further increased, and the radiographic image is reliably prevented from becoming blurred. If the photodetector devices 94 are made of an organic photoconductor or an amorphous oxide semiconductor, and the TFTs 92 are made of an organic semiconductor, an amorphous oxide semiconductor, e.g., a-IGZO, or carbon nanotubes, then the TFTs 92 and the photodetector devices 94 can be formed on the distal end portion of the columnar crystalline structure 84 and can be deposited as films at low temperatures.

FIGS. 9A through 10B show a process of manufacturing the radiation detector 70, which incorporates the structure shown in FIG. 8A.

First, as shown in FIG. 9A, the TFTs 92 and the photodetector devices 94 are alternately formed on the base 90, with a peel-off layer 136 interposed therebetween. Then, as shown in FIG. 9B, a planarization process is performed on the TFTs 92 and the photodetector devices 94 to form the planarization film 96. Then, as shown in FIG. 10A, using a distal end portion of the scintillator 74, i.e., the columnar crystalline structure 84, as a transfer target, the distal end portion of the scintillator 74 and the photodetector substrate 72 are bonded to each other by the bonding layer 88a or are adhered to each other by the adhesive layer 88b. The photodetector substrate 72 may be bonded or adhered (transferred) to the scintillator 74, which serves as the transfer target, according to known transfer techniques.

Then, as shown in FIG. 10B, the peel-off layer 136 is irradiated with a laser beam, not shown, to peel the base 90 and the peel-off layer 136 from the TFTs 92 and the photodetector devices 94. Thereafter, the resetting light source 78, the switching filter 76, the photodetector substrate 72, and the scintillator 74 are placed inside the casing 44 in the order shown in FIGS. 4A and 8A, thereby housing the radiation detector 70 inside the casing 44.

Since the TFTs 92 and the photodetector devices 94 are held in direct contact with the switching filter 76 with no base 90 interposed therebetween, the generated radiographic image is effectively prevented from becoming blurred. If the base 90 is made of a material that is permeable at least to the resetting light 132, the TFTs 92 and the photodetector devices 94 may be formed directly on the base 90. In this manner, the radiation detector 70, which incorporates the structure shown in FIG. 6B, is fabricated.

The structures shown in FIGS. 6A through 8B are by way of example only, and may be combined to provide the photodetector substrate 72, etc. For example, in each of the structures shown in FIGS. 6B and 7A as well as FIGS. 8A and 8B, the oblique light blocking layer 102 may be interposed between the photodetector substrate 72 and the scintillator 74.

As shown in FIG. 11, the switching filter 76 is constructed by stacking a transparent base 110, a transparent conductive film 112, an ion storage layer 114, a solid-state electrolytic layer 116, a buffer layer 118, a catalyst layer 120, and a light-regulating mirror film layer 122 in this order along a direction from the resetting light source 78 toward the photodetector substrate 72. A power supply 124 and a switch 126 are electrically connected to the transparent conductive film 112 and the light-regulating mirror film layer 122.

The transparent base 110 serves as an evaporated substrate of the switching filter 76, which is located near the resetting light source 78. The transparent base 110 may be a glass substrate or a plastic substrate, which is permeable to resetting light 132 (see FIGS. 12A and 12B) emitted from the resetting light source 78. The transparent conductive film 112 is a transparent electrode made of ITO, which is permeable to the resetting light 132. The ion storage layer 114 is a thin film made of WO₃ (tungsten oxide), which is capable of storing hydrogen ions (H⁺). The solid-state electrolytic layer 116 is a thin film made of Ta₂O₅ (tantalum oxide). The buffer layer 118 is a metal film made of Al (aluminum). The catalyst layer 120 is a thin film made of Pd (palladium). The light-regulating mirror film layer 122 comprises a thin film fabricated from a Mg.Ni (magnesium•nickel) alloy.

If the switch 126 is turned on, the power supply 124 applies a voltage between the transparent conductive film 112 and the light-regulating mirror film layer 122, whereby the light-regulating mirror film layer 122 changes to a mirror state (non-transmissive state) or a transparent state (transmissive state). The mirror state (non-transmissive state) is a state in which the light-regulating mirror film layer 122 reflects resetting light 132 toward the resetting light source 78, and also reflects visible light 130 (see FIGS. 13A and 13B) emitted by the scintillator 74 toward the photodetector substrate 72. The transparent state (transmissive state) is a state in which the light-regulating mirror film layer 122 passes resetting light 132 therethrough to the photodetector devices 94 of the photodetector substrate 72.

Switching of the light-regulating mirror film layer 122 between the mirror state and the transparent state will be described in specific detail below.

The light-regulating mirror film layer 122 has a surface, which is normally in a mirror state and capable of reflecting visible light 130 and resetting light 132 due to the metallic luster of the Mg.Ni alloy thin film.

If the light-regulating mirror film layer 122 is in the mirror state, the switch 126 is turned on to apply a voltage, i.e., a DC voltage of a few volts, from the power supply 124 to the switching filter 76, such that the light-regulating mirror film layer 122 is set at a negative polarity and the transparent conductive film 112 is set at a positive polarity, as shown in FIG. 12A. At this time, the light-regulating mirror film layer 122 switches from the mirror state to the transparent state. More specifically, hydrogen ions (H⁺) stored in the ion storage layer 114 move through the solid-state electrolytic layer 116, the buffer layer 118, and the catalyst layer 120 to the light-regulating mirror film layer 122, whereupon the Mg.Ni alloy is hydrogenated from its metal state into a non-metal state and becomes transparent.

Once the light-regulating mirror film layer 122 has become transparent, the light-regulating mirror film layer 122 remains transparent even if the switch 126 is turned off and application of voltage from the power supply 124 to the switching filter 76 is stopped, i.e., energization of the switching filter 76 is turned off, as shown in FIG. 12B.

While the light-regulating mirror film layer 122 is in the transparent state and radiation 16 is not applied to the subject 14, i.e., a radiographic image of the subject 14 is not being captured, if the resetting light source 78 emits resetting light 132 toward the switching filter 76, the resetting light 132 passes through the transparent conductive film 112 and the light-regulating mirror film layer 122 to the photodetector devices 94 of the photodetector substrate 72. If resetting light 132 is applied to the photodetector devices 94, each in the form of a photodiode of a-Si or the like, the photodetector devices 94 are reset to embed electric charges at the impurity level of the photodiode, so that electric charges converted from visible light 130 by the photodetector devices 94 when radiation 16 is applied thereto, i.e., when a radiographic image of the subject 14 is being captured, will not become trapped by the impurity level.

If the light-regulating mirror film layer 122 is in the transparent state, the switch 126 is turned on to apply a voltage, i.e., a DC voltage of a few volts, which is opposite in polarity to the voltage polarity shown in FIG. 12A, to the switching filter 76, such that the light-regulating mirror film layer 122 is set at a positive polarity and the transparent conductive film 112 is set at a negative polarity, as shown in FIG. 13A. At this time, the light-regulating mirror film layer 122 switches from the transparent state to the mirror state. More specifically, hydrogen ions, which have moved to the light-regulating mirror film layer 122, flow back through the catalyst layer 120, the buffer layer 118, and the solid-state electrolytic layer 116 to the ion storage layer 114, under the influence of applied voltage that is opposite in polarity, whereupon the light-regulating mirror film layer 122 changes back to its original metal state.

With the light-regulating mirror film layer 122 returned to the mirror state, the light-regulating mirror film layer 122 remains in the mirror state even if the switch 126 is turned off and application of voltage from the power supply 124 to the switching filter 76 is stopped, as shown in FIG. 13B.

While the light-regulating mirror film layer 122 is in a mirror state and radiation 16 is applied to the subject 14, i.e., if a radiographic image of the subject 14 is captured, among the visible light 130 that is converted from radiation 16 by the scintillator 74, light that is applied to the photodetector substrate 72 and which travels toward the light-regulating mirror film layer 122 is reflected toward the photodetector substrate 72 by the light-regulating mirror film layer 122. The photodetector devices 94 then detect, as electric signals, fluorescence, i.e., visible light 130, converted by the scintillator 74 and applied directly through the bonding layer 88a or the adhesive layer 88b and the planarization film 96, and also detect reflected light, i.e., visible light 130, that passes through the photodetector substrate 72 and is reflected by the light-regulating mirror film layer 122. As a result, the sensitivity of the photodetector devices 94 with respect to visible light 130 easily is increased.

When a radiographic image of the subject 14 is captured, i.e., when radiation 16 is applied to the subject 14, the resetting light source 78 may be irradiated with radiation 16 and caused to emit resetting light 132, or may be energized in error and thereby emit resetting light 132. Particularly, if the radiation detector 70 is of an ISS type, then since the resetting light source 78, the switching filter 76, the photodetector substrate 72, and the scintillator 74 are arranged successively in this order along the direction in which radiation 16 is applied, radiation 16 necessarily passes through the resetting light source 78 and has the possibly to trigger the resetting light source 78 to thereby emit resetting light 132 during a radiographic image capturing process.

However, if the light-regulating mirror film layer 122 is kept in the mirror state during the radiographic image capturing process, then even in a case where resetting light 132 is emitted from the resetting light source 78 due to application of radiation 16 thereto, the light-regulating mirror film layer 122 reflects the resetting light 132 back toward the resetting light source 78. Consequently, resetting light 132 is reliably prevented from traveling toward the photodetector substrate 72 during the radiographic image capturing process.

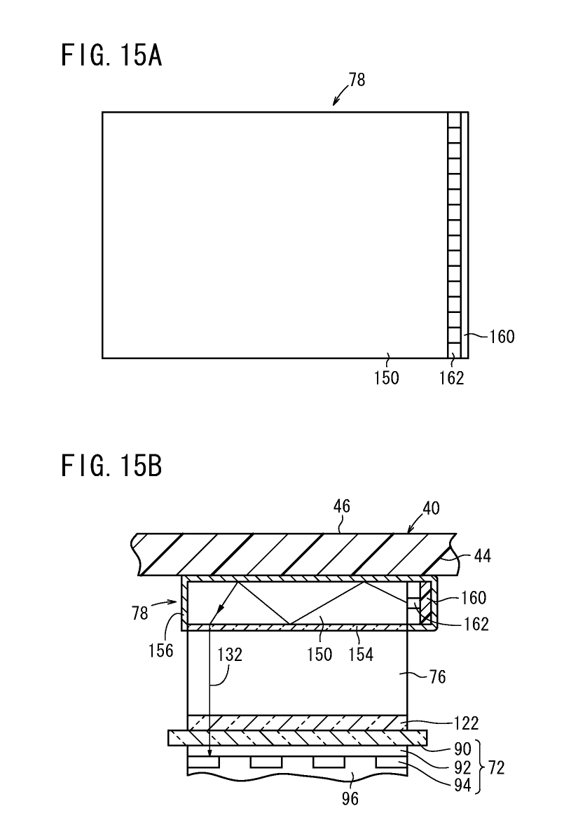

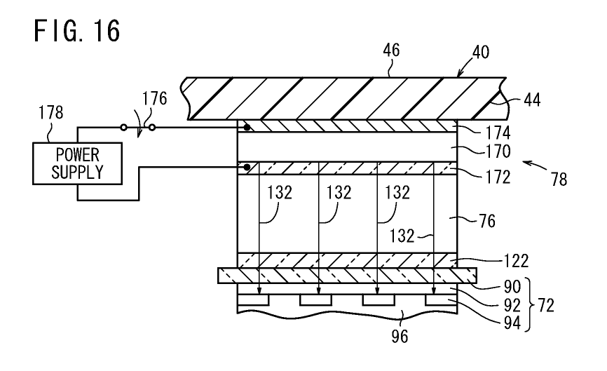

FIGS. 14A through 16 show different resetting light sources 78. Each of the resetting light sources 78 includes an array of light-emitting elements 142 (see FIG. 14A), a backlight (see FIGS. 14B through 15B), or an electroluminescent light source (see FIG. 16), disposed in facing relation to the photodetector substrate 72, with the switching filter 76 interposed therebetween.

The resetting light source 78 shown in FIG. 14A includes the array of light-emitting elements 142 in the form of light-emitting diodes (LEDs) or the like, which are disposed on a base 140 mounted on the wall of the casing 44 including the irradiation surface 46. While the light-regulating mirror film layer 122 is in the transparent state, if the light-emitting elements 142 simultaneously emit resetting light 132, the resetting light source 78 functions as a surface emission light source. Resetting light 132 is uniformly applied through the switching filter 76 to the photodetector devices 94 in order to reset the photodetector devices 94.

The resetting light source 78 shown in FIG. 14A also is capable of pinpointing each of the photodetector devices 94 to reset a certain device by energizing only the light-emitting element 142 that faces toward the pinpointed photodetector device 94.

The resetting light source 78 shown in FIG. 14B is an edge-lit backlight, including a light guide plate 150 disposed between the wall of the casing 44, which has the irradiation surface 46, and the switching filter 76, and a cold-cathode ray tube (light source) 152 disposed on a side of the light guide plate 150. The region in which the cold-cathode ray tube 152 is disposed is not irradiated with radiation 16. A diffusion sheet 154 is interposed between the light guide plate 150 and the switching filter 76, and a reflective sheet 156 is disposed in surrounding relation to the light guide plate 150 and the cold-cathode ray tube 152. If light is applied from the cold-cathode ray tube 152 toward the light guide plate 150, the applied light is repeatedly reflected within the light guide plate 150 by surfaces of the reflective sheet 156 and the diffusion sheet 154, and then the light is emitted as resetting light 132 through the diffusion sheet 154 toward the switching filter 76.

In FIG. 14B, only one ray of resetting light 132 is illustrated. Actually, however, light applied from the cold-cathode ray tube 152 toward the light guide plate 150 is repeatedly reflected by the surfaces, and spreads fully within the light guide plate 150, so that such light is emitted as surface-emission resetting light 132 from the diffusion sheet 154 toward the switching filter 76. Therefore, the resetting light source 78 in the form of a backlight also functions as a surface-emission light source for uniformly applying resetting light 132 through the switching filter 76 to the photodetector devices 94 to thereby reset the photodetector devices 94.

The resetting light source 78 shown in FIGS. 15A and 15B, which also is an edge-lit backlight, differs from the resetting light source 78 shown in FIG. 14B, in that the resetting light source 78 includes a substrate 160 supporting thereon a linear array of light-emitting elements (light sources) 162 such as LEDs or the like, instead of the cold-cathode ray tube 152. The region in which the light-emitting elements 162 and the substrate 160 are disposed is not irradiated with radiation 16. If light is applied from the light-emitting elements 162 toward the light guide plate 150, the applied light is repeatedly reflected by surfaces of the reflective sheet 156 and the diffusion sheet 154, and spreads fully within the light guide plate 150, so that such light is emitted as surface-emission resetting light 132 from the diffusion sheet 154 toward the switching filter 76. Therefore, the resetting light source 78 is capable of uniformly applying resetting light 132 through the switching filter 76 to the photodetector devices 94 to thereby reset the photodetector devices 94. In FIG. 15B, only one ray of the resetting light 132 is illustrated.

The resetting light source 78 shown in FIG. 16 is an organic electroluminescence (EL) light source or an inorganic electroluminescence (EL) light source. The resetting light source 78 includes a light-emitting layer 170 made of an organic EL material or an inorganic EL material, a transparent electrode 172 made of ITO, which is permeable to resetting light 132, and a metal electrode 174, which is impermeable to resetting light 132. The transparent electrode 172 and the metal electrode 174 are electrically connected to a switch 176 and a power supply 178. If the light-regulating mirror film layer 122 is in the transparent state, the switch 176 is turned on to apply a voltage from the power supply 178 between the transparent electrode 172 and the metal electrode 174, such that the transparent electrode 172 is set at a positive polarity and the metal electrode 174 is set at a negative polarity. At this time, the light-emitting layer 170 emits surface-emission resetting light 132 through the transparent electrode 172 to the switching filter 76.

Therefore, the resetting light source 78, whether it is made of an organic EL light source or an inorganic EL light source, is capable of uniformly applying resetting light 132 through the switching filter 76 to the photodetector devices 94, to thereby reset the photodetector devices 94.

As the above-mentioned resetting light 132 emitted from the resetting light source 78, for example, it is preferable to use dark red light or infrared radiation having energy of 0.8 eV to 2.0 eV (corresponding to the wavelength from 620 nm to 1550 nm) for resetting the photodetector devices 94.

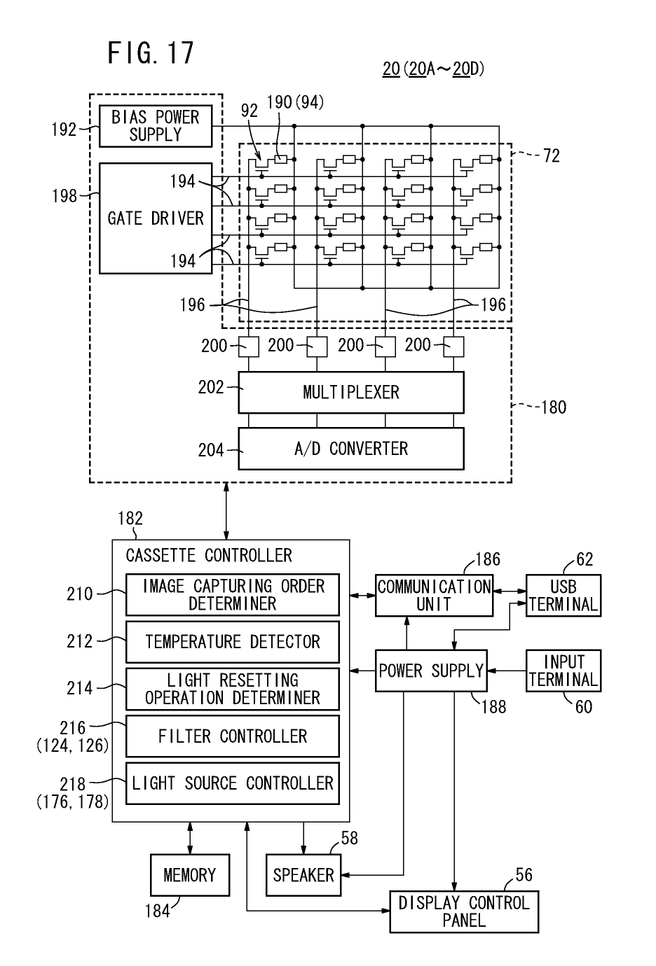

FIG. 17 is a schematic view, partially in block form, of an electric arrangement of the electronic cassette 20 (20A through 20D) shown in FIG. 1.

As shown in FIG. 17, the photodetector substrate 72 of the electronic cassette 20 (20A through 20D) has a structure including an array or matrix of photodetector devices 94 and TFTs 92. The photodetector devices 94 will also be referred to as pixels 190.

The pixels 190, which are arranged in a matrix of rows and columns, are energized upon application of a bias voltage thereto from a bias power supply 192 of a drive circuit 180. The pixels 190 store electric charges that are generated in a case where visible light 130 converted from radiation 16 by the scintillator 74 is photoelectrically converted. The electric charges stored in the pixels 190 are read as pixel values of analog signals (electric charge signals, electric signals) via signal lines 196 if the TFTs 92 are successively turned on column by column. In FIG. 17, the pixels 190 and the TFTs 92 are arranged in a matrix of four vertical columns and four horizontal rows. However, the pixels 190 and the TFTs 92 may be arranged in a matrix of any desired number of vertical columns and any desired number of horizontal rows.

The TFTs 92, which are electrically connected to the respective pixels 190, are connected to gate lines 194 extending along the respective rows and signal lines 196 extending along the respective columns. The gate lines 194 are connected to a gate driver 198 of the drive circuit 180, and the signal lines 196 are connected to a multiplexer 202 of the drive circuit 180 through respective charge amplifiers. The multiplexer 202 is connected to an A/D converter 204, which converts analog electric signals into digital electric signals. The A/D converter 204 outputs digital electric signals, i.e., digital signal pixel values (hereinafter also referred to as digital values) to a cassette controller 182. The drive circuit 180 is included in the panel 40 or in the controller 42 (see FIG. 2). The cassette controller 182 is included in the controller 42.

The cassette controller 182 controls the electronic cassette 20 (20A through 20D) in its entirety. An information processing apparatus such as a computer or the like may function as the cassette controller 182 if the information processing apparatus reads and executes a program, which corresponds functionally to the cassette controller 182.

A memory 184 and a communication unit 186 are connected to the cassette controller 182. The memory 184 stores the digital signal pixel values, and the communication unit 186 sends signals to and receives signals from the console 22. The communication unit 186 sends packets of a single image, i.e., a one-frame image, made up of a matrix of pixel values to the console 22. A power supply 188 supplies electric power to the cassette controller 182, the memory 184, and the communication unit 186, etc., and also supplies electric power to the bias power supply 192. The memory 184, the communication unit 186, and the power supply 188 are included in the controller 42.

The cassette controller 182 includes an image capturing order determiner 210, a temperature detector 212, a light resetting operation determiner 214, a filter controller 216, and a light source controller 218.

If the image capturing order determiner 210 receives order information representing an image capturing order with respect to application of radiation 16 to the subject 14, i.e., for capturing radiographic images of the subject 14, the image capturing order determiner 210 identifies, i.e., determines, an image capturing method included within the order information. The order information is produced by the doctor in the RIS 26 or the HIS 28, and includes subject information for identifying the subject 14, such as the name, age, gender, etc., of the subject 14, information concerning the radiation output device 18 and the electronic cassette 20 that are used to capture a radiographic image of the subject 14, a region to be imaged of the subject 14, a technique used to capture a radiographic image of the subject 14, and an image capturing method indicative of capturing of a still image or capturing of a moving image.

If resetting light 132 emitted from the resetting light source 78 is applied to the photodetector devices 94, i.e., the pixels 190, to thereby reset the photodetector devices 94, the photodetector devices 94 detects electric signals, i.e., dark current signals, depending on the resetting light 132, and stores the detected dark current signals as electric charges. The level of the dark current signals varies depending on the temperature of the photodiodes that serve as the photodetector devices 94. The temperature detector 212 detects the temperature of the photodetector devices 94 based on the dark current signals, i.e., pixel values thereof, which are read via the signal lines 196 from the photodetector devices 94 if the TFTs 92 are successively turned on.

The light resetting operation determiner 214 determines whether or not a light resetting process is to be performed on the photodetector devices 94, i.e., whether the photodetector devices 94 are to be reset by the resetting light 132, based on the image capturing method identified by the image capturing order determiner 210 and the temperature of the photodetector devices 94 detected by the temperature detector 212.

The filter controller 216 performs functions of the power supply 124 and the switch 126 (see FIGS. 11 through 13B), so as to apply a voltage to the switching filter 76 and control switching of the light-regulating mirror film layer 122 between the mirror state and the transparent state. The light source controller 218 performs functions of the switch 176 and the power supply 178 (see FIG. 16), so as to control emission of resetting light 132 from the resetting light source 78.

The image capturing method identified by the image capturing order determiner 210, the temperature detected by the temperature detector 212, the light resetting process determined by the light resetting operation determiner 214, switching of the switching filter 76 controlled by the filter controller 216, and emission of resetting light 132 from the resetting light source 78, which is controlled by the light source controller 218, are displayed respectively on the display control panel 56, or may be output as sounds from the speaker 58, and may be sent or indicated from the communication unit 186 to the console 22 via a wireless communication link.

### Operations of the First Embodiment

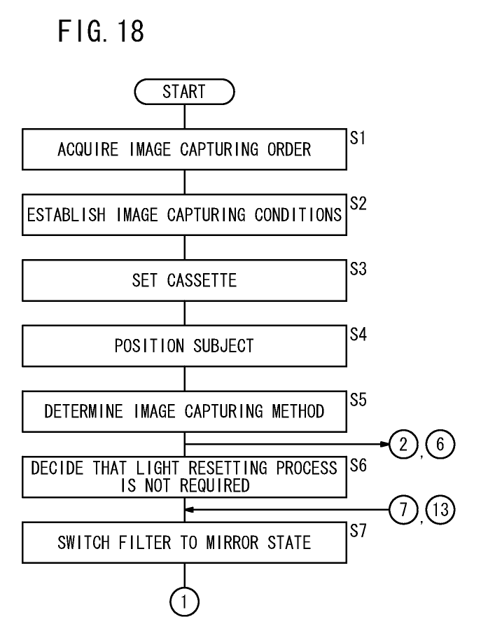

The radiographic image capturing system 10 incorporating therein the electronic cassette 20 (20A through 20D) according to the first embodiment is basically constructed as described above. Operations of the radiographic image capturing system 10 will be described below with reference to FIGS. 18 through 28, and also to FIGS. 1 through 17 as needed.

More specifically, operations of the radiographic image capturing system 10, which incorporates the electronic cassette 20A according to the first example, will be described below with reference to FIGS. 18 through 28. However, the description of operations of the radiographic image capturing system 10 also is applicable to the electronic cassettes 20B through 20D according to the second through fourth examples, provided such operations are modified depending on the configurations of the electronic cassettes 20B through 20D.

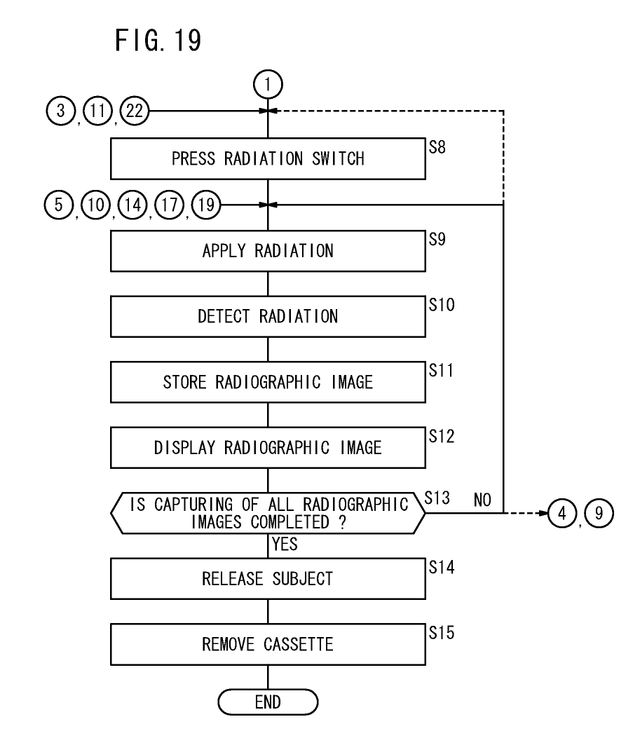

Radiographic image capturing processes [1] through [7] according to different image capturing orders will be described below.

[1] The radiographic image capturing process according to an image capturing order including capturing of at least one still image of the subject 14, i.e., a radiographic image capturing mode for capturing at least one radiographic image of the subject 14, or capturing of a moving image at a frame rate lower than a frame rate threshold value Fth, i.e., a low-rate moving image capturing mode or a first moving image capturing mode (see FIGS. 18 and 19), will be described below.

The radiographic image capturing process is an image capturing process in which the light resetting process is not performed on the photodetector devices 94.

The light resetting process is not performed on the photodetector devices 94 if noise caused by dark current signals produced in a case where electric charges trapped by the impurity level are discharged again is low enough so as not to prevent a doctor from interpreting the captured radiographic image.

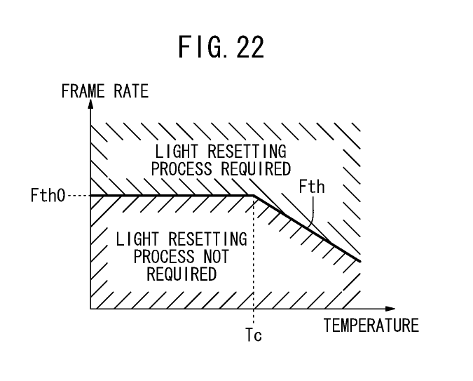

The frame rate threshold value Fth is a threshold value (see FIG. 22) used to determine whether the light resetting process should be carried out or not. If the frame rate of a moving image capturing mode is higher than the frame rate threshold value Fth, then it is judged that the light resetting process should be carried out. On the other hand, if the frame rate of a moving image capturing mode is lower than the frame rate threshold value Fth, then it is judged that the light resetting process should not be carried out.

The low-rate moving image capturing mode refers to a moving image capturing mode at a frame rate lower than the frame rate threshold value Fth (normally, Fth=Fth0). A moving image capturing mode at a frame rate higher than the frame rate threshold value Fth will hereinafter be referred to as a high-rate moving image capturing mode, or a second moving image capturing mode.

In step S1 shown in FIG. 18, the console 22 (see FIG. 1) acquires order information representing an image capturing order produced by the doctor in the RIS 26 or the HIS 28. In step S2, the doctor establishes image capturing conditions for the subject 14 based on the order information acquired by the console 22. The image capturing conditions refer to various conditions required for applying radiation 16 to a region to be imaged of the subject 14, e.g., a tube voltage and a tube current of the radiation source 30, a radiation exposure time, etc.

In step S3, the doctor grips the grip 52 (see FIGS. 2 and 3A) of the electronic cassette 20A, which has been placed in a given storage location, carries the electronic cassette 20A, and places the electronic cassette 20A on the image capturing base 12. In step S4, the doctor lays the subject 14 on the image capturing base 12 and the electronic cassette 20A so that the region to be imaged of the subject 14 is positioned within the image capturing area 50, thereby positioning the region to be imaged of the subject 14 with respect to the image capturing area 50.

Up to this time, the power supply 188 (see FIG. 17) has been supplying electric power to the cassette controller 182, the communication unit 186, and the display control panel 56. After positioning the subject 14, the doctor operates the display control panel 56 to indicate activation of the electronic cassette 20A. The cassette controller 182 then starts to supply electric power from the power supply 188 to the drive circuit 180 and the speaker 58. The bias power supply 192 starts applying a bias voltage to the pixels 190, i.e., the photodetector devices 94, which are now readied to store electric charges. The speaker 58 is also readied to output sounds representing audio signals from the cassette controller 182. As a result, the electronic cassette 20A switches from a sleep mode into an activated mode.

The cassette controller 182 sends a transmission request signal for requesting transmission of an image capturing order and image capturing conditions from the communication unit 186 to the console 22 via a wireless communication link. In response to the transmission request signal, the console 22 sends the image capturing order and the image capturing conditions to the electronic cassette 20A via a wireless communication link, and also sends the image capturing conditions to the radiation output device 18 via a wireless communication link. In the radiation output device 18, the received image capturing conditions are registered in the radiation source controller 32. In the electronic cassette 20A, the image capturing order and the image capturing conditions, which have been received, are registered in the cassette controller 182. The cassette controller 182 may also display the image capturing order and the image capturing conditions, which have been received, on the display control panel 56.

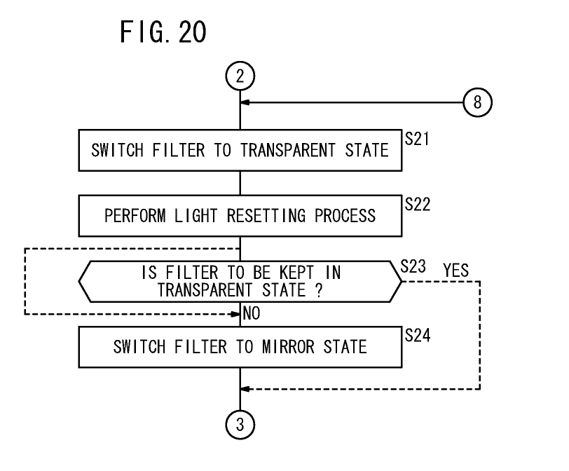

In step S5, the image capturing order determiner 210 of the cassette controller 182 determines an image capturing method included in the order information. At this time, the determined image capturing method represents capturing of at least one still image of the subject 14, or capturing of a moving image at a frame rate lower than the frame rate threshold value Fth (Fth0) (see FIG. 20), i.e., the low-rate moving image capturing mode. The image capturing order determiner 210 indicates the determined image capturing method to the light resetting operation determiner 214, and displays the determined image capturing method on the display control panel 56.

Based on the image capturing method indicated by the image capturing order determiner 210, the light resetting operation determiner 214 determines whether or not a light resetting process is to be performed on the pixels 190, i.e., the photodetector devices 94. Since the image capturing method represents capturing of at least one still image or the low-rate moving image capturing mode, in step S6, the light resetting operation determiner 214 decides that the pixels 190 do not need to be reset. The light resetting operation determiner 214 indicates the decision to the filter controller 216 and the light source controller 218, and displays the decision on the display control panel 56. The light resetting operation determiner 214 may also output a sound indicative of the decision from the speaker 58.

Based on the decision indicated by the light resetting operation determiner 214, the filter controller 216 prohibits voltage from being applied to the switching filter 76, and the light source controller 218 prohibits the resetting light source 78 from being energized. Therefore, in step S7, the light-regulating mirror film layer 122 of the switching filter 76 remains in a mirror state, and the resetting light source 78 does not emit resetting light 132.

Since the decisions made in steps S5 and S6 are displayed on the display control panel 56, by viewing the decisions displayed on the display control panel 56, the doctor can recognize that the light resetting process is not performed. If sounds representing the decisions made in steps S5 and S6 are output from the speaker 58, then by listening the sounds output from the speaker 58, the doctor can recognize that the light resetting process is not performed.

Decisions may be sent from the communication unit 186 to the console 22 via a wireless communication link. In this case, the console 22 may send the received decisions to the display device 24 via a wireless communication link, so that the display device 24 can display the judgements. Accordingly, the doctor can recognize for sure that the pixels 190 have not been reset.

In step S8 shown in FIG. 19, after the preparatory processes in steps S1 through S7 have been performed on the radiographic image capturing system 10, the doctor presses the radiation switch 34 (see FIG. 1). The radiation source controller 32 prepares itself to apply radiation 16, and sends a notice signal indicating readiness to apply radiation 16 to the console 22 via a wireless communication link. The console 22 sends a synchronization control signal for achieving synchronism with application of radiation 16 from the radiation source 30 to the electronic cassette 20A via a wireless communication link. Upon receipt of the synchronization control signal by the cassette controller 182 of the electronic cassette 20A, the cassette controller 182 displays information indicative of readiness for application of radiation 16 on the display control panel 56 (see FIGS. 2 and 17). The cassette controller 182 may also output a sound indicative of such information from the speaker 58.

In step S9, by the doctor subsequently pressing the radiation switch 34, the radiation source controller 32 applies radiation 16 from the radiation source 30 to the region to be imaged of the subject 14 for a preset period of time according to the image capturing conditions. The radiation source controller 32 may send a notice signal indicative of start of application of radiation 16 to the console 22 via a wireless communication link at the same time that radiation 16 starts to be applied. The console 22 may transfer the received notice signal to the electronic cassette 20A. In response to reception of the notice signal, the cassette controller 182 of the electronic cassette 20A may display information indicative of application of radiation 16 on the display control panel 56, and may also output a sound indicative of such information from the speaker 58.

In step S10, at the time that radiation 16 passes through the region to be imaged of the subject 14 and is applied to the radiation detector 70 of the electronic cassette 20A, because the radiation detector 70 is of an ISS type as shown in FIGS. 3A and 4A, radiation 16 passes through the resetting light source 78, the switching filter 76, the bonding layer 88a or the adhesive layer 88b, and the photodetector substrate 72, to arrive at the columnar crystalline structure 84 of the scintillator 74.

The columnar crystalline structure 84 emits visible light 130 (see FIGS. 13A and 13B) having an intensity depending on the intensity of the radiation 16, and the emitted visible light 130 is applied from the columns of the columnar crystalline structure 84, through the bonding layer 88a or the adhesive layer 88b, and to the photodetector substrate 72. A portion of the visible light 130 travels from the columns of the columnar crystalline structure 84 toward the non-columnar crystalline portion 82, and is reflected back from the non-columnar crystalline portion 82 and the evaporated substrate 108 toward the photodetector substrate 72. Reflected light also is applied to the photodetector substrate 72 via the columnar crystalline structure 84 and the bonding layer 88a or the adhesive layer 88b.

A portion of the visible light 130 that is applied to the photodetector substrate 72 is applied directly to the photodetector devices 94, and a portion of the same visible light 130 travels toward the resetting light source 78. Since the light-regulating mirror film layer 122 is in a mirror state, the portion of the visible light 130 that travels toward the resetting light source 78 is reflected back toward the photodetector substrate 72 and falls on the photodetector devices 94. Therefore, the photodetector devices 94 are irradiated with light (visible light 130) reflected by the light-regulating mirror film layer 122 in the mirror state, as well as with directly applied reflected light. As a result, the sensitivity of the pixels 190, i.e., the photodetector devices 94, of the photodetector substrate 72 with respect to visible light 130 is easily increased.

The pixels 190 convert the applied visible light 130 into electric signals and store the electric signals as electric charges. Electric charges stored in the pixels 190, which represent a radiographic image of the region to be imaged of the subject 14, are read according to drive signals supplied from the cassette controller 182 (see FIG. 17) to the gate driver 198.

More specifically, the gate driver 198 successively selects the gate lines 194 from the 0th row of the matrix of pixels 190, and supplies gate signals to the selected gate lines 194 to turn on the TFTs 92 connected to the selected gate lines 194, thereby successively reading the electric charges stored in the pixels 190 one row at a time from the 0th row of the matrix of pixels 190. The electric charges read from the pixels 190 one row at a time are transferred along the signal lines 196 to the charge amplifiers 200 in respective columns of the matrix of pixels 190. Then, in step S11, the electric charges are processed by the multiplexer 202 and the A/D converter 204, and are stored as digital electric signals in the memory 184. More specifically, the memory 184 successively stores radiographic image information represented by the digital electric signals obtained from the rows of the matrix of pixels 190.

The radiographic image information stored in the memory 184 is sent, together with cassette ID information for identifying the electronic cassette 20A, from the communication unit 186 to the console 22 (see FIG. 1) via a wireless communication link. In step S12, the console 22 displays a radiographic image represented by the radiographic image information and the cassette ID information on the display device 24. The cassette controller 182 may also display the radiographic image and the cassette ID information on the display control panel 56.

The doctor confirms the radiographic image by observing the contents displayed on the display device 24 or the display control panel 56. Thereafter, in step S13, if capturing of all of the radiographic images registered in the image capturing order is completed (step S13: YES), then in step S14, the doctor releases the subject 14 from the image capturing base 12.

Then, the doctor operates the display control panel 56 to de-energize the electronic cassette 20A. The cassette controller 182 stops supplying electric power from the power supply 188 to the drive circuit 180 and the speaker 58. The supply of the bias voltage from the bias power supply 192 to the pixels 190 also is stopped. As a result, the electronic cassette 20A switches from the activated mode into a sleep mode.

In step S15, after having confirmed that nothing is displayed on the display control panel 56 and that the electronic cassette 20A has switched to the sleep mode, the doctor grips the grip 52 (see FIGS. 2 and 3A) of the electronic cassette 20A and carries the electronic cassette 20A to the given storage location.

In step S13, if the image capturing order includes a low-rate moving image capturing mode and capturing of all moving images is not yet completed (step S13: NO), then the radiation source controller 32 performs a next moving image capturing mode (second and subsequent radiographic images), and in step S9, controls the radiation source 30 to apply radiation 16 to the region to be imaged of the subject 14 according to the image capturing conditions.

In step S13, if the image capturing order includes capturing of a plurality of still images and capturing of all still images is not yet completed (step S13: NO), then the doctor carries out step S8 again in order to perform a next still image capturing mode (second and subsequent radiographic images).

As described above, for capturing at least one still image of the subject 14 or for a low-rate moving image capturing mode, in the case that the light resetting process is not performed, a radiographic image capturing process is performed on the subject 14 while the light-regulating mirror film layer 122 remains in the mirror state.

The radiographic image capturing process [1] for a case in which the light resetting process is not performed has been described above.

The radiographic image capturing processes [2] through [7] performed using the electronic cassette 20A of an ISS type, for cases in which the light resetting process is performed on the photodetector devices 94 or the pixels 190, will be described below with reference to FIGS. 20 through 28.

Prior to describing the radiographic image capturing processes [2] through [7], the need for resetting the photodetector devices 94 or the pixels 190 with resetting light 132 will be described.

If the photodiodes of the photodetector devices 94 (see FIGS. 6A through 8B, FIGS. 11 through 14B, and FIGS. 15B through 17) are made of amorphous silicon (a-Si) or the like, then some of the electric charges converted from visible light 130 are temporarily trapped by the impurity level of the amorphous silicon. If such trapped electrons are subsequently released due to a rise in temperature of the photodiodes, which may be caused upon capturing of a moving image at a high rate, unwanted current such as dark current is generated, possibly producing noise in a resultant radiographic image of the subject 14. As explained in the “Description of the Related Art,” it heretofore has been customary to reduce noise by applying resetting light 132 to the photodiodes when radiation is not being applied to the subject 14, i.e., when a radiographic image of the subject 14 is not being captured, to thereby embed electric charges in the impurity level, so that electric charges converted from visible light 130 upon application of radiation 16 the subject 14 will not be trapped by the impurity level.

According to the above process of the related art, however, since electric charges are embedded in a relatively shallow position, if the temperature of the photodiodes rises, almost all of the electric charges are discharged from the impurity level, making it ineffective at reducing noise. In the high-rate moving image capturing mode, since the temperature of the photodiodes rises due to repeated capturing of moving images over a long period of time, if the image capturing interval, i.e., the frame rate, and the time during which electric charges are discharged from the impurity level are comparable with each other, such electric charges tend to be more prominently discharged from the impurity level and at different rates between frames.

According to the present embodiment, it is desirable that electric charges be embedded sufficiently deeply in the impurity level to eliminate varying rates between frames, during which the electric charges are discharged due to an increase in the temperature of the photodiodes, and also to remove or correct noise caused by electric charges, which are discharged at a certain rate from radiographic images, by way of an image processing sequence.

The level of dark current also varies depending on the temperature of the photodiodes. In particular, the level of dark current becomes higher as the temperature of the photodiodes rises. Not only during the moving image capturing mode, but also if a radiographic image capturing process is performed over a long period of time, such as during capturing of still images at a reduced interval in the still image capturing mode, upon switching of the moving image capturing mode to the still image capturing mode, and upon switching of the still image capturing mode to the moving image capturing mode, the temperature of the photodiodes is likely to rise, and noise due to dark current signals is not negligible.

If noise due to a rise in temperature of the photodiodes increases to the extent that such noise is not negligible, then if the temperature of the photodiodes is higher than a threshold temperature Tc, as shown in FIG. 22, it is desirable to reduce the frame rate threshold value Fth from the initial value Fth0, and to determine whether or not the photodetector devices 94 should be reset in view of the temperature of the photodiodes, regardless of whether the low-rate moving image capturing mode or the high-rate moving image capturing mode has been indicated by the image capturing order.

In the radiographic image capturing processes, with the light resetting process being performed as shown in FIGS. 20 through 28, it is determined whether or not the light resetting process should be performed in view of the temperature of the photodetector devices 94, which include photodiodes made of amorphous silicon.

Radiographic image capturing processes [2] through [7] with the light resetting process being performed will be described separately below with reference to FIGS. 20 through 28.

[2] The radiographic image capturing process according to an image capturing order including a still image capturing mode or a low-rate moving image capturing mode, with the light resetting process being carried out at least once prior to the image capturing mode (see FIG. 20), shall be described below.

Since high-quality radiographic images are required, it is assumed that the light resetting process is performed at least once prior to the image capturing mode in order to acquire radiographic images with only slight noise therein. More specifically, even if the image capturing order described above with respect to the radiographic image capturing process [1] is given, it is assumed that the light resetting process is performed at least once prior to the image capturing mode, so as to acquire radiographic images of higher quality.

In step S21 shown in FIG. 20, after step S5 (see FIG. 18), the light resetting operation determiner 214 decides that the light resetting process needs to be performed at least once prior to the image capturing mode, because the image capturing method identified by the image capturing order determiner 210 represents a radiographic image capturing mode for capturing at least one radiographic image or a low-rate moving image capturing mode. Then, the light resetting operation determiner 214 outputs the decision that the light resetting process needs to be performed at least once prior to the image capturing mode to the filter controller 216 and to the light source controller 218, while also displaying the decision on the display control panel 56. The speaker 58 may also output a sound representative of the decision.

Based on the decision from the light resetting operation determiner 214, in step S21, the filter controller 216 applies a voltage to the switching filter 76 (see FIG. 3A, FIG. 4A, FIGS. 6A through 8B, FIGS. 11 through 14B, and FIGS. 15B and 16) in order to switch the light-regulating mirror film layer 122 from the mirror state to the transparent state. Based on the same decision, the light source controller 218 energizes the resetting light source 78 to start emitting resetting light 132.

Resetting light 132 passes through the light-regulating mirror film layer 122 to the photodetector substrate 72, thereby starting the light resetting process for resetting the photodetector devices 94, i.e., the pixels 190, with resetting light 132 in step S22. Thereafter, the light source controller 218 de-energizes the resetting light source 78 so that emission of resetting light 132 is stopped, thereby finishing the light resetting process.

If, based on the decision from the light resetting operation determiner 214 in step S23 (step S23: NO), the filter controller 216 decides that it is necessary to return the light-regulating mirror film layer 122 to the mirror state, then in step S24, the filter controller 216 applies a voltage, which is opposite in polarity to the voltage applied in step S21, to the switching filter 76 in order to switch the light-regulating mirror film layer 122 from the transparent state to the mirror state.

After the light resetting process is finished, the radiographic image capturing system 10 executes step S8 shown in FIG. 19.

In step S23 shown in FIG. 20, the filter controller 216 determines whether or not the light-regulating mirror film layer 122 should switch to the mirror state according to the following criteria.

In a radiographic image capturing mode for capturing a single still image, a radiographic image with only slight noise therein can be acquired if the photodetector devices 94 are reset once prior to the image capturing mode. If the switching filter 76 is in the mirror state, then since visible light 130 is reflected toward the photodetector substrate 72, the sensitivity of the photodetector devices 94 can easily be increased. In a radiographic image capturing mode for capturing a plurality of radiographic images or a low-rate moving image capturing mode, since the temperature of the photodiodes is not expected to rise significantly if images are captured over a relatively long interval, high-quality radiographic images can be captured even if the photodetector devices 94 are not reset prior to capturing of second and subsequent radiographic images.

In such image capturing modes, therefore, the filter controller 216 may decide that the light-regulating mirror film layer 122 should switch back to the mirror state for the purpose of acquiring high-quality radiographic images with high sensitivity.

As described above, with the electronic cassette 20A (or the electronic cassette 20B) of an ISS type, since the resetting light source 78, the switching filter 76, the photodetector substrate 72, and the scintillator 74 are arranged successively in this order along the direction in which radiation 16 is applied, radiation 16 passes through the resetting light source 78 and is applied to the scintillator 74. Therefore, the resetting light source 78 could possibly be triggered by such radiation 16 and emit resetting light 132. However, as described above, if the light-regulating mirror film layer 122 is in the mirror state, then since the resetting light 132 is reflected by the light-regulating mirror film layer 122, the resetting light 132 is reliably prevented from being applied to the photodetector substrate 72 during the radiographic image capturing process.

With an ISS type of electronic cassette 20A (or the electronic cassette 20B), since the light-regulating mirror film layer 122 needs to remain in the mirror state during the radiographic image capturing process, as described above, the filter controller 216 makes an affirmative decision in step S23 (step S23: YES). Alternatively, step S23 may be dispensed with, whereupon control jumps directly from step S22 to step S24. With the electronic cassettes 20C, 20D of a PSS type, however, the filter controller 216 can make either an affirmative decision or a negative decision. Operations of electronic cassettes 20C, 20D of a PSS type will be described later.

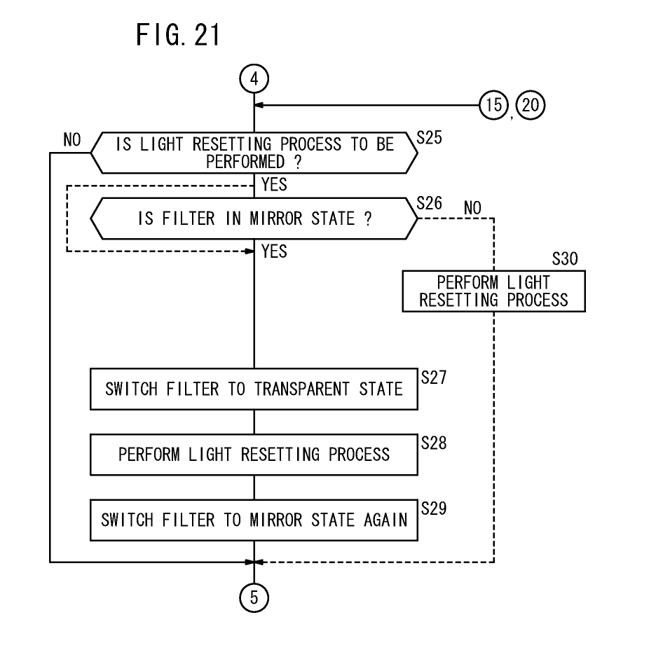

In the radiographic image capturing process [2], therefore, the light resetting process is performed at least once prior to the image capturing mode. After the light resetting process has been performed, the light-regulating mirror film layer 122 is kept in the mirror state, and a radiographic image capturing mode for capturing still images or a low-rate moving image capturing mode is carried out.

[3] The radiographic image capturing process according to an image capturing order including capturing of a plurality of images (a still image capturing mode or a moving image capturing mode) with the light resetting process being performed between image capturing cycles (see FIG. 21) shall be described below.

It is assumed that the light resetting process is performed while images are successively being captured in an image capturing mode for capturing a plurality of still images, a low-rate moving image capturing mode, or a high-rate moving image capturing mode.

In step S13, if capturing of all moving images is not yet completed (step S13: NO), then in step S25, the light resetting operation determiner 214 (see FIG. 17) decides that the light resetting process needs to be performed between image capturing cycles (step S25: YES), because the decision made by the image capturing order determiner 210 represents capturing of a plurality of images (an image capturing mode for capturing a plurality of still images or a moving image capturing mode). The light resetting operation determiner 214 outputs the decision to the filter controller 216 and the light source controller 218, while also displaying the decision on the display control panel 56. The light resetting operation determiner 214 may also output a sound indicative of the decision from the speaker 58.

Based on the decision from the light resetting operation determiner 214, in step S26, the filter controller 216 determines whether or not the light-regulating mirror film layer 122 (see FIGS. 6A through 8B, FIGS. 11 through 14B, and FIGS. 15B and 16) is in the mirror state. In step S26, if the light-regulating mirror film layer 122 is in the mirror state (step S26: YES), then in step S27, similar to step S21, the filter controller 216 applies a voltage to the switching filter 76 in order to switch the light-regulating mirror film layer 122 from the mirror state to the transparent state.

Based on the same decision, the light source controller 218 energizes the resetting light source 78 to start emitting resetting light 132, in the same manner as with step S22. More specifically, in step S28, resetting light 132 passes through the light-regulating mirror film layer 122 and is applied to the photodetector substrate 72, thereby resetting the photodetector devices 94, i.e., the pixels 190.

Thereafter, the light source controller 218 de-energizes the resetting light source 78 so as to stop emitting resetting light 132. In step S29, the filter controller 216 applies a voltage to the switching filter 76, which is opposite in polarity to the voltage in step S27, to thereby switch the light-regulating mirror film layer 122 from the transparent state to the mirror state. Thereafter, control goes back to step S9 shown in FIG. 19, in which the radiographic image capturing system 10 performs a next radiographic image capturing process.

In the radiographic image capturing process [3], therefore, steps S25 through S29 are carried out between image capturing cycles with respect to an image capturing order, which includes an image capturing mode for capturing a plurality of still images, a low-rate moving image capturing mode, or a high-rate moving image capturing mode. Accordingly, the light-regulating mirror film layer 122 is switched alternately between the mirror state and the transparent state during one frame, and the light resetting process is performed during the transparent state.

In the radiographic image capturing process [3], as with the radiographic image capturing process [2], with electronic cassettes 20A, 20B of an ISS type, the light-regulating mirror film layer 122 remains in the mirror state while images are being captured. Therefore, in step S26, the filter controller 216 makes an affirmative decision (step S26: YES). Alternatively, step S26 may be dispensed with, whereupon control jumps from step S25 directly to step S27. With electronic cassettes 20C, 20D of an PSS type, however, the filter controller 216 can make either an affirmative decision or a negative decision in step S26, as will be described later.

In step S25, if the light resetting operation determiner 214 decides that the light resetting process does not need to be performed between image capturing cycles (step S25: NO), even though the decision made by the image capturing order determiner 210 represents capturing of a plurality of images, then the light resetting operation determiner 214 outputs the decision to the filter controller 216 and to the light source controller 218, while displaying the decision on the display control panel 56. The light resetting operation determiner 214 may also output a sound indicative of the decision from the speaker 58. Thereafter, control goes back to step S9 shown in FIG. 19, in which the radiographic image capturing system 10 performs a next radiographic image capturing process.

In step S25, the light resetting operation determiner 214 may determine whether or not the light resetting process needs to be performed between image capturing cycles in view of the temperature of the photodetector devices 94, in addition to the above image capturing method (an image capturing mode for capturing a plurality of still images or a moving image capturing mode).

For example, among pixel values of the electric signals read from the pixels 190 in a preceding image capturing cycle, the pixel values of electric signals read from the pixels 190, which are located within a region not irradiated with radiation 16, are assumed to be dark current dependent pixel values. Based on the pixel values of (dark current dependent) electric signals read from such pixels 190, the temperature detector 212 detects the temperature of the pixels 190, i.e., the photodiodes, and outputs the detected temperature to the light resetting operation determiner 214.

In step S25, the light resetting operation determiner 214 identifies the frame rate threshold value Fth corresponding to the temperature detected by the temperature detector 212 in FIG. 22, and compares the frame rate threshold value Fth with the frame rate of the image capturing method identified by the image capturing order determiner 210. If the frame rate of the identified image capturing method is higher than the frame rate threshold value Fth dependent on the detected temperature, then in step S25, the light resetting operation determiner 214 determines that the pixels 190 need to be reset (step S25: YES). If the frame rate of the identified image capturing method is lower than the frame rate threshold value Fth dependent on the detected temperature, then in step S25, the light resetting operation determiner 214 determines that the pixels 190 do not need to be reset (step S25: NO). If the temperature detected by the temperature detector 212 is lower than the threshold temperature Tc, and the frame rate threshold value Fth is at the initial value Fth0, then the light resetting operation determiner 214 does not determine whether the light resetting process needs to be performed in view of the temperature of the photodetector devices 94, but may determine whether the light resetting process needs to be performed simply by comparing the frame rate of the image capturing method with the frame rate threshold value Fth0.

In the radiographic image capturing processes [2] and [3], the subject 14 is imaged with radiation 16 according to an image capturing order, including at least one of an image capturing mode for capturing at least one still image, a low-rate moving image capturing mode, and a high-rate moving image capturing mode.

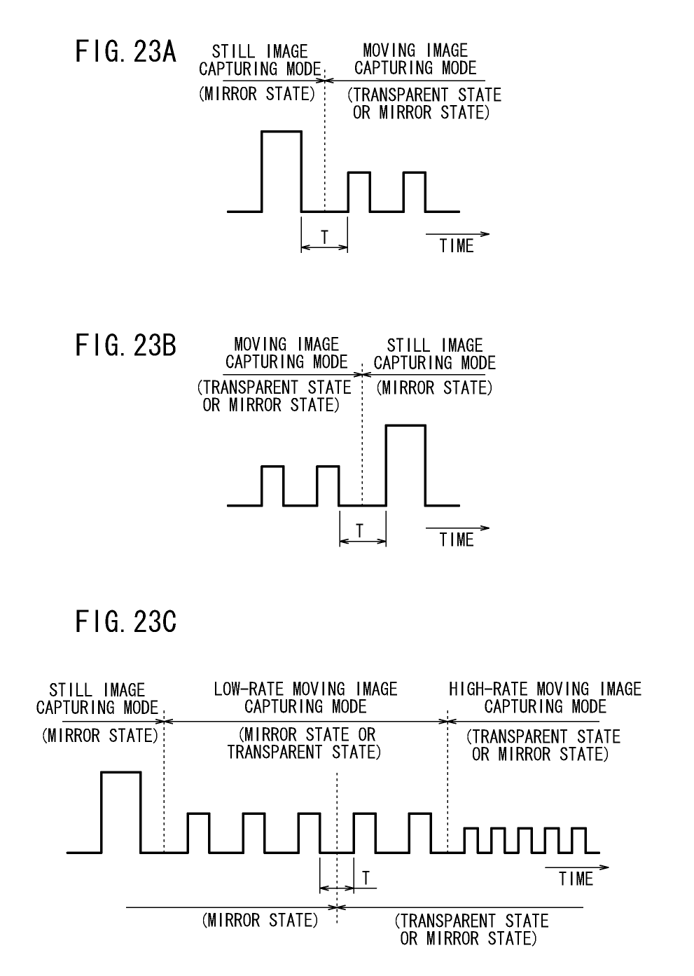

However, as shown in FIGS. 23A through 23C, for example, certain image capturing orders include two or more image capturing modes, not just one image capturing mode. For example, FIG. 23A shows an image capturing order in which a still image capturing mode switches to a moving image capturing mode. FIG. 23B shows an image capturing order in which a moving image capturing mode switches to a still image capturing mode. FIG. 23C shows an image capturing order in which a still image capturing mode switches to a low-rate moving image capturing mode and then to a high-rate moving image capturing mode.

According to an image capturing order including two or more image capturing modes, the light-regulating mirror film layer 122 switches between the mirror state and the transparent state at a timing (time period T) at which the image capturing modes are switched (see FIGS. 23A and 23B), or alternatively, switches between the mirror state and the transparent state in advance if the image capturing interval is relatively long (see FIG. 23C).

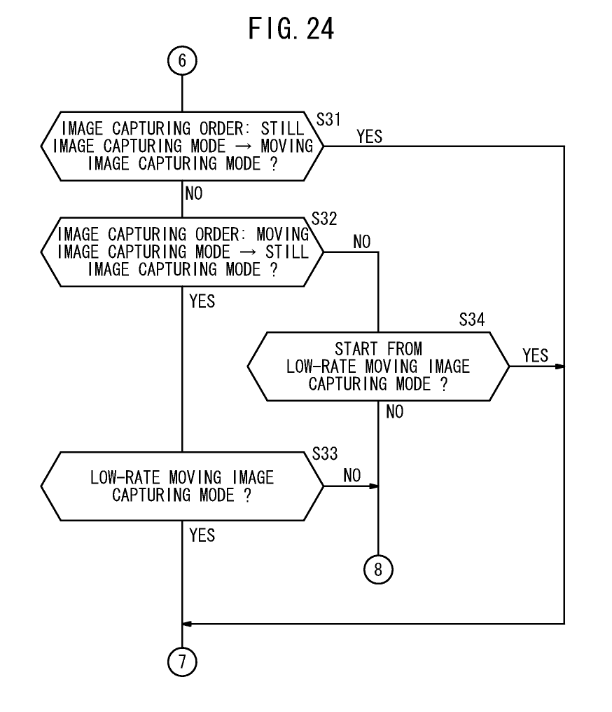

Radiographic image capturing processes [4] through [7] and light resetting processes for image capturing orders, which include two or more image capturing modes, will be described below with reference to FIGS. 24 through 28.

[4] A radiographic image capturing process according to an image capturing order including, in this order, a sequence of an image capturing mode for capturing at least one still image and a moving image capturing mode, with the switching filter 76 switching between the mirror state and the transparent state at a timing at which the still image capturing mode is switched to the moving image capturing mode will be described below (see FIG. 23A).

In the still image capturing mode, the light-regulating mirror film layer 122 (see FIGS. 6A through 8B, FIGS. 11 through 14B, and FIGS. 15B and 16) is in the mirror state. After a time period T, in which the still image capturing mode switches to the moving image capturing mode, the light-regulating mirror film layer 122 remains in the mirror state, or switches alternately between the mirror state and the transparent state, depending on the frame rate of the moving image capturing mode. The light-regulating mirror film layer 122 switches between the mirror state and the transparent state during the time period T. The moving image capturing mode in the radiographic image capturing process [4] refers to either a low-rate moving image capturing mode or a high-rate moving image capturing mode.

If the image capturing method included within the image capturing order represents, in this order, a sequence of a still image capturing mode and a moving image capturing mode (step S31: YES) (see FIG. 24), then after step S5 shown in FIG. 18, control proceeds to step S7 (see FIG. 18) in which the light-regulating mirror film layer 122 is set to the mirror state, and the still image capturing mode is carried out.

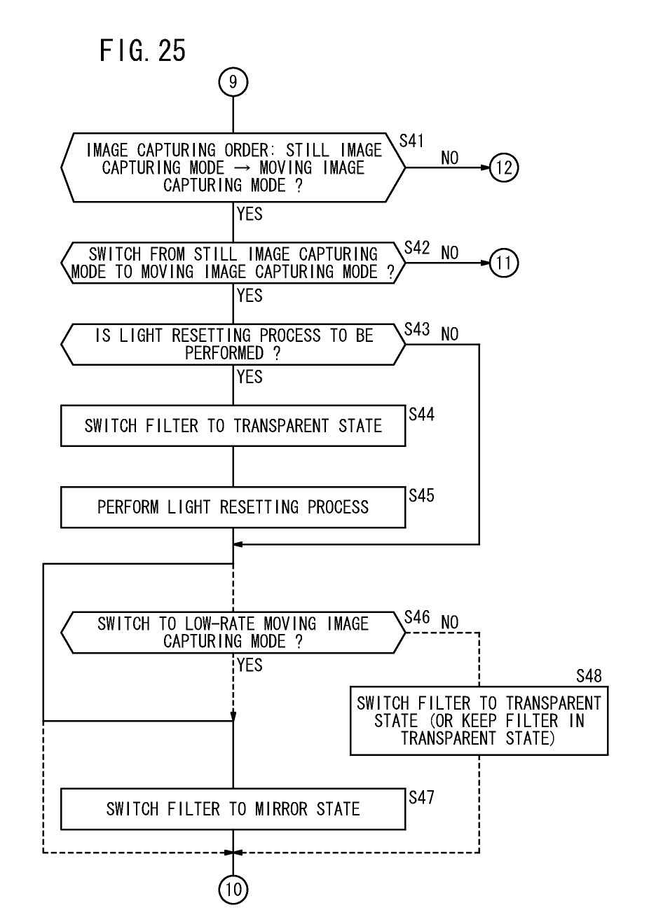

In step S13, after it has been decided that capturing of all radiographic images is not yet completed (step S13: NO) (see FIG. 19), if the decision sent from the image capturing order determiner 210 (see FIG. 17) indicates a sequence of a still image capturing mode and a moving image capturing mode in this order (step S41: YES) (see FIG. 25), then in step S42, the light resetting operation determiner 214 determines whether or not the present time represents a timing at which the still image capturing mode is switched to the moving image capturing mode.

If the light resetting operation determiner 214 decides that the present time does not represent a timing at which the still image capturing mode is switched to the moving image capturing mode, i.e., that the next mode also is a still image capturing mode (step S42: NO), then the light resetting operation determiner 214 displays the decision on the display control panel 56. The doctor confirms the decision displayed on the display control panel 56, and control goes back to step S8 in FIG. 19, in order to perform a next still image capturing mode again.

If the light resetting operation determiner 214 decides that the present time is a timing during the time period T, at which the still image capturing mode is switched to the moving image capturing mode (step S42: YES), then in step S43, the light resetting operation determiner 214 determines whether or not the light resetting process should be performed.

If the preceding image capturing mode is a still image capturing mode with a relatively high radiation dose, whereas the next image capturing mode is a moving image capturing mode with a relatively low radiation dose, then the light resetting operation determiner 214 determines that the light resetting process needs to be performed (step S43: YES). The light resetting operation determiner 214 outputs the decision indicating that the light resetting process needs to be performed to the filter controller 216 and to the light source controller 218, and displays the decision on the display control panel 56. The light resetting operation determiner 214 may also output a sound indicative of the decision from the speaker 58.

In step S44, the filter controller 216 applies a voltage to the switching filter 76 (see FIG. 3A, FIG. 4A, FIGS. 6A through 8B, FIGS. 11 through 14B, and FIGS. 15B and 16) to switch the light-regulating mirror film layer 122 from the mirror state to the transparent state. The light source controller 218 energizes the resetting light source 78 to start emitting resetting light 132. In step S45, the resetting light 132 passes through the light-regulating mirror film layer 122 to the photodetector substrate 72, thereby starting a light resetting process for resetting the photodetector devices 94, i.e., the pixels 190. Thereafter, the light source controller 218 de-energizes the resetting light source 78 to stop emitting resetting light 132, thereby finishing the light resetting process. In step S47, the filter controller 216 applies a voltage, which is opposite in polarity to the voltage applied in step S44, to the switching filter 76 to switch the light-regulating mirror film layer 122 from the transparent state to the mirror state. After step S47, control proceeds to step S9 in FIG. 19, in which a moving image capturing mode, i.e., a low-rate moving image capturing mode or a high-rate moving image capturing mode, starts to be performed.

In step S43, if the time period T shown in FIG. 23A is relatively long and the temperature of the photodiodes does not rise significantly, or if noise due to dark current is not serious even though the light resetting process is not performed, or if the preceding image capturing mode was a still image capturing mode with a relatively low radiation dose, then in step S43, the light resetting operation determiner 214 determines that the light resetting process does not need to be performed (step S43: NO). The light resetting operation determiner 214 outputs the decision to the filter controller 216 and to the light source controller 218, while displaying the decision on the display control panel 56. In this case, since the light-regulating mirror film layer 122 is kept in the mirror state, step S47 is skipped, as indicated by the broken lines in FIG. 25, and thereafter, control proceeds to step S9 in FIG. 19, during which a moving image capturing mode, i.e., a low-rate moving image capturing mode or a high-rate moving image capturing mode, starts to be performed.

In the radiographic image capturing process [4], as with the radiographic image capturing processes [2] and [3], with electronic cassettes 20A, 20B of an ISS type, the light-regulating mirror film layer 122 needs to remain in the mirror state while images are being captured. Therefore, the light-regulating mirror film layer 122 is returned to the mirror state immediately after resetting of the photodetector devices 94 is finished in steps S45 and S47. With electronic cassettes 20C, 20D of a PSS type, however, it is possible to perform the sequence of selecting the mirror state or the transparent state in steps S46 through S48 depending on the magnitude of the frame rate, as will be described later.

[5] The radiographic image capturing process according to an image capturing order includes, in this order, a sequence of a moving image capturing mode and an image capturing mode for capturing at least one still image, with the switching filter 76 switching between the mirror state and the transparent state at a timing at which the moving image capturing mode is switched to the still image capturing mode (see FIG. 23B).

In the moving image capturing mode, the light-regulating mirror film layer 122 (see FIGS. 6A through 8B, FIGS. 11 through 14B, and FIGS. 15B and 16) is in the mirror state. Alternatively, after a time period T during which the mirror state switches to the transparent state and the moving image capturing mode switches to the still image capturing mode in one frame, the light-regulating mirror film layer 122 remains in the mirror state in the still image capturing mode. The light-regulating mirror film layer 122 switches between the mirror state and the transparent state during the time period T. The moving image capturing mode in the radiographic image capturing process [5] may also refer to either a low-rate moving image capturing mode or a high-rate moving image capturing mode.

After step S5 in FIG. 18, if the image capturing method included within the image capturing order represents, in this order, a sequence of a moving image capturing mode and a still image capturing mode in step S31 (step S31: NO) and in step S32 (step S32: YES) (see FIG. 24), and also if the moving image capturing mode is a low-rate moving image capturing mode (step S33: YES), then in step S7 and subsequent steps, the low-rate moving image capturing mode is carried out with the light-regulating mirror film layer 122 being in the mirror state.

If the moving image capturing mode is a high-rate moving image capturing mode (step S33: NO), then control proceeds to steps S21 through S24 in FIG. 20. Step S8 and subsequent steps in FIG. 19 are carried out after the photodetector devices 94 have been reset prior to capturing of moving images.

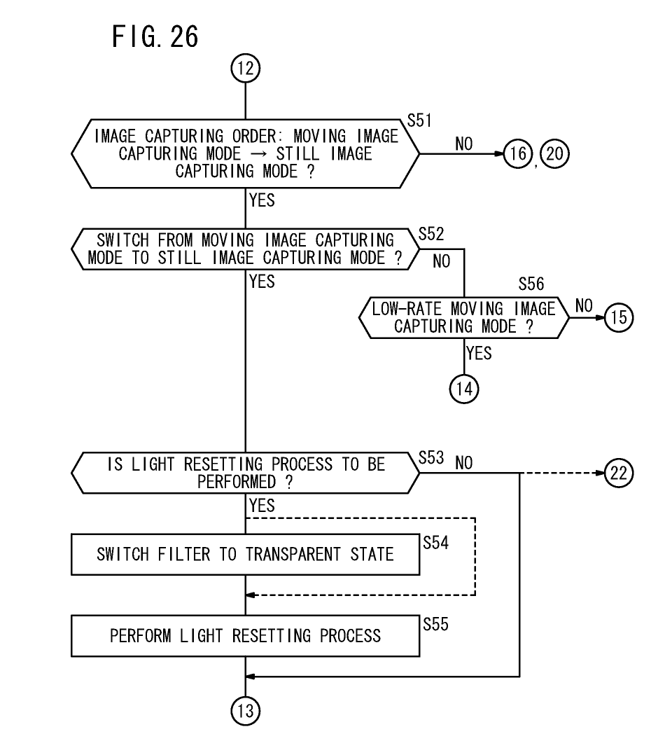

Then, in step S13, after it has been decided that capturing of all radiographic images is not yet completed (step S13: NO) (see FIG. 19), since the decision sent from the image capturing order determiner 210 indicates, in this order, a sequence of a moving image capturing mode and a still image capturing mode in step S41 (step S41: NO) (see FIG. 25) and step S51 (step S51: YES) (see FIG. 26), in step S52, the light resetting operation determiner 214 determines whether or not the present time represents a timing to switch from the moving image capturing mode to the still image capturing mode.

If the light resetting operation determiner 214 determines that the present time represents a timing to switch from the moving image capturing mode to the still image capturing mode, i.e., that the next mode is a still image capturing mode during the time period T (step S52: YES), then in step S53, the light resetting operation determiner 214 determines whether or not the light resetting process is to be performed.

If a radiographic image with only slight noise is to be acquired in a still image capturing mode, or if the frame rate of a moving image capturing mode is higher than the frame rate threshold value Fth (see FIG. 22) depending on the temperature of the photodiodes, then in step S53, the light resetting operation determiner 214 determines that the light resetting process needs to be performed (step S53: YES). The light resetting operation determiner 214 outputs the decision indicating that the light resetting process is to be performed to the filter controller 216 and to the light source controller 218, while also displaying the decision on the display control panel 56. The light resetting operation determiner 214 may also output a sound indicative of the decision from the speaker 58.

In step S54, the filter controller 216 applies a voltage to the switching filter 76 to switch the light-regulating mirror film layer 122 from the mirror state to the transparent state. The light source controller 218 energizes the resetting light source 78 to start emitting resetting light 132. In step S55, resetting light 132 passes through the light-regulating mirror film layer 122 to the photodetector substrate 72, thereby starting a light resetting process for resetting the photodetector devices 94, i.e., the pixels 190. Thereafter, control proceeds to step S7 in FIG. 18, to switch the light-regulating mirror film layer 122 to the mirror state. Then, step S8 and subsequent steps in FIG. 19 are carried out, to thereby perform the still image capturing mode.

In step S52, if the light resetting operation determiner 214 determines that the present time is not a timing at which the moving image capturing mode should switch to the still image capturing mode, i.e., that the next mode is also a moving image capturing mode (step S52: NO), then in step S56, the light resetting operation determiner 214 determines whether or not the next moving image capturing mode is a low-rate moving image capturing mode.

If the next moving image capturing mode is a low-rate moving image capturing mode (step S56: YES), then step S9 in FIG. 19 is performed. If the next moving image capturing mode is a high-rate moving image capturing mode (step S56: NO), then step S25 in FIG. 21 is performed.

If the time period T is long, and it is expected that high-quality radiographic images with only slight noise therein can be acquired in the still image capturing mode even if the light resetting process is not performed, or if the frame rate of the moving image capturing mode is lower than the frame rate threshold value Fth depending on the temperature of the photodiodes, then in step S53, the light resetting operation determiner 214 determines that the light resetting process does not need to be performed (step S53: NO). The light resetting operation determiner 214 displays the decision on the display control panel 56. Thereafter, in step S8 and subsequent steps in FIG. 19, the still image capturing mode is carried out.

In step S53, if the light resetting operation determiner 214 determines whether or not the light resetting process should be performed based on the temperature of the photodiodes, then, as described above with respect to the radiographic image capturing process [3], the light resetting operation determiner 214 may detect the temperature of the photodiodes from pixel values read from pixels 190 that are not irradiated with radiation 16, so as to determine whether or not the light resetting process should be performed or not based on the frame rate threshold value Fth (or Fth0) depending on the detected temperature and the frame rate of the moving image capturing mode.

[6] The radiographic image capturing process according to an image capturing order including two moving image capturing modes having different frame rates (see part of FIG. 23C) shall be described below.

The radiographic image capturing process is performed in a sequence of a low-rate moving image capturing mode and a high-rate moving image capturing mode in this order, or a in sequence of a high-rate moving image capturing mode and a low-rate moving image capturing mode in this order.

According to the radiographic image capturing process [6], unlike the radiographic image capturing processes [4] and [5], even if the frame rate is changed during the radiographic image capturing process (due to switching from a low-rate moving image capturing mode to a high-rate moving image capturing mode, or due to switching from a high-rate moving image capturing mode to a low-rate moving image capturing mode) depending on the temperature of the photodiodes or the image capturing interval, the light-regulating mirror film layer 122 (see FIGS. 6A through 8B, FIGS. 11 through 14B, and FIGS. 15B and 16) may continue to switch alternately between the mirror state and the transparent state in one frame.

After step S5 in FIG. 18, the two moving image capturing modes included in the image capturing order are successively carried out in step S31 (step S31: NO) (see FIG. 24) and step S32 (step S32: NO), and also if the image capturing order indicates that the low-rate moving image capturing mode is initially carried out (step S34: YES), then in step S7 and subsequent steps in FIG. 18, the low-rate moving image capturing mode is carried out with the light-regulating mirror film layer 122 being set to the mirror state.

If the image capturing order indicates that the high-rate moving image capturing mode is initially carried out (step S34: NO), then prior to capturing of images, the sequence of steps S21 through S24 in FIG. 20 is carried out, and the sequence of step S8 and subsequent steps in FIG. 19 is carried out after the light resetting process.

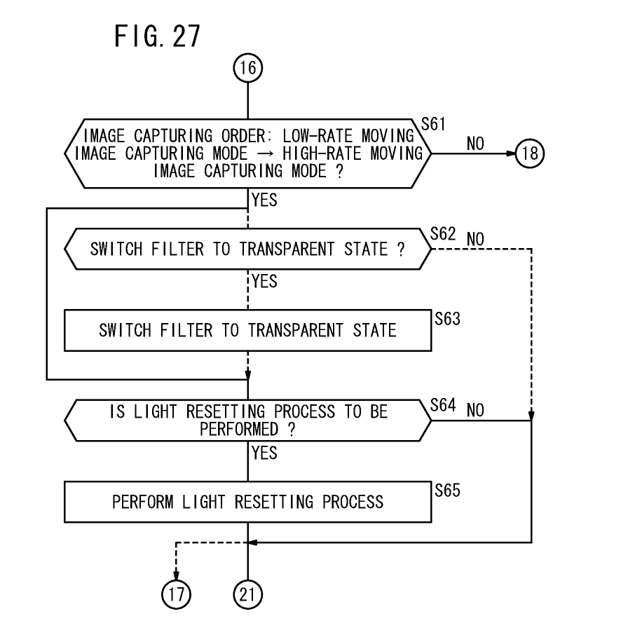

After it has been decided that capturing of all moving images is not yet completed (step S13: NO), if the decision from the image capturing order determiner 210 indicates that two image capturing modes are successively carried out in step S41 (step S41: NO) in FIG. 25 and in step S51 (step S51: NO) in FIG. 26, and also, in step S61, if the decision indicates that a low-rate moving image capturing mode and a high-rate moving image capturing mode are successively carried out in this order (step S61: YES) in FIG. 27, then in step S64, the light resetting operation determiner 214 (see FIG. 17) determines whether or not the light resetting process needs to be performed.

If the frame rate of the low-rate moving image capturing mode is higher than the frame rate threshold value Fth (see FIG. 22) depending on the temperature of the photodiodes, or if the next image capturing mode is a high-rate moving image capturing mode, then in step S64, the light resetting operation determiner 214 determines that the light resetting process is required (step S64: YES), and outputs the decision that the light resetting process needs to be performed to the filter controller 216 and to the light source controller 218, while displaying the decision on the display control panel 56. The speaker 58 may also output a sound representative of the decision.

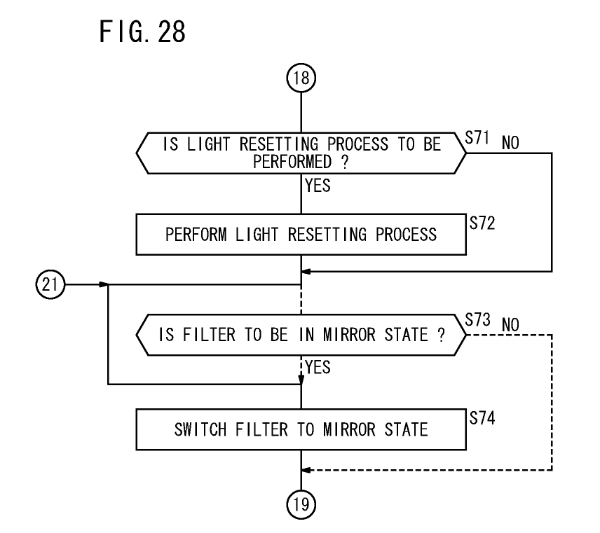

The filter controller 216 switches the light-regulating mirror film layer 122 from the mirror state to the transparent state. The light source controller 218 energizes the resetting light source 78 to start emitting resetting light 132. In step S65, resetting light 132 passes through the light-regulating mirror film layer 122 and is applied to the photodetector substrate 72, thereby starting the light resetting process for resetting the photodetector devices 94, i.e., the pixels 190, with resetting light 132. Thereafter, in step S74 in FIG. 28, the filter controller 216 switches the light-regulating mirror film layer 122 from the transparent state back to the mirror state. Thereafter, step S9 and subsequent steps in FIG. 19 are carried out, i.e., the moving image capturing modes (a low-rate moving image capturing mode or a high-rate moving image capturing mode) are performed.

If the light resetting operation determiner 214 determines that the light resetting process is not required (step S64: NO), i.e., if the frame rate of the low-rate moving image capturing mode is lower than the frame rate threshold value Fth dependent on the temperature of the photodiodes, then step S9 and subsequent steps are carried out while the light-regulating mirror film layer 122 is kept in the mirror state.

If it is decided that a high-rate moving image capturing mode and a low-rate moving image capturing mode are to be carried out in this order (step S61: NO), then in step S71 in FIG. 28, the light resetting operation determiner 214 determines whether or not the light resetting process is required.

If the frame rate of the moving image capturing mode is higher than the frame rate threshold value Fth dependent on the temperature of the photodiodes, then the light resetting operation determiner 214 determines that the light resetting process is required (step S71: YES). The light resetting operation determiner 214 outputs the decision to the filter controller 216 and the light source controller 218, while displaying the decision on the display control panel 56. The light resetting operation determiner 214 may also output a sound indicative of the decision from the speaker 58.

In step S54, the filter controller 216 applies a voltage to the switching filter 76 to switch the light-regulating mirror film layer 122 from the mirror state to the transparent state. The light source controller 218 energizes the resetting light source 78 to start emitting resetting light 132. In step S72, the resetting light 132 passes through the light-regulating mirror film layer 122 to the photodetector substrate 72, thereby starting a light resetting process for resetting the photodetector devices 94, i.e., the pixels 190. Thereafter, the light source controller 218 de-energizes the resetting light source 78 to stop emitting resetting light 132, thereby finishing the light resetting process. In step S74, the filter controller 216 switches the light-regulating mirror film layer 122 from the transparent state to the mirror state. Thereafter, step S9 and subsequent steps in FIG. 19 are carried out.

If the frame rate of the moving image capturing mode is lower than the frame rate threshold value Fth dependent on the temperature of the photodiodes, then in step S71, the light resetting operation determiner 214 determines that the light resetting process is not required (step S71: NO). The light resetting operation determiner 214 outputs the decision to the filter controller 216 and to the light source controller 218, while displaying the decision on the display control panel 56.

[7] The radiographic image capturing process according to an image capturing order including two moving image capturing modes having different frame rates, and an image capturing mode for capturing at least one still image (see FIG. 23C) shall be described below.

The radiographic image capturing process is performed, in this order, in a sequence of a still image capturing mode, a low-rate moving image capturing mode, and a high-rate moving image capturing mode.

The radiographic image capturing process [4] is applicable to switching from a still image capturing mode to a low-rate moving image capturing mode.

The radiographic image capturing process [6] is applicable to switching from a low-rate moving image capturing mode to a high-rate moving image capturing mode.

The radiographic image capturing process [7] may also be performed in a sequence of a high-rate moving image capturing mode, a low-rate moving image capturing mode, and a still image capturing mode in this order, or in a sequence of a low-rate moving image capturing mode, a still image capturing mode, and a high-rate moving image capturing mode in this order. The radiographic image capturing processes [4] through [6] also are applicable to such modifications.

According to the present embodiment, it is determined whether or not the light resetting process is required based on the frame rate and the temperature of the photodiodes. If the light resetting process is carried out on the photodetector devices 94, the photodetector devices 94 are reset, so as to sufficiently embed the impurity level of the photodiodes with electric charges, to thereby eliminate variations in the amount of electric charges discharged from the impurity level between frames due to a rise in temperature of the photodiodes. If a plurality of images are captured in a moving image capturing mode, etc., the amount of electric charges discharged from the impurity level are made constant between frames. In the radiographic image capturing processes [2] through [7] in which the light resetting process is carried out, in step S12, the cassette controller 182 or the console 22 may perform an image processing sequence for removing noise caused by a certain amount of discharged electric charges from the radiographic images, i.e., for correcting the radiographic images. Thus, high-quality radiographic images, which are free of noise, can be displayed on the display control panel 56 and the display device 24.

The radiographic image capturing system 10 incorporating therein the electronic cassette 20 according to the present embodiment operates as described above.

### Modifications to the Present Embodiment

Modifications to the electronic cassette 20 (electronic cassettes 20A through 20D) and the electronic cassettes 20B through 20D according to second through fourth examples will be described in detail below. The electronic cassettes 20B through 20D according to the second through fourth examples will be described, with respect to their structural and operational details, with reference to FIGS. 18 through 28.

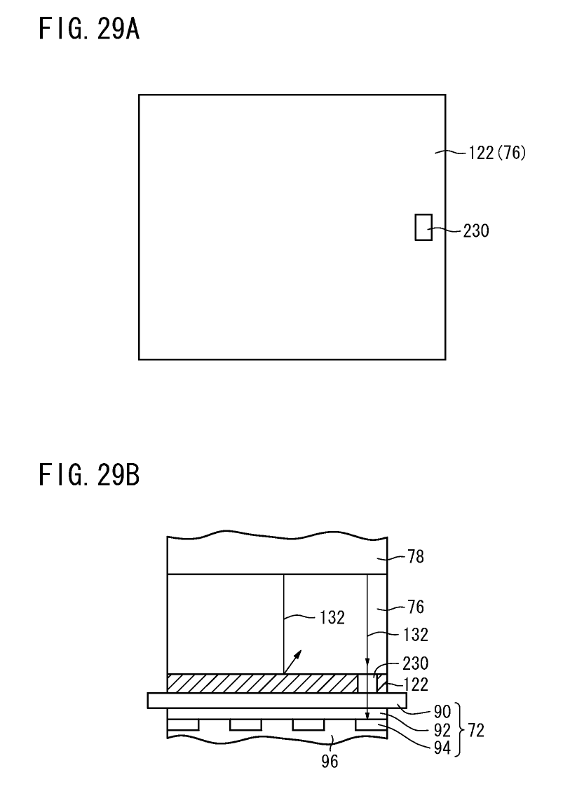

FIGS. 29A and 29B show a switching filter 76 for detecting temperature of photodiodes more accurately and more efficiently.

As shown in FIGS. 29A and 29B, the light-regulating mirror film layer 122 has a window 230 defined therein for allowing resetting light 132 to pass therethrough at all times. The window 230 should preferably be disposed in a position facing toward a photodetector device 94, which is located in an area the temperature of which is expected to rise. More preferably, the window 230 should be disposed in a position facing toward the photodetector device 94, which is located in an area that is not irradiated with radiation 16.

If the light-regulating mirror film layer 122 is in a mirror state, then in a case where the resetting light source 78 emits resetting light 132, most of the resetting light 132 is reflected toward the resetting light source 78 by the light-regulating mirror film layer 122 in the mirror state. However, a portion of such resetting light 132, which travels toward the window 230, passes through the window 230 and is applied to the photodetector device 94 (i.e., the photodiode that is not irradiated with radiation 16) that faces toward the window 230.

If the photodetector device 94, which faces toward the window 230, is irradiated with resetting light 132, the photodetector device 94 detects and stores the resetting light 132 as electric charges. Since the photodetector device 94 is in the form of the photodiode that is not irradiated with radiation 16, if the stored electric charges are read as electric signals, the electric signals represent a pixel value depending on a dark current signal. The temperature detector 212 (see FIG. 7) detects the temperature of the photodiode based on the pixel value depending on the dark current signal. The light resetting operation determiner 214 then identifies a frame rate threshold value Fth (see FIG. 22) depending on the detected temperature, and determines whether or not the light resetting process should be carried out based on a comparison between the identified frame rate threshold value Fth and the frame rate of the moving image capturing mode. If the light resetting operation determiner 214 determines that the light resetting process should be carried out, then the filter controller 216 switches the light-regulating mirror film layer 122 from the mirror state to the transparent state.

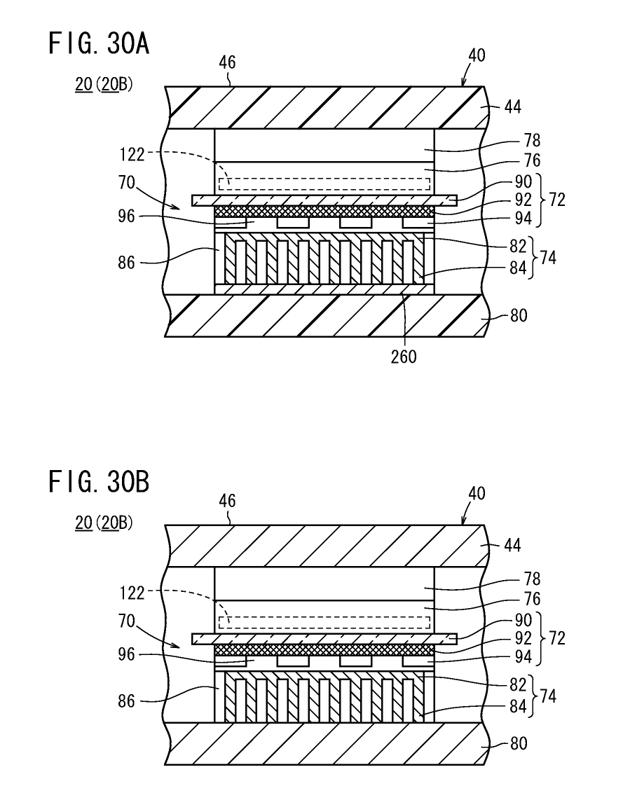

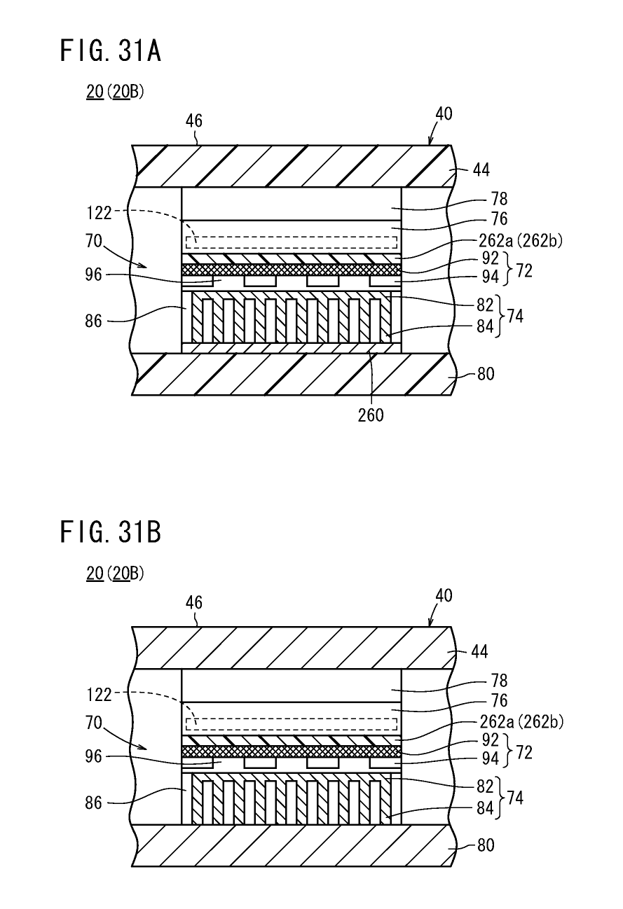

FIGS. 30A through 31B show specific structural details of electronic cassettes 20B according to the second example shown in FIG. 4B.

In the electronic cassette 20B shown in FIG. 30A, the photodetector substrate 72 is of the same structure as that shown in FIG. 6A. The scintillator 74 is disposed on the base 90 with the TFTs 92, the photodetector devices 94, and the planarization film 96 interposed therebetween. As described above with reference to FIG. 6A, the base 90 is normally a glass substrate, but may be made of various other materials.

More specifically, if the photodetector devices 94 are made of an organic photoconductor or an amorphous oxide semiconductor, and the TFTs 92 are made of an organic semiconductor, an amorphous oxide semiconductor, or carbon nanotubes, then since the TFTs 92 and the photodetector devices 94 can be deposited as films at low temperatures, a plastic film, which is permeable at least to the resetting light 132 and which is flexible, such as a polyimide film, a polyarylate film, a biaxially elongated polystyrene film, an aramid film, or a film of bionanofibers, may be used as the base 90.

In FIG. 30A, a reflecting layer 260 made of aluminum or the like for reflecting visible light 130 is interposed between the bottom plate 80 of the casing 44 and the distal end of the columnar crystalline structure 84.

Inasmuch as the electronic cassette 20B shown in FIG. 30A incorporates therein the photodetector substrate 72 having the structure shown in FIG. 6A, the electronic cassette 20B shown in FIG. 30A offers the same advantages as those of the electronic cassette 20A shown in FIG. 6A. When radiation 16 is applied to the electronic cassette 20B shown in FIG. 30A, if a portion of the visible light 130, which is converted from radiation 16 by the columnar crystalline structure 84, travels toward the bottom plate 80, then the reflecting layer 260 reflects that portion of the visible light 130 toward the photodetector substrate 72. The reflected portion of the visible light 130 passes through the scintillator 74 to the photodetector substrate 72. Therefore, the sensitivity of the photodetector devices 94 of the electronic cassette 20B shown in FIG. 30A with respect to visible light 130 also is increased.

The electronic cassette 20B shown in FIG. 30B differs from the electronic cassette 20B shown in FIG. 30A, in that the casing 44 is made of a metal such as aluminum or the like, which is permeable to radiation 16 and which reflects visible light 130. When radiation 16 is applied to the electronic cassette 20B shown in FIG. 30B, if a portion of the visible light 130, which is converted from the radiation 16 by the columnar crystalline structure 84, travels toward the bottom plate 80, then the bottom plate 80 reflects that portion of the visible light 130 toward the photodetector substrate 72. The reflected portion of the visible light 130 passes through the scintillator 74 and is applied to the photodetector substrate 72. Therefore, the sensitivity of the photodetector devices 94 of the electronic cassette 20B shown in FIG. 30B with respect to visible light 130 also is increased.

The electronic cassette 20B shown in FIG. 31A differs from the electronic cassette 20B shown in FIG. 30A, in that the base 90 is dispensed with, and the photodetector substrate 72 and the switching filter 76 are held in close contact with each other with a bonding layer 262a or an adhesive layer 262b being interposed therebetween, which is permeable at least to the resetting light 132.

The bonding layer 262a may be of the same material as the bonding layer 80a, and the adhesive layer 262b may be of the same material as the adhesive layer 80b. Since the base 90 is dispensed with, radiation 16 that would otherwise be absorbed by the base 90 reaches the scintillator 74, resulting in an increase in sensitivity of the photodetector devices 94 with respect to visible light 130. Further, since the base 90 is dispensed with, the radiographic image is effectively prevented from becoming blurred while allowing visible light 130 generated by the scintillator 74 to be focused onto the photodetector devices 94, and the radiation detector 70 is made low in profile.

As with the electronic cassette 20B shown in FIG. 31A, the electronic cassette 20B shown in FIG. 31B differs from the electronic cassette 20B shown in FIG. 30B, in that the base 90 is dispensed with, and the photodetector substrate 72 and the switching filter 76 are held in close contact with each other with a bonding layer 262a or an adhesive layer 262b being interposed therebetween. The electronic cassette 20B shown in FIG. 31B offers the same advantages as those of the electronic cassette 20B shown in FIG. 31A, in addition to the advantages of the electronic cassette 20B shown in FIG. 30B.

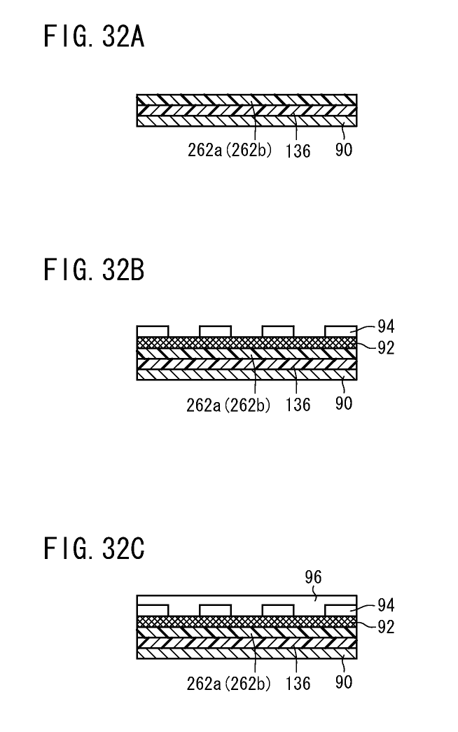

FIGS. 32A through 34B show a process of manufacturing the electronic cassette 20B. Fabrication of the electronic cassette 20B shown in FIG. 31B will be described below by way of example.

First, as shown in FIG. 32A, a peel-off layer 136 is formed on the surface of a base 90. Thereafter, a bonding layer 262a or an adhesive layer 262b is formed on the surface of the peel-off layer 136. Then, as shown in FIG. 32B, an array of TFTs 92 is formed on the surface of the bonding layer 262a or the adhesive layer 262b, and thereafter, photodetector devices 94 are formed on the array of TFTs 92. Then, as shown in FIG. 32C, a planarization process is performed on the TFTs 92 and the photodetector devices 94 to form a planarization film 96.

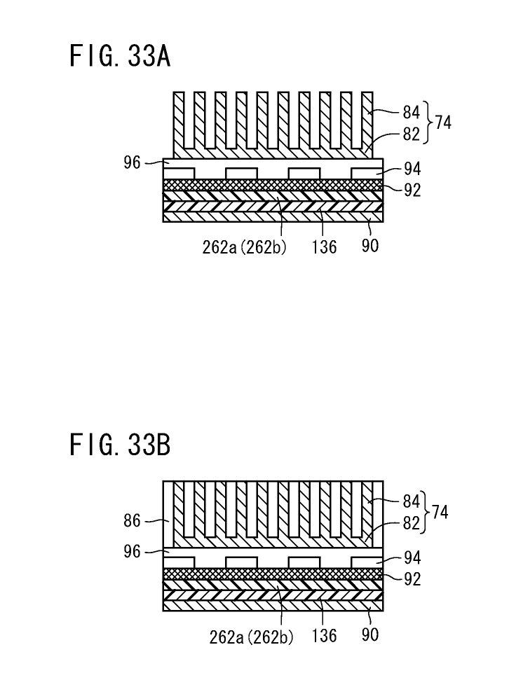

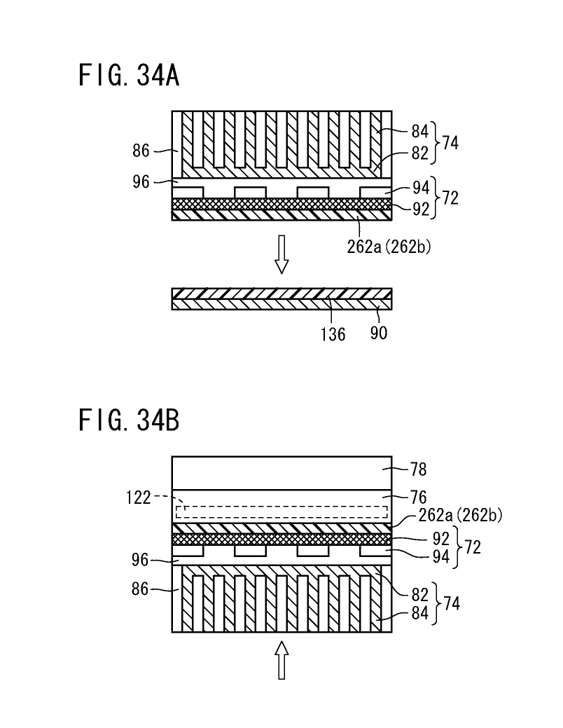

Then, as shown in FIG. 33A, a scintillator 74 is deposited on the planarization film 96. Then, as shown in FIG. 33B, the scintillator 74 is sealed by a moisture-resistant protective layer 86 so as to cover the columns of the columnar crystalline structure 84 with polyparaxylylene. Then, as shown in FIG. 34A, a laser beam, not shown, is applied to the peel-off layer 136, so as to peel the base 90 and the peel-off layer 136 from the bonding layer 262a or the adhesive layer 262b.

Thereafter, as shown in FIG. 34B, using the stack made up of the switching filter 76 and the resetting light source 78 as a transfer target, the scintillator 74 and the photodetector substrate 72 are bonded to the light-regulating mirror film layer 122 of the switching filter 76 by the bonding layer 262a, or are adhered to the light-regulating mirror film layer 122 of the switching filter 76 by the adhesive layer 262b, whereupon the radiation detector 70 is completed. The scintillator 74 and the photodetector substrate 72 may be bonded or adhered (transferred) to the stack made up of the switching filter 76 and the resetting light source 78, which serves as a transfer target, according to known transfer techniques.

Finally, the completed radiation detector 70 is placed in the casing 44 so that the radiation detector 70 is arranged as shown in FIG. 31B, whereupon an electronic cassette 20B of an ISS type is fabricated.

With the electronic cassette 20B shown in FIG. 31B constructed in the foregoing manner, since the base 90 is not interposed therein, the radiographic image is effectively prevented from becoming blurred, and the sensitivity of the photodetector devices 94 is increased. If the base 90 is made of a material permeable to at least resetting light 132, the peel-off layer 136 may be dispensed with, and the TFTs 92 and the photodetector devices 94 may be formed directly on the base 90. In this case, a radiation detector 70, which incorporates the structure shown in FIG. 30A or 30B, is fabricated.

Since the electronic cassette 20B according to the second example is substantially the same as the electronic cassette 20B according to the first example (see FIGS. 4A and 6A), except that the scintillator 74 is deposited directly on the photodetector substrate 72 as shown in FIGS. 4B and 30A through 31B, the radiographic image capturing processes [1] through [7] also may be applied to the electronic cassette 20B according to the second example.

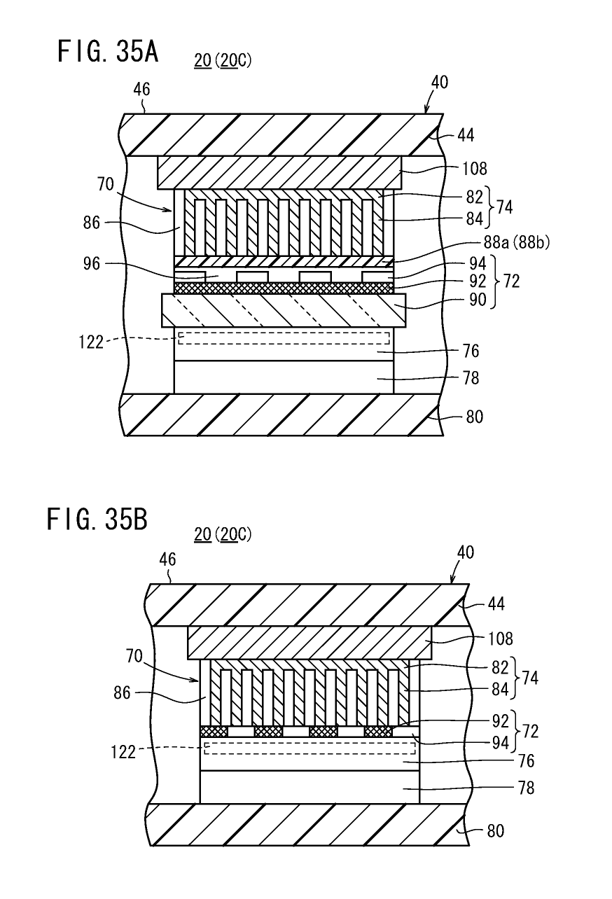

FIGS. 35A and 35B are fragmentary cross-sectional views showing an electronic cassette 20C according to a third example in the vicinity of the radiation detector 70. The electronic cassette 20C according to the third example differs from the electronic cassette 20A according to the first example (see FIGS. 6A and 8B), in that the radiation detector 70 is vertically reversed or turned upside down. By way of example, the radiation detector 70 shown in FIGS. 6A and 8B is vertically reversed, or turned upside down, and then placed in the casing 44 of the electronic cassette 20C.

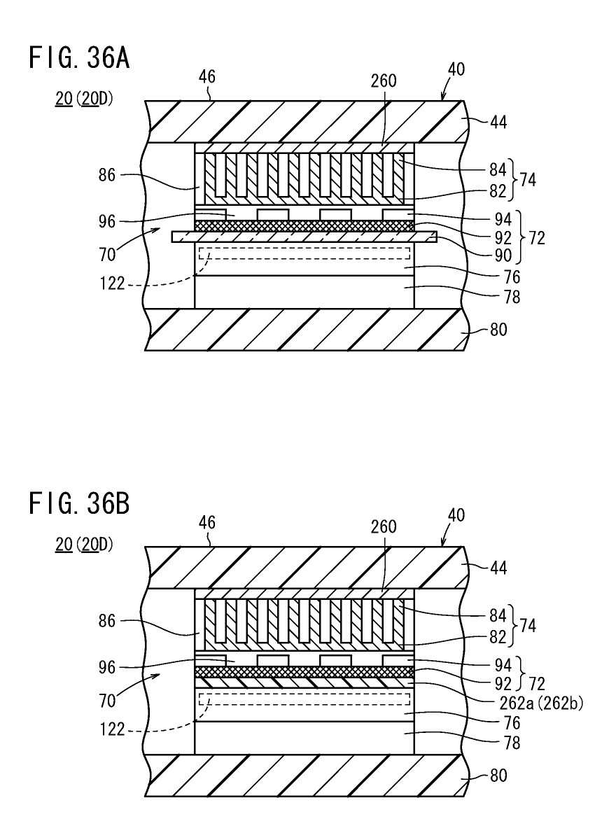

FIGS. 36A and 36B are fragmentary cross-sectional views showing the electronic cassette 20D according to a fourth example in the vicinity of the radiation detector 70. The electronic cassette 20D according to the fourth example differs from the electronic cassette 20B according to the second example (see FIGS. 30A and 31A), in that the radiation detector 70 is vertically reversed or turned upside down. By way of example, the radiation detector 70 shown in FIGS. 30A and 31A is vertically reversed, or turned upside down, and then placed inside the casing 44 of the electronic cassette 20D.

With the electronic cassettes 20C and 20D according to the third and fourth examples, radiation 16 that has passed through the subject 14 is converted by the scintillator 74 into visible light 130, which is applied to the photodetector substrate 72. The photodetector devices 94 of the photodetector substrate 72 convert visible light 130 into electric signals. In an image capturing process, since most of the radiation 16 is converted into visible light 130 by the scintillator 74, only a minimum amount of radiation 16 passes through the scintillator 74 and reaches the switching filter 76. If the light-regulating mirror film layer 122 is in a mirror state (metal state) during the image capturing process, then radiation 16 that reaches the switching filter 76 is absorbed by the light-regulating mirror film layer 122, which is in the metal state, and hence such radiation is prevented from reaching the resetting light source 78. Even if radiation 16 reaches the resetting light source 78, thereby causing the resetting light source 78 to emit resetting light 132, the resetting light 132 is reflected toward the resetting light source 78 by the light-regulating mirror film layer 122, which is in a mirror state. Therefore, resetting light 132 is prevented from traveling toward the photodetector substrate 72.

With electronic cassettes 20C and 20D of a PSS type, since the scintillator 74, the photodetector substrate 72, the switching filter 76, and the resetting light source 78 are successively arranged in this order in the casing 44 along the direction in which radiation 16 is applied, the above operations and advantages are achieved without reducing the dose of radiation 16 that reaches the scintillator 74.

As described above, with PSS type electronic cassettes 20C and 20D, since most of the radiation 16 is converted into visible light 130 by the scintillator 74, only minimal radiation 16 passes through the scintillator 74 and reaches the switching filter 76. Accordingly, it is possible to keep the light-regulating mirror film layer 122 in a transparent state while radiation 16 is applied.

More specifically, if the radiographic image capturing processes [1] through [7] are applied to PSS type electronic cassettes 20C and 20D, then the electronic cassettes 20C, 20D are considered to operate in a mode (1) in which the electronic cassettes 20C, 20D are irradiated with radiation 16 with the light-regulating mirror film layer 122 being in a mirror state, and a mode (2) in which the electronic cassettes 20C, 20D are irradiated with radiation 16 with the light-regulating mirror film layer 122 being in a transparent state.

Operations of the radiographic image capturing system 10 with the electronic cassettes 20C and 20D in mode (2) will be described below with respect to the radiographic image capturing processes [1] through [7]. Those features of mode (2), which differ from mode (1), will be described below, while other common features thereof will not be described.

[1] The radiographic image capturing process according to an image capturing order including an image capturing mode for capturing at least one radiographic image of the subject 14 or a low-rate moving image capturing mode (see FIGS. 18 and 19) will be described below.

The radiographic image capturing process [1] is directly applicable without modifications.

[2] The radiographic image capturing process according to an image capturing order including a still image capturing mode or a low-rate moving image capturing mode with the light resetting process being carried out at least once prior to the image capturing mode (see FIG. 20) will be described below.

Steps S23 and S24 may be carried out with respect to the electronic cassettes 20C and 20D in the following manner.

If the filter controller 216 (see FIG. 17) determines that it is necessary to return the light-regulating mirror film layer 122 (see FIGS. 6A through 8B, FIGS. 11 through 14B, and FIGS. 15B and 16) to the mirror state based on the decision from the light resetting operation determiner 214 (step S23: NO), then in step S24, the filter controller 216 applies a voltage to the switching filter 76, which is opposite in polarity to the voltage applied in step S21, so as to switch the light-regulating mirror film layer 122 from the transparent state to the mirror state. If the filter controller 216 decides that the light-regulating mirror film layer 122 needs to remain in the transparent state based on the above decision (step S23: YES), then the filter controller 216 does not apply any voltage to the switching filter 76, thereby keeping the light-regulating mirror film layer 122 in a transparent state.

In step S23, the filter controller 216 determines whether or not the light-regulating mirror film layer 122 should remain in the transparent state according to the following criteria.

In a radiographic image capturing mode for capturing a plurality of still images, or a low-rate moving image capturing mode, if images are captured within a relatively short interval, then as the number of captured images increases, the temperature of the photodiodes rises. Thus, in capturing of second and subsequent images, if the light resetting process is not performed immediately before an image is captured, it is expected that noise due to dark current will adversely affect the radiographic images. Further, if the time required for the light-regulating mirror film layer 122 to switch between the mirror state and the transparent state is longer than the image capturing interval, then switching of the switching filter 76 may not be able to catch up with the frame rate of the moving image capturing mode. In such cases, the filter controller 216 may not return the light-regulating mirror film layer 122 to the mirror state, but may determine that the light-regulating mirror film layer 122 should be kept in the transparent state, for the purpose of performing the light resetting process reliably and to acquire radiographic images having only slight noise therein.

With PSS type electronic cassettes 20C, 20D, as described above, since the scintillator 74, the photodetector substrate 72, the switching filter 76, and the resetting light source 78 are successively arranged in the casing 44 along a direction in which radiation 16 is applied, most of the radiation 16 is converted into visible light 130 by the columnar crystalline structure 84, and the possibility that radiation 16 may reach the switching filter 76 and the resetting light source 78 is minimal. According to PSS type electronic cassettes, therefore, the switching filter 76 and the resetting light source 78 are prevented from becoming degraded by radiation 16. Even if the light-regulating mirror film layer 122 is kept in a transparent state while radiation 16 is applied, the resetting light source 78 is prevented from emitting resetting light 132 in error due to being irradiated with radiation 16.

According to the radiographic image capturing process [2] that is applied to the electronic cassettes 20C and 20D, the light resetting process is performed at least once before an image capturing mode is started. If the image capturing order includes a still image capturing mode, then after completion of the light resetting process, the light-regulating mirror film layer 122 is kept in a mirror state, and still images are captured. If the image capturing order includes a moving image capturing mode, then the light-regulating mirror film layer 122 is kept in a mirror state and a moving image is captured, or alternatively, the light-regulating mirror film layer 122 is kept in a transparent state and a moving image is captured.

[3] The radiographic image capturing process according to an image capturing order including an image capturing mode for capturing a plurality of still images, or a moving image capturing mode with the light resetting process being performed between image capturing cycles (see FIG. 21), will be described below.

Steps S26 and S30 may be carried out with respect to the electronic cassettes 20C and 20D in the following manner

If the filter controller 216 (see FIG. 17) determines that the light-regulating mirror film layer 122 (see FIGS. 6A through 8B, FIGS. 11 through 14B, and FIGS. 15B and 16) is in the transparent state (step S26: NO), i.e., that the moving image capturing mode is carried out with the light-regulating mirror film layer 122 being in the transparent state, then the filter controller 216 does not apply any voltage to the switching filter 76, so as to continuously maintain the light-regulating mirror film layer 122 in a transparent state. In step S30, the light source controller 218 energizes the resetting light source 78 to perform the light resetting process on the pixels 190, in the same manner as in steps S22 and S28. Thereafter, the light source controller 218 de-energizes the resetting light source 78 to stop emitting resetting light 132. Then, control goes back to step S9 shown in FIG. 19, and the radiographic image capturing system 10 performs a next radiographic image capturing process.

According to the radiographic image capturing process [3], which is applied to the electronic cassettes 20C and 20D, if the light-regulating mirror film layer 122 is kept in the transparent state, then the light resetting process can be performed between image capturing cycles, and thereafter, the light-regulating mirror film layer 122 can be kept in a transparent state without switching back to the mirror state. In particular, if the image capturing order includes a high-rate moving image capturing mode, then since the switching time of the light-regulating mirror film layer 122 may not be able to catch up with the frame rate of the high-rate moving image capturing mode, the light resetting process can reliably be performed between image capturing cycles by maintaining the light-regulating mirror film layer 122 in the transparent state.

The radiographic image capturing process and the light resetting process for an image capturing order including two or more image capturing modes, such as the aforementioned radiographic image capturing processes [4] through [7], will be described below. With the electronic cassettes 20C and 20D, for the image capturing order shown in FIG. 23C, since it is time-consuming to switch the light-regulating mirror film layer 122 (see FIGS. 6A through 8B, FIGS. 11 through 14B, and FIGS. 15B through 17) at a timing at which the image capturing modes are changed, i.e., since the switching time is unable to catch up with the frame rate of the moving image capturing mode, it is expected that the light-regulating mirror film layer 122 may be switched in advance, during a period in which the image capturing interval is relatively long.

[4] The radiographic image capturing process according to an image capturing order including, in this order, a sequence of an image capturing mode for capturing at least one still image and a moving image capturing mode, while the switching filter 76 is switched between the mirror state and the transparent state at a timing at which the still image capturing mode is switched to the moving image capturing mode (see FIG. 23A), will be described below.

The radiographic image capturing process [4], as well as a process for keeping the light-regulating mirror film layer 122 in a transparent state depending on the frame rate in the moving image capturing mode after a time period T, will be described below.

In step S46 shown in FIG. 25, the filter controller 216 (see FIG. 17) determines whether or not the next moving image capturing mode is a low-rate moving image capturing mode.

Since the low-rate moving image capturing mode is a moving image capturing mode at a relatively low frame rate, the image capturing interval is relatively long and the temperature of the photodiodes does not rise significantly, and thus, the light resetting process may not be necessary. Since the image capturing interval is relatively long, if the light resetting process is carried out, it is possible to provide a time period during which the switching filter 76 (see FIGS. 3, 5A, and 5B) can be switched between image capturing cycles.

If the next moving image capturing mode is a low-rate moving image capturing mode (step 46: YES), then in step S47, the filter controller 216 applies a voltage, which is opposite in polarity to the voltage in step S44, to the switching filter 76 in order to switch the light-regulating mirror film layer 122 from the transparent state to the mirror state. After step S47, step S9 is carried out to start the low-rate moving image capturing mode.

If the next moving image capturing mode is a high-rate moving image capturing mode (step S46: NO), then in step S48, the filter controller 216 determines that the light-regulating mirror film layer 122 (see FIGS. 6A through 8B, FIGS. 11 through 14B, and FIGS. 15B and 16) should remain in the transparent state. Thereafter, step S9 is carried out to start the high-rate moving image capturing mode.

If the decision in step S43 is negative (step S43: NO), then there is a possibility that the light-regulating mirror film layer 122 will presently be in a mirror state. Therefore, in step S46, if the filter controller 216 determines that the next moving image capturing mode is a high-rate moving image capturing mode (step S46: NO), then in step S48, the filter controller 216 may apply a voltage to the switching filter 76 in order to switch the light-regulating mirror film layer 122 from the mirror state to the transparent state.

In a moving image capturing mode, e.g., a high-rate moving image capturing mode, the light-regulating mirror film layer 122 may be kept in the transparent state, or if the switching time of the light-regulating mirror film layer 122 is longer than the frame rate, steps S46 and S47 may be skipped.

[5] The radiographic image capturing process according to an image capturing order including a sequence of a moving image capturing mode and an image capturing mode for capturing at least one still image in this order, while the switching filter 76 switches between the mirror state and the transparent state at a timing at which the moving image capturing mode is switched to the still image capturing mode (see FIG. 23B), will be described below.

If the light-regulating mirror film layer 122 (see FIGS. 6A through 8B, FIGS. 11 through 14B, and FIGS. 15B and 16) is kept in a transparent state during the moving image capturing mode, then step S54 may be skipped, as indicated by the broken lines in FIG. 26, and in step S55, the light resetting process may be carried out immediately.

[6] The radiographic image capturing process according to an image capturing order including two moving image capturing modes having different frame rates (see part of FIG. 23C) will be described below.

According to the radiographic image capturing process that is applied to the electronic cassettes 20C and 20D, even if the frame rate is changed during the radiographic image capturing process depending on the temperature of the photodiodes or the image capturing interval, the light-regulating mirror film layer 122 (see FIGS. 6A through 8B, FIGS. 11 through 14B, and FIGS. 15B and 16) may be kept in a transparent state.

More specifically, in step S13, after it has been decided that the capturing of all radiographic images is not completed (step S13: NO), if the decision sent from the image capturing order determiner 210 indicates a sequence of two moving image capturing modes in this order in step S41 (step S41: NO) (see FIG. 25) and step S51 (step S51: NO) (see FIG. 26), and in step S61, if the decision indicates a sequence of a low-rate moving image capturing mode and a high-rate moving image capturing mode in this order (step S61: YES) (see FIG. 27), then in step S62, the light resetting operation determiner 214 (see FIG. 17) determines whether or not the light-regulating mirror film layer 122 should be switched to the transparent state.

More specifically, since the image capturing interval of the high-rate moving image capturing mode is shorter than the image capturing interval of the low-rate moving image capturing mode, even if the light-regulating mirror film layer 122 is switched alternately to the mirror state and the transparent state during one frame, it is difficult to perform the light resetting process if the switching time is longer than the image capturing interval.

Consequently, if switching of the light-regulating mirror film layer 122 to the mirror state or the transparent state cannot catch up with the frame rate of the high-rate moving image capturing mode, then it is desirable to switch the light-regulating mirror film layer 122 from the mirror state to the transparent state during the low-rate moving image capturing mode, the image capturing interval of which is relatively long.

In step S62, if the light resetting operation determiner 214 determines that the light-regulating mirror film layer 122 is to switch from the mirror state to the transparent state (step S62: YES) in FIG. 27, then the light resetting operation determiner 214 outputs the decision to the filter controller 216 while also displaying the decision on the display control panel 56. In step S63, the filter controller 216 applies a voltage to the switching filter 76 (FIGS. 3B, 5A, and 5B), to thereby switch the light-regulating mirror film layer 122 from the mirror state to the transparent state.

Then, in step S64, the light resetting operation determiner 214 determines whether or not the light resetting process is necessary.

If the frame rate of the low-rate moving image capturing mode is higher than the frame rate threshold value Fth dependent on the temperature of the photodiodes, then in step S64, the light resetting operation determiner 214 determines that the light resetting process is necessary (step S64: YES), and outputs the decision that the light resetting process needs to be performed to the filter controller 216 and to the light source controller 218, while displaying the decision on the display control panel 56. The speaker 58 may also output a sound representative of the decision.

The filter controller 216 keeps the light-regulating mirror film layer 122 in a transparent state, and the light source controller 218 energizes the resetting light source 78 to start emitting resetting light 132. In step S65, resetting light 132 passes through the light-regulating mirror film layer 122 to the photodetector substrate 72, thereby resetting the photodetector devices 94, i.e., the pixels 190. After the light resetting process is finished, the light-regulating mirror film layer 122 is kept in the transparent state. Then, step S9 and the subsequent steps shown in FIG. 19 are carried out, i.e., the low-rate moving image capturing mode is performed.

If the light resetting operation determiner 214 decides that the light-regulating mirror film layer 122 should remain in the mirror state (step S62: NO), i.e., if switching of the light-regulating mirror film layer 122 to the mirror state or the transparent state can sufficiently catch up with the frame rate of the high-rate moving image capturing mode, or if the light-regulating mirror film layer 122 should be kept in the mirror state because a certain time period remains prior to switching from the low-rate moving image capturing mode to the high-rate moving image capturing mode, then steps S63 through S65 are skipped, and step S9 and subsequent steps are carried out while the light-regulating mirror film layer 122 remains in the mirror state.

If the light resetting operation determiner 214 decides that the light resetting process is not necessary (step S64: NO), even if the light-regulating mirror film layer 122 switches to the transparent state, then step S9 and subsequent steps are carried out while the light-regulating mirror film layer 122 is kept in the transparent state.

If the light-regulating mirror film layer 122 has already been in a transparent state in previous moving image capturing modes, then after the affirmative decision in step S61 is made, steps S62 and S63 may be skipped, and step S64 may be carried out.

If a high-rate moving image capturing mode and a low-rate moving image capturing mode are successively performed in this order (step S61: NO), then in step S71 in FIG. 28, the light resetting operation determiner 214 determines whether or not the light resetting process needs to be performed.

If the frame rate of the moving image capturing mode is higher than the frame rate threshold value Fth (see FIG. 22) depending on the temperature of the photodiodes, then in step S71, the light resetting operation determiner 214 decides that the light resetting process is necessary (step S71: YES), and outputs the decision to the filter controller 216 and the light source controller 218, while also displaying the decision on the display control panel 56. The speaker 58 may also output a sound representative of the decision.

The filter controller 216 applies a voltage to the switching filter 76 to switch the light-regulating mirror film layer 122 from the mirror state to the transparent state. The light source controller 218 energizes the resetting light source 78 to start emitting resetting light 132. In step S72, the resetting light 132 passes through the light-regulating mirror film layer 122 to the photodetector substrate 72, thereby performing the light resetting process on the photodetector devices 94, i.e., the pixels 190. Thereafter, the light source controller 218 de-energizes the resetting light source 78 in order to finish the light resetting process. In step S73, the filter controller 216 determines whether or not the light-regulating mirror film layer 122 should be switched to the mirror state.

If switching of the light-regulating mirror film layer 122 to the mirror state or the transparent state can sufficiently catch up with the frame rate of the high-rate moving image capturing mode (step S73: YES), then the filter controller 216 applies a voltage, which is opposite in polarity to the voltage applied in step S72, to the switching filter 76, so as to switch the light-regulating mirror film layer 122 from the transparent state to the mirror state in step S74. Thereafter, step S9 and subsequent steps shown in FIG. 19 are carried out.

If switching of the light-regulating mirror film layer 122 to the mirror state or the transparent state cannot catch up with the frame rate of the high-rate moving image capturing mode (step S73: NO), then the filter controller 216 keeps the light-regulating mirror film layer 122 in a transparent state, after which step S9 and subsequent steps are carried out.

Further, in step S71, if the frame rate of the moving image capturing mode is lower than the frame rate threshold value Fth dependent on the temperature of the photodiodes, then the light resetting operation determiner 214 determines that the light resetting process is not necessary (step S71: NO), and outputs the decision to the filter controller 216 and to the light source controller 218, while displaying the decision on the display control panel 56.

[7] The radiographic image capturing process according to an image capturing order including two moving image capturing modes having different frame rates, and an image capturing mode for capturing at least one still image (see FIG. 23C) will be described below.

The radiographic image capturing process [4] is applied directly to switching from the still image capturing mode to the low-rate moving image capturing mode.

The radiographic image capturing process [6] is applied directly to switching from the low-rate moving image capturing mode to the high-rate moving image capturing mode. More specifically, if the light-regulating mirror film layer 122 (see FIGS. 6A through 8B, FIGS. 11 through 14B, and FIGS. 15B and 16) switches to the mirror state or to the transparent state in one frame after the low-rate moving image capturing mode switches to the high-rate moving image capturing mode, there is a possibility that the switching time may not be able to catch up with the frame rate. Therefore, as shown in FIG. 23C, the light-regulating mirror film layer 122 is switched from the mirror state to the transparent state in advance between image capturing cycles in the low-rate moving image capturing mode, and is kept in the transparent state during the high-rate moving image capturing mode, so that the light resetting process can be performed reliably. In particular, in a high-rate moving image capturing mode carried out on a region of interest (ROI) of the subject 14 (see FIG. 1), noise in the radiographic image can reliably be reduced by performing the light resetting process, while keeping the light-regulating mirror film layer 122 in the transparent state.

According to the radiographic image capturing processes [2] through [7], which are applied to PSS type electronic cassettes 20C and 20D, the cassette controller 182 or the console 22 can perform an image processing sequence to remove or correct noise caused by a certain amount of electric charges discharged at a given rate from the radiographic images, so that high-quality radiographic images with only slight noise therein can be displayed on the display control panel 56 and the display device 24.

The radiographic image capturing system 10 incorporating therein the electronic cassettes 20C and 20D according to the third and fourth examples operates as described above.

### Advantages of the Present Embodiment

As described above, with the electronic cassette 20 (20A through 20D) according to the present embodiment, if the switching filter 76 is switched to the transparent state with respect to resetting light 132, the resetting light source 78 can apply resetting light 132 to the photodetector substrate 72 for sufficiently performing a light resetting process on the photodetector substrate 72.

If the switching filter 76 is switched to the mirror state with respect to resetting light 132, fluorescence, i.e., visible light 130, which is converted from radiation 16 by the scintillator 74, reaches the photodetector substrate 72. Among such visible light 130, part of the fluorescence that travels toward the resetting light source 78 is reflected by the switching filter 76 toward the photodetector substrate 72. Reflected light is applied to the photodetector substrate 72 without reaching the resetting light source 78. The photodetector substrate 72 can acquire high-quality radiographic images, which are not blurred, and the amount of visible light 130 applied to the photodetector substrate 72 is increased, thereby increasing the sensitivity of the photodetector substrate 72 with respect to visible light 130.

According to the present embodiment, therefore, since the resetting light source 78, the switching filter 76, the photodetector substrate 72, and the scintillator 74 are successively arranged in this order, and the switching filter 76 is selectively permeable and impermeable to resetting light 132, the light resetting process can sufficiently be performed on the photodetector substrate 72, and the sensitivity of the photodetector substrate 72 with respect to visible light 130 can be increased while preventing radiographic images from becoming blurred.

Based on the image capturing order, the switching filter 76 can be switched to the transparent state (permeable state) for passing resetting light 132 therethrough, or the mirror state (impermeable state) for reflecting visible light 130 toward the photodetector substrate 72 as well as reflecting resetting light 132 toward the resetting light source 78. Therefore, the switching filter 76 can be kept in a transparent state or in a mirror state, or switched to a transparent state or a mirror state, depending on the image capturing method (a still image capturing mode or a moving image capturing mode) for the subject 14, thereby reliably and efficiently performing the light resetting process on the photodetector substrate 72, and acquiring, with high sensitivity, high-quality radiographic images, which are prevented from becoming blurred. If the switching filter 76 in the mirror state reflects visible light 130 toward the photodetector substrate 72, the amount of visible light 130 applied to the photodetector substrate 72 is increased. Consequently, the amount of radiation 16 that is applied to the subject 14 can be reduced, thereby reducing the dose of radiation 16 applied to the subject 14.

More specifically, if the image capturing order includes a radiographic image capturing mode for capturing at least one radiographic image, or a moving image capturing mode having a frame rate lower than the frame rate threshold value Fth (or Fth0), i.e., a low-rate moving image capturing mode, then the switching filter 76 may be kept in the mirror state.

The above image capturing modes, in particular, require high-quality radiographic images to be acquired with high sensitivity. Since the image capturing interval in such image capturing modes is relatively long, the temperature of the photodiodes does not rise significantly, and noise caused if electric charges trapped by the impurity level are discharged again is not expected to greatly affect the captured radiographic images.

If the above image capturing order is received, the switching filter 76 is kept in a mirror state in order to keep the light resetting process off, and also to reflect visible light 130 converted from radiation 16 by the scintillator 74 toward the photodetector substrate 72, thereby increasing the amount of visible light 130 applied to the photodetector substrate 72. As a result, it is possible to easily acquire low-noise, high-quality radiographic images, which are prevented from becoming blurred, with high sensitivity.

If the image capturing order includes a moving image capturing mode, and in particular, a high-rate moving image capturing mode, then the switching filter 76 is kept in a mirror state during each frame when the subject 14 is irradiated with radiation 16, and is kept in a transparent state during each frame when the subject 14 is not irradiated with radiation 16. Accordingly, the switching filter 76 is switched successively between the mirror state and the transparent state.

Since the switching filter 76 is switched successively between the mirror state and the transparent state within one frame, when the subject 14 is irradiated with radiation 16, the switching filter 76 is kept in a mirror state to reflect visible light 130 reliably toward the photodetector substrate 72, thereby increasing the amount of visible light 130 applied to the photodetector substrate 72. When the subject 14 is not irradiated with radiation 16, the switching filter 76 is kept in a transparent state to thereby sufficiently perform the light resetting process on the photodetector substrate 72.

In the moving image capturing mode, therefore, the switching filter 76 is switched alternately between the mirror state and the transparent state within one frame in order to acquire high-quality radiographic images with high sensitivity, and also to reduce noise in the acquired radiographic images. If the switching filter 76 has a switching time that is capable of catching up sufficiently with the frame rate of the moving image capturing mode, i.e., if the switching filter 76 has a switching time shorter than the time interval between image capturing cycles, then the switching filter 76 can be switched alternately between the mirror state and the transparent state.

If the image capturing order includes a moving image capturing mode and a still image capturing mode for capturing at least one radiographic image, then the switching filter 76 is kept in a mirror state during the still image capturing mode and also is kept in a mirror state during the moving image capturing mode. Alternatively, the switching filter 76 is kept in a mirror state when the subject 14 is irradiated with radiation 16, and is kept in a transparent state when the subject 14 is not irradiated with radiation 16, such that the switching filter 76 is switched successively between the mirror state and the transparent state. Thus, at a timing at which the moving image capturing mode is switched to the still image capturing mode, the switching filter 76 switches from successively switching between the mirror state and the transparent state to the mirror state, or is kept in the mirror state. At a timing at which the still image capturing mode is switched to the moving image capturing mode, the switching filter 76 switches from the mirror state to successively switching between the mirror state and the transparent state, or is further kept in the mirror state.

In this manner, by keeping the switching filter 76 in one of the mirror state and the transparent states, or by switching the switching filter 76 between the mirror state and the transparent state at a timing at which switching between the image capturing methods, i.e., the still image capturing mode and the moving image capturing mode, occurs, it is possible to reliably acquire optimum radiographic images depending on the image capturing method.

If the image capturing order includes a low-rate moving image capturing mode and a high-rate moving image capturing mode, then the switching filter 76 is kept in a mirror state in the low-rate moving image capturing mode. In the high-rate moving image capturing mode, the switching filter 76 is kept in a mirror state if the subject 14 is irradiated with radiation 16, and is kept in a transparent state if the subject 14 is not irradiated with radiation 16, whereby the switching filter 76 is switched successively between the mirror state and the transparent state. At a timing at which the low-rate moving image capturing mode is switched to the high-rate moving image capturing mode, the switching filter 76 may switch from the mirror state to successively switching between the mirror state and the transparent state. Further, at a timing at which the high-rate moving image capturing mode is switched to the low-rate moving image capturing mode, the switching filter 76 may switch from successively switching between the mirror state and the transparent state to the mirror state.

Even if the frame rate of the image capturing order is changed during the radiographic image capturing process, therefore, optimum radiographic images depending on the frame rate can reliably be acquired by switching the switching filter 76 at a timing at which the frame rate is changed.

If the image capturing order includes the above two moving image capturing modes as well as a still image capturing mode for capturing at least one still image, then the switching filter 76 is kept in the mirror state during the still image capturing mode. At a timing at which one of the moving image capturing modes is switched to the still image capturing mode, the switching filter 76 may switch from the state depending on the moving image capturing mode to the mirror state. At a timing at which the still image capturing mode is switched to one of the moving image capturing modes, the switching filter 76 may switch from the mirror state to the state depending on the moving image capturing mode.

Even if the image capturing order includes a still image capturing mode, therefore, optimum radiographic images can easily be acquired during each of the image capturing modes, by switching the switching filter 76 as described above.

With the electronic cassette 20, the photodetector substrate 72 includes the photodetector devices 94 for converting visible light 130 into electric signals, and the switching filter 76 includes the window 230, which is defined in a portion for passing resetting light 132 therethrough at all times. If the resetting light source 78 applies resetting light 132 through the window 230 to one of the photodetector devices 94, which faces toward the window 230, the photodetector device 94, which is irradiated with resetting light 132, detects a dark current signal generated by the resetting light 132. The switching filter 76 may switch to the mirror state or to the transparent state based on the temperature of the photodetector device 94, depending on the dark current signal and the image capturing order.

The level of noise trapped by the impurity level varies with the temperature of the photodetector devices 94 in the form of photodiodes. Therefore, it is desirable to change the frame rate threshold value Fth depending on the temperature of the photodetector devices 94. Therefore, as described above, noise can be reduced efficiently depending on a change in temperature of the photodetector devices 94, by switching the switching filter 76 into a mirror state or a transparent state based on the temperature, and depending on the dark current signal and the image capturing order.

According to the present embodiment, unlike conventional processes, it is determined whether or not the light resetting process is required based on the frame rate and the temperature of the photodiodes. If a light resetting process is performed, a sufficient amount of electric charge is embedded in the impurity level to thereby eliminate variations in the amount of electric charge discharged from the impurity level between frames due to a rise in the temperature of the photodiodes. As a consequence, noise due to electric charges discharged at a certain rate can be removed or corrected from the radiographic images by way of an image processing sequence, thus making it possible to acquire radiographic images of higher quality.

The switching filter 76 includes the light-regulating mirror film layer 122, which is controlled electrically to be permeable or impermeable to resetting light 132. The photodetector substrate 72 is disposed on the side of the light-regulating mirror film layer 122, whereas the resetting light source 78 is disposed on the side of the transparent base 110. Therefore, the switching filter 76 can easily and efficiently be switched to a permeable state or an impermeable state (mirror state).

The resetting light source 78 is in the form of an array of light-emitting elements 142, a backlight, or an electroluminescence light source, disposed in facing relation to the photodetector substrate 72 with the switching filter 76 interposed therebetween.

The resetting light source 78, which is in the form of a backlight, makes it possible to place the cold-cathode ray tube 152 and the light-emitting elements 162 in an area that is not irradiated with radiation 16. Therefore, the cold-cathode ray tube 152 and the light-emitting elements 162 are prevented from becoming degraded by radiation 16. If the resetting light source 78 is in the form of an organic electroluminescence light source, then the resetting light source 78 may be made low in profile.

If the photodetector devices 94 of the photodetector substrate 72 are made of an organic photoconductor or an amorphous oxide semiconductor, and the TFTs 92 are made of an organic semiconductor, an amorphous oxide semiconductor, or carbon nanotubes, then the photodetector devices 94 and the TFTs 92 can be deposited as films at low temperatures.

The oblique light blocking layer 102 is interposed between the photodetector substrate 72 and the scintillator 74, thereby making it possible to increase sensitivity of the photodetector substrate 72 with respect to visible light 130, and to prevent radiographic images from becoming blurred.

Various structural details of the electronic cassettes 20A through 20D according to the first through fourth examples have been described above. Preferably, the PSS type electronic cassettes 20C and 20D should include structural details for peeling off the base 90 from the photodetector substrate 72 and for transferring the base 90 (see FIGS. 8A, 31A, and 31B), as well as structural details whereby the photodetector substrate 72 is formed directly on the scintillator 74 (see FIGS. 8B and 35B), or should include structural details including the oblique light blocking layer 102 (see FIG. 7B) for the purpose of increasing sensitivity of the photodetector substrate 72 with respect to visible light 130 and for preventing radiographic images from becoming blurred.

Preferably, ISS type electronic cassettes 20A and 20B and PSS type electronic cassettes 20C and 20D should include a combination of the structural details for peeling off the base 90 from the photodetector substrate 72 and for transferring the base 90 (see FIGS. 8A, 31A, and 31B), or include structural details in which the photodetector substrate 72 is formed directly on the scintillator 74 (see FIGS. 8B and 35B), and the electroluminescence light source (see FIG. 16) for the above purposes as well as for making the electronic cassettes 20A through 20D low in profile.

The present invention is not limited to the illustrated details of the present embodiment, but various process modifications may be made to the illustrated processes, as follows.

According to the radiographic image capturing processes [1] through [7], the light resetting operation determiner 214 determines whether or not the light resetting process needs to be performed on the photodetector devices 94 based on the magnitude of the frame rate relative to the frame rate threshold value Fth. However, the light resetting operation determiner 214 may also determine whether or not the light resetting process needs to be performed according to any one of the following processes (1) through (3).

(1) The light resetting operation determiner 214 determines that the light resetting process needs to be performed if the number of captured images exceeds a predetermined threshold value during the moving image capturing mode.

(2) Since the noise level in the radiographic image increases as the temperature of the photodetector devices 94 rises, the light resetting operation determiner 214 may determine that the light resetting process needs to be performed, if the noise level of an acquired radiographic image exceeds a predetermined threshold value.

(3) In the radiographic image capturing process [6], if the high-rate moving image capturing mode and the low-rate moving image capturing mode are successively carried out in this order, i.e., if a high frame rate changes to a low frame rate in the moving image capturing mode, it may not necessarily be decided that the light resetting process is not required because of the low frame rate. In other words, the temperature of the photodetector devices 94 may possibly be increased if the light resetting process is repeatedly performed on the photodetector devices 94 during the high-rate moving image capturing mode. Accordingly, the light resetting operation determiner 214 may decide that the light resetting process needs to be performed in order to eliminate adverse effects of the high-rate moving image capturing mode.

The light resetting operation determiner 214 may determine whether or not the light resetting process needs to be performed according to the processes (1) through (3), instead of determining whether the light resetting process needs to be performed based on the frame rate. The light resetting operation determiner 214 may also determine whether or not the light resetting process needs to be performed based on a combination of the frame rate and any one of the processes (1) through (3). Furthermore, the light resetting operation determiner 214 may determine whether or not the light resetting process needs to be performed based on a combination of the frame rate and all of the processes (1) through (3).

Although certain preferred embodiments of the present invention have been shown and described in detail, it should be understood that various changes and modifications may be made to the embodiments without departing from the scope of the invention as set forth in the appended claims.

What is claimed is:

1. A radiographic image capturing apparatus comprising:
a scintillator for converting radiation into fluorescence;
a photodetector substrate for converting the fluorescence into electric signals;
a resetting light source for applying resetting light to the photodetector substrate; and
a switching filter, which is selectively permeable and impermeable to the resetting light,
wherein the resetting light source, the switching filter, the photodetector substrate, and the scintillator are arranged in this order, and
if the switching filter is permeable to the resetting light, the switching filter applies the resetting light to the photodetector substrate, and if the switching filter is impermeable to the resetting light, the switching filter reflects at least the fluorescence toward the photodetector substrate.

2. The radiographic image capturing apparatus according to claim 1, wherein:
the scintillator converts the radiation, which has passed through a subject, into the fluorescence;
the photodetector substrate converts the fluorescence into the electric signals, which represent a radiographic image of the subject; and
the switching filter is selectively switchable to a transparent state, which is permeable to the resetting light, and a mirror state, which reflects the fluorescence toward the photodetector substrate and also reflects the resetting light toward the resetting light source, based on an image capturing order concerning capturing of the radiographic image of the subject.

3. The radiographic image capturing apparatus according to claim 2, wherein if the image capturing order includes a still image capturing mode for capturing at least one still image or a moving image capturing mode at a frame rate lower than a frame rate threshold value, the switching filter is kept in the mirror state.

4. The radiographic image capturing apparatus according to claim 2, wherein if the image capturing order includes a moving image capturing mode, the switching filter is kept in the mirror state in each frame while the subject is irradiated with the radiation, and is kept in the transparent state while the subject is not irradiated with the radiation, whereby the switching filter is switched successively between the mirror state and the transparent state.

5. The radiographic image capturing apparatus according to claim 2, wherein if the image capturing order includes a moving image capturing mode and a still image capturing mode for capturing at least one still image,
the switching filter is kept in the mirror state in the still image capturing mode, and is kept in the mirror state in the moving image capturing mode, or is kept in the mirror state while the subject is irradiated with the radiation and is kept in the transparent state while the subject is not irradiated with the radiation in each frame in the moving image capturing mode, whereby the switching filter is switched successively between the mirror state and the transparent state;
the switching filter switches from successively switching between the mirror state and the transparent state to the mirror state, or is further kept in the mirror state at a timing at which the moving image capturing mode is switched to the still image capturing mode; and
the switching filter switches from the mirror state to successively switching between the mirror state and the transparent state, or is further kept in the mirror state at a timing at which the still image capturing mode is switched to the moving image capturing mode.

6. The radiographic image capturing apparatus according to claim 2, wherein if the image capturing order includes a first moving image capturing mode at a frame rate lower than a frame rate threshold value and a second moving image capturing mode at a frame rate higher than the frame rate threshold value,
the switching filter is kept in the mirror state in the first moving image capturing mode, or is kept in the mirror state while the subject is irradiated with the radiation and is kept in the transparent state while the subject is not irradiated with the radiation in each frame in the second moving image capturing mode, whereby the switching filter is switched successively between the mirror state and the transparent state; and
the switching filter switches from the mirror state to successively switching between the mirror state and the transparent state at a timing at which the first moving image capturing mode is switched to the second moving image capturing mode, or switches from successively switching between the mirror state and the transparent state to the mirror state at a timing at which the second moving image capturing mode is switched to the first moving image capturing mode.

7. The radiographic image capturing apparatus according to claim 6, wherein if the image capturing order further includes a still image capturing mode for capturing at least one still image, the switching filter is kept in the mirror state in the still image capturing mode, and switches from a state in which the switching filter depends on one of the moving image capturing modes to the mirror state, at a timing at which one of the moving image capturing modes is switched to the still image capturing mode, or switches from the mirror state to the state in which the switching filter depends on one of the moving image capturing modes, at a timing at which the still image capturing mode is switched to the one of the moving image capturing modes.

8. The radiographic image capturing apparatus according to claim 2, wherein the photodetector substrate includes a plurality of photodetector devices for converting the fluorescence into the electric signals;
the switching filter has a window defined in a portion thereof for passing the resetting light therethrough at all times;
if the resetting light source applies the resetting light through the window to one of the photodetector devices, which faces toward the window, the photodetector device, which is irradiated with the resetting light, detects a dark current signal generated by the resetting light; and
the switching filter switches to the mirror state or the transparent state based on a temperature of the photodetector device depending on the dark current signal and the image capturing order.

9. The radiographic image capturing apparatus according to claim 1, wherein the switching filter includes a light-regulating mirror film layer, which is electrically controlled to be permeable or impermeable to the resetting light.

10. The radiographic image capturing apparatus according to claim 9, wherein the switching filter includes a transparent base permeable to the resetting light, and the light-regulating mirror film layer is disposed on the transparent base; and
the photodetector substrate is disposed on a side of the light-regulating mirror film layer, and the resetting light source is disposed on a side of the transparent base.

11. The radiographic image capturing apparatus according to claim 1, wherein the resetting light source comprises an array of light-emitting elements, a backlight, or an electroluminescence light source, disposed in facing relation to the photodetector substrate with the switching filter interposed therebetween.

12. The radiographic image capturing apparatus according to claim 11, wherein the backlight comprises a light guide plate disposed on a side of the switching filter remote from the photodetector substrate, a light source disposed on a side of the light guide plate, a reflection sheet disposed in surrounding relation to the light guide plate and the light source, and a diffusion sheet disposed on a surface of the light guide plate, which faces toward the switching filter;
the light source applies light to the light guide plate; and
the light applied to the light guide plate is repeatedly reflected in the light guide plate between surfaces of the reflection sheet and the diffusion sheet, and thereafter, the light is emitted as the resetting light from the diffusion sheet to the switching filter.

13. The radiographic image capturing apparatus according to claim 12, wherein the light source comprises a light-emitting diode or a cold-cathode ray tube.

14. The radiographic image capturing apparatus according to claim 11, wherein the electroluminescence light source comprises an organic electroluminescence light source.

15. The radiographic image capturing apparatus according to claim 1, further comprising:
an oblique light blocking layer for blocking the fluorescence that travels obliquely to a direction in which the radiation is applied, the oblique light blocking layer being interposed between the photodetector substrate and the scintillator.

16. The radiographic image capturing apparatus according to claim 1, wherein the resetting light source, the switching filter, the photodetector substrate, and the scintillator are successively arranged in this order, or the scintillator, the photodetector substrate, the switching filter, and the resetting light source are successively arranged in this order, along a direction in which the radiation is applied.

17. The radiographic image capturing apparatus according to claim 16, wherein if the resetting light source, the switching filter, the photodetector substrate, and the scintillator are successively arranged in this order along the direction in which the radiation is applied, the switching filter is kept in a mirror state for reflecting the resetting light toward the resetting light source and reflecting the fluorescence toward the photodetector substrate, at least during application of the radiation.
